(19) United States
(12) Patent Application Publication
(10) Pub. No.: US 2015/0004637 A1
(43) Pub. Date: Jan. 1, 2015

(54) SYSTEMS AND METHODS FOR IMAGING AT HIGH SPATIAL AND/OR TEMPORAL PRECISION

(71) Applicant: President and Fellows of Harvard College, Cambridge, MA (US)

(72) Inventors: Adam E. Cohen, Cambridge, MA (US); Dougal Maclaurin, Cambridge, MA (US); Daniel Hochbaum, Cambridge, MA (US); Joel Kralj, Somerville, MA (US)

(21) Appl. No.: 14/359,387

(22) PCT Filed: Nov. 21, 2012
(86) PCT No.: PCT/US2012/066303

§ 371 Date: May 20, 2014

Related U.S. Application Data
(60) Provisional application No. 61/563,537, filed on Nov. 23, 2011.

(51) Int. Cl. G02B 21/36; G01N 21/64; G02B 21/08; G02B 21/02; G02B 21/16

(52) U.S. Cl. CPC G02B 21/367; G02B 21/025; G02B 21/16; G02B 21/082; G02B 21/361; G01N 21/6486; G01N 2201/06113
USPC 435/29; 359/380; 348/80

(57) ABSTRACT

Various aspects of the present invention are generally directed to systems and methods for imaging at high spatial and/or temporal resolutions. In one aspect, the present invention is generally directed to an optical microscopy system and related methods adapted for high spatial and temporal resolution of dynamic processes. The system may be used in conjunction with fluorescence imaging wherein the fluorescence may be mediated by voltage-indicating proteins. In some cases, time resolutions may be enhanced by fitting predefined temporal waveforms to signal values received from an image. The system may also contain a high numerical aperture objective lens and a zoom lens located in an imaging optical path to an object region. Other aspects of the present invention are generally directed to techniques of making or using such systems, kits involving such systems, manufactured storage devices able to implement such systems or methods, and the like.

### CROSS-REFERENCE TO RELATED APPLICATIONS

This application claims priority to U.S. provisional application No. 61/563,537 titled “SYSTEMS AND METHODS FOR IMAGING AT HIGH SPATIAL AND/OR TEMPORAL PRECISION,” filed Nov. 23, 2011, which is incorporated herein by reference.

### GOVERNMENT FUNDING

Research leading to various aspects of the present invention was sponsored, at least in part, by the NIH, Grant Nos. 1-R01-EB012498-01 and 1-DP2-OD007428, and ONR, Grant No. N000141110-549. The U.S. Government has certain rights in the invention.

### BACKGROUND

Fluorescence microscopy is regularly used in research and development applications to study biological processes. Species of interest, e.g., cells, proteins, genes, antibodies, antigens, etc., may be tagged with one or more fluorophores and then illuminated with radiation that will excite the fluorophores while the samples are viewed in a microscope. In some cases, the tagged species may be a constituent of a larger sample that is to be viewed in the microscope. High resolution images of a sample along with fluorescence from one or more tagged species may be obtained, and the observed fluorescence may provide a diagnostic measure of an underlying chemical or biochemical process, e.g., expression of a gene, presence of an antibody, location of specific proteins within a cell.

Specially adapted microscopes can currently be purchased for fluorescence microscopy applications. Such microscopes may include special filters for blocking ambient radiation and/or excitation radiation. They may also comprise low-fluorescence optics to reduce background fluorescence, and special illumination schemes (e.g., slim-field illumination, or total internal reflection illumination (TIRF)) that reduce unwanted contributions to an image from out-of-focus material near an object to be imaged. Additionally, fluorescent tags such as green fluorescent protein (GFP) have been engineered that exhibit a high quantum efficiency to provide readily detectable fluorescence.

### SUMMARY

The present invention relates, in one set of embodiments, to dynamic, low-light level, fluorescence microscopy. Certain embodiments of the present invention are generally directed to systems and methods for studying biological processes that utilize voltage-sensitive fluorescent proteins. These proteins, also referred to herein as voltage-indicating proteins (“VIP”), can provide a fluorescent signal that may be dependent (in some cases, linearly) upon an electrostatic potential within which the VIPs reside. Accordingly with use of the VIPs, spatial and temporal dynamics of time-varying electric potentials can be observed or measured, e.g., in real time and/or at microscopic levels in various systems such as cells or other samples, e.g., living biological samples.

In one set of embodiments, the present invention is generally directed to a fluorescence microscopy optical system adapted to detect low-light-level fluorescence at both high spatial and temporal resolutions. According to one embodiment, an optical system for observing low-light-level fluorescence comprises an object region and an objective lens having a numerical aperture (“NA”) greater than about 0.9 and located in an imaging optical path from the object region. The optical system may further comprise a zoom lens also located in the imaging optical path. The objective lens may be an immersion objective. According to some embodiments, a relay optic is disposed in the imaging optical path between the objective lens and the zoom lens, and is configured to relay an image at the objective lens location to a location at approximately an entrance pupil to the zoom lens.

The optical system may further comprise a processor configured to receive and process imaging signals detected at an imaging location for the optical system. The processing of the imaging signals may be used to temporally resolve a time-varying image obtained by the microscope. The imaging signals may be received from a pixelated detector (e.g., a CCD or MOSFET detector array). The processor may be configured to receive a plurality of radiation signal values that were recorded from a plurality of imaging pixels for a plurality of time bins. There may be a plurality of time-binned signals for each of the pixels. The processor may further be configured to fit, for each of the pixels, a pre-defined temporal waveform to the respective signal values received for each pixel. According to some embodiments, the processor is further configured to determine, for each pixel based on the fitting, an occurrence in time of an event, and suppress, for each pixel, recorded signal values at time bins for which the event did not occur when displaying the time-varying image.

Also contemplated is one or more manufactured storage devices containing machine-readable instructions that, when executed by a processor, adapt the processor to receive a plurality of radiation signal values that were recorded from a plurality of imaging pixels for a plurality of time bins, and process the received signals to temporally resolve a time-varying microscope image as described above.

In another aspect, the present invention is generally directed to a method for temporally resolving a time-varying image. In one set of embodiments, the method comprises receiving, from a plurality of imaging pixels, a plurality of signal values associated with a plurality of measurement time bins during which the time-varying image was obtained, and fitting, for at least some of the pixels, a pre-defined temporal waveform to the respective signal values received for each pixel.

Another aspect of the present invention is generally directed to an optical system. In one set of embodiments, the optical system comprises an object region, an objective lens having a numerical aperture greater than about 0.9 and located in an imaging optical path from the object region, and a first zoom lens located in the imaging optical path. The objective lens and associated imaging optics may be used to acquire high-spatial-resolution images of samples, e.g., biological specimens. The optical system may further include apparatus for illuminating the samples. For example, the illumination apparatus may include a source of excitation radiation used to excite fluorescence or stimulate the sample. The illumination apparatus may couple one or more excitation beams into at least a portion of the imaging optical path. In some embodiments, the illumination apparatus may include a digital micromirror device that is configured to provide spatially-patterned illumination. The illumination apparatus may project spatially-patterned illumination from the digital micromirror onto the sample.

In yet another aspect, the present invention is generally directed to an imaging system. In one set embodiments, the imaging system comprises an imaging array having a plurality of imaging pixels, and a processor in communication with the imaging array, wherein the processor is configured to receive, from the plurality of imaging pixels, a plurality of signal values associated with a plurality of measurement time bins during which a time-varying image was obtained, and fit, for each of the pixels, a pre-defined temporal waveform to the respective signal values received for each pixel.

The present invention, in still another aspect, is generally directed to a manufactured storage device comprising instructions that, when executed by a processor, adapt the processor to receive, from the plurality of imaging pixels, a plurality of signal values associated with a plurality of measurement time bins during which a time-varying image was obtained, and fit, for each of the pixels, a pre-defined temporal waveform to the respective signal values received for each pixel.

According to yet another aspect, the present invention is generally directed to a method comprising acts of providing a sample comprising a voltage-indicating protein, and a light-sensitive moiety, illuminating at least a portion of the sample with a first light having, at least, a first wavelength at an intensity that causes the light-sensitive moiety to increase ion transport therethrough, and illuminating at least a portion of the sample with a second light having, at least, a second wavelength at an intensity that causes the voltage-indicating protein to fluoresce in a voltage-dependent manner.

The foregoing and other aspects, embodiments, and features of the present teachings can be more fully understood from the following description in conjunction with the accompanying drawings. The subject matter of the present invention involves, in some cases, interrelated products, alternative solutions to a particular problem, and/or a plurality of different uses of one or more systems and/or articles.

### BRIEF DESCRIPTION OF THE DRAWINGS

Those of ordinary skill in the art will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1A illustrates a microbial rhodopsin (D97N mutant of green proteorhodopsin) in a bilayer lipid membrane.

FIG. 1B depicts a mechanism of voltage-sensitive fluorescence of the microbial rhodopsin of FIG. 1A, in accordance with certain embodiments of the invention.

FIG. 1C is a graph illustrating fluorescence dependence on applied voltage of a microbial rhodopsin in another set of embodiments.

FIG. 2 is a block diagram of a dynamic, low-light-level microscopy system, according to one embodiment.

FIG. 3A depicts a microscopy system according to one embodiment of the present invention.

FIG. 3B illustrates various types of illumination of the object region that may be implemented with the system of FIG. 3A.

FIG. 4A-4D are depictions of a neuron transfected with a voltage-sensitive fluorescent protein, in accordance with certain embodiments, where propagation of an action potential along the neuron can produce a rapidly time varying fluorescence along the neuron.

FIG. 5A depicts an action potential and a minimum measurement interval Tₘ, in one set of embodiments.

FIG. 5B illustrates the fitting of a waveform (an action potential in this example) to measured samples recorded for a pixel over successive measurement intervals Tₘ, in accordance with one set of embodiments.

FIG. 5C illustrates temporal super-resolution for one pixel of a time-varying microscope image, according to one embodiment.

FIG. 5D illustrates temporal super-resolution for one pixel of a time-varying microscope image in which a detected signal is displayed at one sub-measurement interval, according to another embodiment.

FIGS. 5E-5F illustrate temporal super-resolution for one pixel of a time-varying microscope image, according to additional embodiments of the present invention. and

FIG. 6 is a flow chart representing acts for temporally resolving a time-varying microscope image.

FIG. 7A depicts models of Arch as a voltage sensor. pH and membrane potential can both alter the protonation of the Schiff base. The cuvettes contain intact E. coli expressing Arch. The crystal structure shown is bacteriorhodopsin; the structure of Arch has not been solved.

FIG. 7B shows absorption (solid line) and fluorescence emission (dashed line) spectra of purified Arch at neutral and high pH.

FIG. 7C shows fluorescence of Arch as a function of membrane potential. The fluorescence was divided by its value at −150 mV.

FIG. 7D illustrates a dynamic response of Arch to steps in membrane potential between −70 mV and +30 mV. The overshoots on the rising and falling edges were an artifact of electronic compensation circuitry. The smaller amplitude compared to FIG. 7C is because background subtraction was not performed in FIG. 7D. Data averaged over 20 cycles. Inset: Step response occurred in less than the 500 μs resolution of the imaging system.

FIG. 7E, top: HEK cell expressing Arch, visualized via Arch fluorescence. FIG. 7E, bottom: pixel-weight matrix regions of voltage-dependent fluorescence. Scale bar 10 microns.

FIG. 8A shows arch WT absorption at neutral (blue) and high (green) pH. At neutral pH, Arch absorbed maximally at 558 nm. Fluorescence emission (red dashed line) was recorded on 2 μM protein solubilized in 1% DM, with λ_{exc}≈532 nm.

FIG. 8B shows Arch^{D95N} spectra under the same conditions as in FIG. 8A. The absorption maximum was about 585 nm.

FIG. 8C illustrates absorption spectra recorded on purified protein between about pH 6 and about pH 11. Singular Value Decomposition of absorption spectra between 400-750 nm was used to calculate the fraction of the SB in the protonated state as a function of pH. The result was fit to a Hill function to determine the pKₐ of the SB.

FIG. 9 shows frequency response of Arch WT, in some embodiments of the invention.

FIG. 10 shows the sensitivity of Arch WT to voltage, in yet other embodiments of the invention. The voltage steps were about 10 mV. Whole-cell membrane potential was determined via direct voltage recording, V, (blue) and weighted Arch fluorescence, \hat{V}_{FL}, (red).

FIG. 11A shows cultured rat hippocampal neuron imaged via fluorescence of Arch. The protein localized to the membrane. Scale bar 10 μm. The group of FIGS. 11A-11G depict optical recording of APs with Arch, according to one embodiment.

FIG. 11B, left: Low-magnification image of neuron in FIG. 11A. FIG. 11B, right: Whole-field fluorescence trace (red) during a single-trial recording at 500 frames/s. The fluorescence has been scaled to overlay on the electrophysiology data (blue), with an r.m.s. deviation of 7.3 mV.

FIG. 11C, left: Pixel-by-pixel map of cross-correlation between whole-field and single-pixel intensities (red) overlaid on the average fluorescence (cyan). Note that the process extending to the top left of the cell body has vanished; it is electrically decoupled from the cell. FIG. 11C, right: Pixel-weighted fluorescence trace (red) with weighting coefficients determined via correlation to whole-field intensity. The weighted fluorescence has been scaled to overlay on the electrophysiology data (blue), with an r.m.s. deviation of 4.2 mV.

FIG. 11D, left: Pixel-by-pixel map of cross-correlation between electrophysiology data and single-pixel intensities (red) overlaid on the average fluorescence (cyan). FIG. 11D, right: Pixel-weighted fluorescence trace (red) with weighting coefficients determined via correlation to electrophysiology data. The r.m.s. deviation between fluorescence and voltage is 4.0 mV. Scale bar in FIG. 11B-FIG. 11D 50 μm.

FIG. 11E illustrates sub-cellular localization of an AP. Left: regions of interest indicated by colored polygons. Right: time-course of an AP averaged over 98 events in the regions indicated with the corresponding colors. The top black trace is the electrical recording. Optical recordings appear broadened due to the finite (2 ms) exposure time of the camera. The small protrusion indicated with the white arrow has a significantly delayed AP relative to the rest of the cell. Vertical scale on fluorescence traces is arbitrary. Scale bar 10 μm.

FIG. 11F represents a gallery of single-trial recordings of APs recorded at 500 μs/frame. The pixel weight matrix was determined from the accompanying electrophysiology recording, so fluorescence was automatically scaled to overlay on voltage. Top right: Averaged spike response for 269 events in a single cell, showing voltage (blue) and fluorescence (red).

FIG. 11G depicts the identification of processes associated with a single target neuron in a dense culture. Left: Time-average Arch fluorescence of multiple transfected neurons. Right: Membrane potential was modulated by whole-cell voltage clamp. Responsive pixels were identified via cross-correlation of pixel intensity and applied voltage, highlighting the target cell's neuronal processes (red). Scale bar 10 μm.

FIG. 12 illustrates action potentials of cells in accordance with certain embodiments of the invention. The vertical scale on the fluorescence traces is arbitrary. The lower regions of the cell did not have adequate SNR to indicate APs on a single-trial basis.

FIGS. 13A-13B illustrates various action potentials of cells, in yet other embodiments of the invention.

FIG. 14A Photocurrents in Arch WT and D95N, expressed in HEK cells clamped at V=0. Cells were illuminated with pulses of light at λ=640 nm, 1800 W/cm². The group of figures FIGS. 14A-14D depict ArchD95N showing voltage-dependent fluorescence but no photocurrent, according to one embodiment.

FIG. 14B shows ArchD95N fluorescence increased about 3-fold between −150 mV and +150 mV, with nearly linear sensitivity from −120 to +120 mV. Inset: map of voltage sensitivity. Scale bar 5 μm.

FIG. 14C depicts a dynamic response of ArchD95N to steps in membrane potential between −70 mV and +30 mV. Data averaged over 20 cycles. Inset: Step response comprised a component faster than 500 μs (20% of the response) and a component with a time constant of 41 ms.

FIG. 14D illustrates that after calibration with a voltage ramp, ArchD95N provided highly accurate estimates of membrane potential, clearly resolving voltage steps of about 10 mV, with a noise in the voltage estimated from fluorescence of 260 μV/(Hz)^{1/2} over timescales <12 s.

FIG. 15 depicts frequency response of ArchD95N, measured in the same manner as for Arch WT (FIG. 9).

FIG. 16A Electrically recorded membrane potential of a neuron expressing Arch WT, subjected to pulses of current injection and laser illumination (I=1800 W/cm², λ=640 nm). Illumination generated sufficient photocurrent to suppress APs when the cell was near threshold. Red bars indicate laser illumination. The group of FIGS. 16A-16D depict optical recording of APs with ArchD95N, according to one embodiment.

FIG. 16B shows data recorded under the same injection and illumination conditions as FIG. 16A in a neuron expressing ArchD95N, showing no effect of illumination on spiking or resting potential.

FIG. 16C shows a neuron expressing ArchD95N, showing ArchD95N fluorescence (cyan), and regions of voltage-dependent fluorescence (red). Scale bar 10 μm.

FIG. 16D represents a single-trial recording of whole-cell membrane potential (blue) and weighted ArchD95N fluorescence (red) during a train of APs.

FIG. 17 is a depiction of optical indicators of membrane potential classified by speed and sensitivity. Green squares represent indicators based on fusions of GFP homologues to membrane proteins. Pink squares represent indicators based on microbial rhodopsins. Blue diamonds represent organic dyes and hybrid dye-protein indicators. Extended bars denote indicators where two time constants have been reported. The Proteorhodopsin Optical Proton Sensor (PROPS) is homologous to ArchD95N. The speeds of most organic dyes are not known precisely; however they respond in less than 500 μs. The data plotted here is taken from Table 4.

FIG. 18A depicts a design of an Optopatch construct, according to some embodiments.

FIG. 18B is an illustration of an Optopatch construct in a plasma membrane of a cell. Blue light (488 nm) stimulated ChR64, causing the ion channel to open and the cell to fire. Red light (640 nm) excites fluorescence from Arch to a degree dependent on the membrane voltage.

FIG. 18C shows fluorescence and voltage from a neuron expressing the Optopatch construct as in FIG. 18B. Optical stimulation generated action potentials which were detected both via conventional patch clamp electrophysiology (bottom rows) and via fluorescence of Arch (top rows).

FIG. 19A depicts illumination apparatus used for spatially patterned and localized initiation of action potentials in conjunction with Optopatch experiments, according to one embodiment.

FIG. 19B shows a transient burst of red fluorescence indicating a single action potential occurrence responsive to blue light excitation in an Optopatch experiment.

FIG. 20A shows time resolved microscope images of a neuron in which the soma has been excited with blue light. Temporal dynamics of the propagating action potential was not resolved in the raw data.

FIG. 20B illustrates temporal super-resolution of action potential dynamics within a neuron. The temporal resolution achieved was about 100 microseconds.

The features and advantages of the present invention will become more apparent from the detailed description set forth below when taken in conjunction with the drawings.

### DETAILED DESCRIPTION

### I. Introduction

Various aspects of the present invention are generally directed to systems and methods for imaging at high spatial and/or temporal resolutions. In one aspect, the present invention is generally directed to an optical or microscopy system and related methods adapted for high spatial and temporal resolution of dynamic processes. The system may be used in conjunction with fluorescence imaging wherein the fluorescence may be mediated by voltage-indicating proteins. In some cases, time resolutions may be enhanced by fitting pre-defined temporal waveforms to signal values received from an image. The system may also contain a high numerical aperture objective lens and a zoom lens located in an imaging optical path to an object region. Other aspects of the present invention are generally directed to techniques of making or using such systems, kits involving such systems, manufactured storage devices able to implement such systems or methods, and the like.

Accordingly, in one set of embodiments, the present invention is generally directed to an optical or microscopy system, e.g., one that is able to observe and/or quantify time-varying and/or low-light-level processes. Such processes can include, for example, rapidly and/or spatially varying fluorescence of microscopic samples associated with voltage-indicating proteins (VIPs). In some cases, the VIPs are fluorescent. The development of the microscopy systems has proceeded in conjunction with research relating to the VIPs (e.g., microbial rhodopsins), though the microscopy systems as discussed herein are not intended to be limited to use with such proteins. Instead, the microscopy systems may be used in a variety of applications, e.g., with time-varying processes and/or low-light-level processes. For example, in some embodiments, sub-millisecond dynamics at micron-level resolution or below in samples such as cells or a living organism can be resolved with certain microscopy systems as discussed herein. In some embodiments, spatial resolution as small as 300 nm can be obtained with temporal resolution as short as 20 microseconds.

### II. Microscopy System

In various aspects, the present invention is generally directed to systems and methods for determining cells, or other samples, using voltage-indicating proteins. Examples of such voltage-indicating proteins include those discussed in detail below, as well as those described in Int. Pat. Apl. Ser. No. PCT/US11/48793, filed Aug. 23, 2011 and published under Int. Pub. No. WO/2012/027358 on Mar. 1, 2012; U.S. 61/376,049, filed Aug. 23, 2010; U.S. Pat. No. 61/412,972, filed Nov. 12, 2010; and U.S. Pat. No. 61/563,337, filed Nov. 23, 2011; each of which is incorporated herein by reference in its entirety, including any and all sequences contained therein, whether submitted on paper or electronically. Any cell may be used or studied, including but not limited to cells able to alter their voltage or transmembrane potentials, for example, cardiac cells or neurons. Other examples of cells are discussed herein or in Int. Pat. Apl. Ser. No. PCT/US11/48793.

One aspect of the present invention is generally directed to optical systems, such as microscopy systems, having an objective lens having a relatively high numerical aperture, and a zoom lens located in the imaging optical path to the object region. Typically, microscope objectives offer a trade-off between magnification and light-gathering capacity (numerical aperture). However, in some embodiments of the present invention, a zoom lens is positioned into the imaging optical path in a microscopy system where a high-NA objective lens is used. As is discussed in detail below, various embodiments are able to avoid this trade-off, and use both an objective lens having a relatively high numerical aperture, and a zoom lens located in the imaging optical path to the object region.

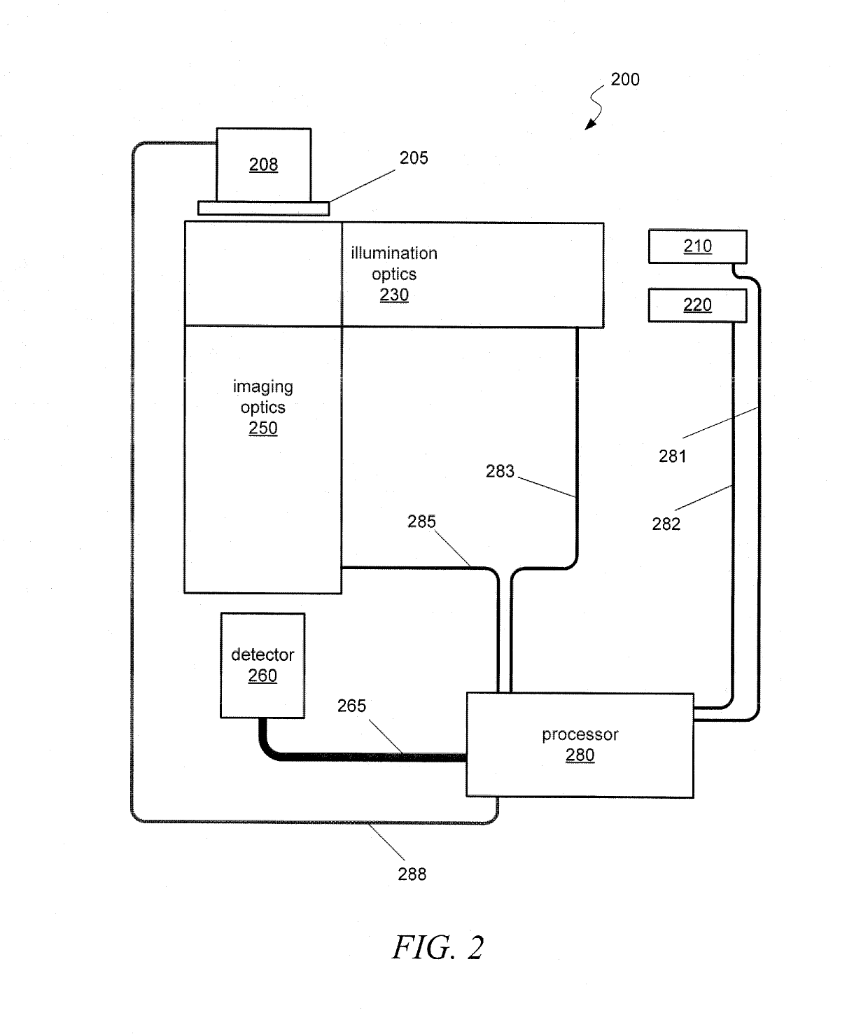

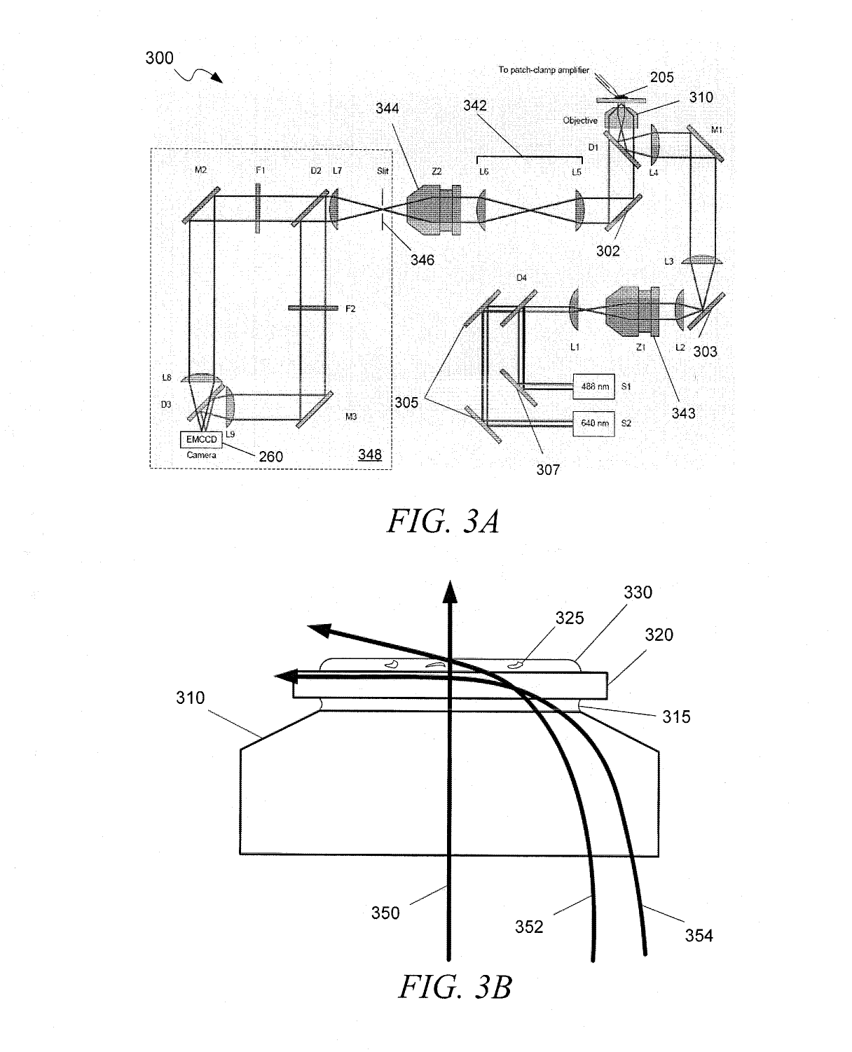

By way of introduction, as a non-limiting example, a high-speed, low-light-level microscopy system 200 is now discussed with reference to the block diagram of FIG. 2. Microscopy system 200 may be used in applications such as dynamic fluorescence imaging applications, or other applications as discussed herein. For example, the system may be used in some embodiments to observe and quantify time-varying dynamics at microscopic and sub-millisecond levels. According to one embodiment, microscopy system 200 comprises an object region 205 at which a sample to be observed may be placed, and sample supporting apparatus 208. The system further comprises illumination optics 230, imaging optics 250, one or more radiation sources 210, 220, a detector 260, and a processor 280. As indicated in FIG. 2, some optical components of the system may serve in some embodiments as components in both illumination optics 230 and imaging optics 250. This can be seen with reference to FIG. 3A, in which the objective lens 310 serves as both a focusing lens for illuminating radiation and an imaging lens.

Referring again to FIG. 2, object region 205 may comprise any spatial region in which a sample to be observed can be placed. In various embodiments, object region 205 is located at an optical object plane or location for imaging optics 250. A corresponding magnified image of the sample can be formed by imaging optics at detector 260.

Sample supporting apparatus 208 may comprise any suitable device configured to support a sample at the object region. As non-limiting examples, sample supporting apparatus 208 may comprise a low-fluorescence glass or polymer plate, a low-fluorescence multi-well plate, or a low-fluorescence material having at least one microfluidic channel in which a sample may be conveyed to and from the object region 205. Sample supporting apparatus 208 may also include, in some embodiments, micro- and/or nano-positioners, and may optionally provide for support of a patch clamp. Such micro- or nano-positioners may be used for translating or navigating across a sample (e.g., moving the sample to observe different regions of the sample, or moving to different wells of a multi-well plate, etc.). The micro- or nano-positioners may also be used in some cases for moving the sample into and out of focus.

In some embodiments, sample supporting apparatus 208 includes an environmental enclosure for supporting cells, biological systems, living organisms, etc. For example, the environmental enclosure may have temperature control, controlled gas flow, humidity control, light control, and/or controlled nutrient flow. The environmental controls may maintain an environment of 37° C., 5% CO₂ in some implementations, or other environments depending on the cells or biological system being studied. In some embodiments, electrical shielding may also be provided by sample supporting apparatus 208, for instance, to suppress electrical signals that may interfere with a patch clamp. In some embodiments, any one or combination of sample positioning, environmental controls, fluidic control, microfluidic control, etc. may be interfaced with a processor 280 for automated or semi-automated control. In addition, in some embodiments, air flow may be directed to minimize vibrations in the object region. Also, provisions may be made in some cases for flowing temperature-controlled, oxygenated culture medium to a sample in the object region 205, with possible injection of test compounds into the medium.

Detector 260 may be any suitable detector. For example, in one set of embodiments, detector 260 comprises an array of low-light-level photosensitive elements. In some cases, each element of the array may be configured to provide an output signal representative of a detected intensity level measured over a measurement time interval or time bin. The output signals may be provided, for example, in a suitable data structure (e.g., data frames comprised of multiple digital words) recognizable by a processor 280 to form a video image representative of an optical image sensed by the detector 260. In some cases, the output signals can be provided repeatedly to the processor 280 over time, e.g., so as to track time variations of an image sensed by the detector 260.

In some embodiments, detector 260 comprises a CCD array or camera or an electron multiplied CCD (EMCCD) array camera. In some embodiments, detector 260 comprises a MOSFET array or camera. The camera may operate at high framing speeds, e.g., greater than about 200 frames/sec in some embodiments, greater than about 500 frames/sec in some embodiments, and yet greater than about 1000 frames/sec in some embodiments. In another embodiment, detector 260 comprises an array of photomultipliers or an array of avalanche photodiodes for which signal outputs are provided to signal processing circuitry. According to one embodiment, detector 260 comprises an Andor iXon+860 EMCCD camera operating at up to 2,000 frames/s (using a small region of interest and pixel binning). In another implementation, detector 260 comprises an Andor iXon+897 EMCCD camera operating at slower framing speeds with a greater number of pixels being used to form an image at finer spatial resolution.

There may be any number of radiation sources used to illuminate object region 205. For example, in FIG. 2, a plurality of radiation sources 210, 220 is used to illuminate the object region 205. In other embodiments, there may be one radiation source, or two or more radiation sources. The radiation sources may be independently broadband, e.g., a white-light source, or narrow band, e.g., having an emission bandwidth less than about 50 nm in some embodiments, or less than about 20 nm in some embodiments. In some implementations, an acousto-optic tunable filter may be used to controllably select an emission band from a white-light source. Some or all of the radiation sources may provide radiation for illuminating the object region, e.g., at different wavelength bands. As a specific example, a first radiation source may provide first radiation in a first wavelength band between about 400 nm and about 550 nm, and a second radiation source may provide second radiation in a second wavelength band between about 560 nm and about 650 nm.

One or more of the radiation sources may be a laser in some embodiments, or may be another type of source, e.g., one or more high-intensity light-emitting diodes, an incandescent source. For instance, if a laser is used as a source, its output power may be adjustable is some implementations to any value between about 1 mW and about 1000 mW. In some embodiments, a first radiation source may provide first radiation in a first wavelength band centered about 488 nm at an output power of about 60 mW (e.g., an Omicron PhoxX 488-60 laser available from Omicron Laserage of Dudenhofen, Germany), and a second radiation source may provide second radiation in a second wavelength band centered about 640 nm at an output power of about 100 mW (e.g, a DL638-100-O, ultra-stable option, model laser available from Crystal Laser of Reno, Nev.).

One or more of the radiation sources may be tunable in some embodiments. In some implementations, an emission band specific to excitation of a fluorophore in a sample may be selectable from one or more of the radiation sources by filtering or tuning of the source. For example, one or more of the radiation sources may output radiation over a broad band of wavelengths, and a tunable filter (e.g., an acousto-optic tunable filter) may be used to select a specific excitation band from the laser's output. A tunable filter may also be used in some implementations to modulate the intensity of a laser at high speeds, e.g., at frequencies greater than about 1 MHz or on/off speeds less than about 1 microsecond. In some embodiments, one or more of the radiation sources may be controlled via a communication link 281, 282 by processor 280.

Processor 280 may comprise one or more microprocessors and/or one or more microcontrollers configured to manage operation of the optical system 200 and receive and process data from detector 260. Processor 280 may further include, in some cases, at least one data storage device, one or more data communication ports, and/or a user interface. In some embodiments, processor 280 may comprise a computer, such as a personal computer or a laptop computer. According to some embodiments, processor 280 may be or include one or more microcontrollers configured to interface with a computer. In certain embodiments, data storage devices may be included with the system 200, and/or may be embodied as peripherals and/or removable storage media. In various embodiments, processor 280 is adapted with machine-readable instructions and/or hardware to execute functionality of system control and/or data processing described herein. In some implementations, processor 280 may be configured to store raw data, or store partially processed raw data, that may be retrieved subsequently for processing and display. In some embodiments, processor 280 may be configured to be operated remotely via a network link, e.g., over an internet link or wireless link. Data obtained by the system 200 may be transferred over the network link for subsequent processing and/or display.

Illumination optics 230 may comprise one or more optical components that direct radiation from the one or more radiation sources (e.g., 210, 220 in FIG. 2) to object region 205. According to some embodiments, illumination optics 230 combine and/or provide for variable focus of multiple sources of radiation onto the object region 205. Variable focus can be used in certain cases to provide high illumination intensity (small focal spot) and/or wide-field illumination (large focal spot). In some implementations, the focal spots can be varied between about 50 microns and about 500 microns providing a corresponding variation in illumination intensity between about 40 W/cm² and about 4000 W/cm². The intensity may be varied further by controlling an output from a radiation source, at least in some instances.

Referring now to FIG. 3A, according to one embodiment, illumination optics 230 may be configured for epi-illumination. The illumination optics 230, in this non-limiting example, comprises a variable magnification zoom lens 343 to enable a user to select the size of the illumination spot at the object region 205. The zoom lens 343 may be placed between the one or more radiation sources 210 (S1), 220 (S2) and condensing optics that focus the radiation onto the object region. Radiation from each source may be combined, e.g., with a dichroic optic D4, to follow an illumination optical path. Dichroic optic D4 may, for example, reflect a first wavelength and transmit a second wavelength towards zoom lens 343. Illumination optics 230 may include additional mirrors, e.g., mirrors 305, 307, to direct radiation from sources S1, S2 to the dichroic optic D4, though in some embodiments these mirrors may be omitted and the lasers adjustably positioned to direct their respective outputs onto dichroic optic D4.

In some embodiments, illumination optics 230 may comprise a digital micromirror device (DMD), e.g., mirror 307 may be a digital micromirror. According to one embodiment, radiation from one radiation source may be reflected off the DMD and directed along the illumination optical path. Activation of pixels on the DMD may reflect portions of the radiation beam away from the illumination optical path and impart a pattern to the radiation beam. The patterned radiation beam may be imaged onto the object region to form spatially patterned illumination of a sample. In some implementations, the DMD may be located at an image plane in the illumination optical path such that an image of the DMD is formed in the object region 205. In another embodiment, the DMD may be located at a Fourier plane in the illumination optical path, e.g., at the location of mirror 303, such that a Fourier transform of the DMD is formed in the object region 205. When located at a Fourier plane, a Fourier transform of a desired image in the object region may be imparted to the radiation beam by the DMD. Spatially patterned illumination may be used to excite portions of a sample, e.g., selected portions of a cell, a biological organism, etc.

As shown in the example of FIG. 3A, focusing optic L1 may be disposed in the illumination optical path prior to zoom lens 343. According to one embodiment, focusing optic L1 and zoom lens 343 provide variable expansion of each radiation beam passing through the lens L1/zoom-lens 343 pair. In some embodiments, the zoom lens 343 provides a variable focal length between about 18 mm to about 200 mm and a variable f-number between about 3.6 and about 6.3. Zoom lens 343 may be, as an example, a Sigma 18-200 mm F3.5-6.3 DC lens available from Sigma Corporation of America, Ronkonkoma, N.Y.

According to some embodiments, zoom lens 343 may be configured to work in concert with variable magnification imaging optics described below. For example, zoom lens 343 may be adjusted to be responsive to adjustments in the imaging magnification, such that a smaller illumination focal spot is produced at high magnifications and a larger focal spot is produced at low magnifications. In some embodiments, adjustments may also be made to radiation sources so as to maintain constant illumination intensity (W/cm²) at low and high magnifications.

Illumination optics 230 may further include, in some cases, additional beam expansion optics provided by a second lens pair L2, L3 located in the illumination optical path after zoom lens 343. Though a turning mirror 303 may be used in some embodiments to fold the illumination optical path as shown in FIG. 3A, in other embodiments the turning mirror 303 may be omitted and the illumination optical path made substantially straight, e.g., substantially parallel to an imaging optical path described below. In some embodiments, a spatial filter, e.g., a pinhole, may be located at a focal region between lenses L2 and L3 to remove spatial high-frequency components from both radiation beams. In some implementations, lenses L1, L2, and L3 are achromatic doublets.

Illumination optics 230 may further include a turning mirror M1, a condensing lens L4, a multi-chroic optic D1, and an objective lens 310 as depicted in the example of FIG. 3A. Turning mirror M1 may include adjustment mechanisms (e.g., manual knobs or instrument controlled actuators, etc.) and be located at a sufficient distance from the object region 205 so as to provide primarily translation of the illuminating beams near the object region, e.g., translation across objective lens 310. Condensing lens L4 may be an achromatic doublet and located to reduce the illuminating beam waists to a value less than the entrance aperture of the objective 310 at the entrance of the illuminating beams into the objective.

Multi-chroic optic D1 may be selectively designed in some embodiments to be used to direct illumination radiation of one or more wavelength bands to the object region 205, and transmit fluorescence radiation of one or more wavelength bands along the imaging optical path of the system 200. According to one embodiment, multi-chroic optic D1 comprises a quad band filter. Optic D1 and objective 310 may be common or shared in both illumination optics 230 and imaging optics 250.

Adjustments to mirror M1 can vary the type of illumination, as depicted in FIG. 3B, in accordance with certain embodiments of the invention. For example, when in a first position, mirror M1 may direct illuminating beams along a normal illumination path 250 providing normal or conventional epi-illumination. When adjusted to a second position, mirror M1 may direct illuminating beams along a slim-field illumination path 352 providing through-the-objective, glancing-incidence, slim-field illumination in the object region 205. When adjusted to a third position, mirror M1 may direct illuminating beams along a total internal reflection path 354 providing for through-the-objective, total-internal-reflection-fluorescence (TIRF) illumination in the object region. Slim-field and TIRF illumination may be used to reduce unwanted fluorescence contributions from out-of-focus material in the object region. In the absence of debris or out-of-focus fluorescent material, conventional epifluorescence illumination may provide adequate signal-to-noise ratio.

Objective lens 310 may be, for example, a high quality microscope or fluorescence microscope objective lens having multiple optical components. Objective 310 may provide any suitable magnification, e.g., a magnification of about 20× in some embodiments, more than about 20× in some embodiments, more than about 40× in some embodiments, more than about 50× in some embodiments, and yet about 60× in some embodiments. In one embodiment, objective 310 may provide a magnification of about 100×. The objection lens 310 may be configured for use as an oil immersion objective lens or water dipping objective lens, and provide a numerical aperture (NA) greater than about 0.9. Higher NA values increase the amount of collected radiation from the object region. In some implementations, the objective lens provides an NA greater than about 1.0, in some cases greater than about 1.1, in some cases greater than about 1.2, in some cases greater than about 1.3, and yet in some implementations greater than about 1.4. As one non-limiting example, the objective lens may comprise an Olympus objective, model 1-U2B616, 60×, oil immersion lens providing an NA of about 1.45, available from Olympus America Inc., Center Valley, Pa.

Any suitable configuration may be used for the microscopy system, e.g., upright, inverted, etc. As an example, according to some embodiments, microscopy system 200 may be configured as an inverted microscope that provides epi-side illumination, as depicted in FIG. 3A. Such a configuration permits ample working room near the object region from the top side to permit use of environmental controls, fluidic controls, sample exchange, and/or application of a patch clamp. FIG. 3B depicts one configuration of the objective 310 and object region. Oil or water may be placed between the objective 310 and a sample plate 320. Samples 325 to be observed may be in a fluid 330 on the plate, e.g., in a droplet, in a well, in a microfluidic channel. Illuminating radiation may pass through the objective and illuminate the sample. Fluorescence from a sample may be collected by the objective and directed to an image detection plane of the system 200.

Referring again to FIG. 3A, imaging optics 250 may include objective 310 and multi-chroic optic D1, as described above. Imaging optics may further include a zoom lens 344 in an imaging optical path as depicted in this figure. The zoom lens may be configured, in certain cases, to provide imaging at continuously variable magnification of a sample in the object region 205. For example, the zoom lens 344 may be used to provide imaging magnification continuously variable between about 10× and 66×, without touching the objective. According to one embodiment, the zoom lens provides a variable focal length between about 18 mm to about 200 mm and a variable f-number between about 3.6 and about 5.6. Zoom lens 344 may be, as a non-limiting example, a 18-200 mm f/3.5-5.6G IF-ED lens available from Nikon Inc., Melville, N.Y.

The use of a zoom lens in the imaging optics 250 allows, in certain embodiments, collection of fluorescence with high efficiency, while also providing a large field of view. For example, the field of view may be large enough to image at least part of a cell, or even the entire cell in some cases. As a specific example, the field of view may contain an entire neuron and its biological processes (e.g., axons, dendrites, etc.).

Additionally, in some cases, the imaging system allows a user to change magnification without touching or affecting the sample being studied (for example, while maintaining a patch-clamp connection to a cell). In some cases, as is shown in FIG. 3A, the imaging optics and zoom lens 344 allows the splitting of the field of view into two wavelength bands, and also allows changing magnification without changing the registration of the two halves of the image, as described herein.

In some embodiments, to accommodate the zoom lens in the imaging path, relay optics 342 may be disposed between the objective 310 and zoom lens 344, as is shown in the example of FIG. 3A. According to one embodiment, relay optics may comprise an achromatic doublet lens pair L5, L6 configured to relay an image at the objective lens 310 to a location near an entrance aperture or entrance pupil of the zoom lens 344. Relay optics 342 may direct divergent radiation from the objective lens 310, that would otherwise miss zoom lens 344 and be lost, into zoom lens. A turning mirror 302 may be disposed in the imaging optical path to fold the path in some embodiments, for space considerations. In another embodiment, turning mirror 302 may be omitted and the imaging optical path made straight from the objective lens, e.g., substantially parallel to the illumination optical path. The diameters of the elements of relay optics 342 are selected to capture substantially all of the light emerging from the back aperture of the objective lens 310, and to introduce minimal aberration into the image.

In certain embodiments, imaging optics 250 may further comprise a split-field, dichroic, image-capture apparatus 348 disposed after zoom lens 344, though in some embodiments, detector 260 as described above may be located at an image plane following zoom lens 344. In some embodiments, a split-field, dichroic, image-capture apparatus 348 may comprise adjustable slit 346 located substantially at an image plane following zoom lens 344. The image at the image plane, and of the slit, may be relayed in some cases by lens pairs L7-L8 and L7-L9 along two paths to detector 260 (shown as an EMCCD in FIG. 3A). The imaging beam may in certain cases be chromatically split by a dichroic mirror D2, located after lens L7. For example, D2 may reflect wavelengths shorter than a selected wavelength (e.g., about 660 nm) and transmit wavelengths longer than the selected wavelength. The split images may be passed through narrow bandpass filters F1 and F2 that are selected to block radiation outside a desired fluorescence band. The imaging beams may then be recombined using a second dichroic mirror D3 such that two images are formed at detector 260. In some embodiments, the slit is adjusted so that each of the two images substantially fills one-half of an imaging array at the detector. In this manner, side-by-side images of different wavelength fluorescence can be observed simultaneously. As a non-limiting example, in one embodiment, fluorescence from a fluorophore such as GFP and a VIP can be viewed simultaneously with the split-field, dichroic, image-capture apparatus 348.

Turning mirrors M2 and M3 may be included in each imaging path in some embodiments, and include adjustments for positioning each image on the detector array. The split-field, dichroic, image-capture apparatus 348 can be readily converted between single-band and dual-band imaging, with only mirror realignment in some embodiments. For example, the slit 346 can be widened and one of the two imaging beam paths blocked. A turning mirror M2 or M3 may then be adjusted to center an image on the detector array at detector 260.

According to one embodiment, parameters for the optical components of the system 300 depicted in FIG. 3A are given in the following list, though this list is provided for example only and not to limit the invention.
Illumination sources: S1—488 nm, 60 mW (Omicron PhoxX). S2—640 nm, 100 mW (CrystaLaser, DL638-100-O, ultra-stable option).
Dichroic mirrors: D1—405/488/561/635 quad pass (Semrock). D2, D3—662 long pass, imaging flatness (Semrock). D4—503 long pass (Semrock).
Broadband mirrors: M1, M2 and M3 are Ø2″ broadband dielectric mirrors. All other mirrors shown are Ø1″.
Fixed lenses (all achromatic doublets): L1—Ø1″ f=25 mm, L2—Ø1″ f=60 mm, L3 Ø2″ f=150 mm, L4, L6, L7, L8, L9—Ø2″ f=100 mm, L5—Ø1″ f=100 mm.
Filters: F1—700/75 bandpass (Chroma). F2—580/60 bandpass (Chroma).
Zoom lenses: Z1—18-200 mm f/3.5-6.3 (Sigma). Z2—18-200 mm f/3.6-5.6 (Nikon).
Objective: Olympus 1-U2B616 60× oil NA 1.45.

### III. Observation of Dynamic Processes with the Microscopy System

The microscopy system 200 described above may be used in conjunction with VIPs to observe and capture high-speed processes, for example, dynamic biological processes such as the electrical activity in certain types of cells. For example, the timing of electrical spikes in some types of cells (e.g., neurons or cardiac cells), and the sub-cellular dynamics in the propagation of electrical spikes may be observed in accordance with certain embodiments of the invention. Additionally, voltage-induced fluctuations in fluorescence may be used to identify single cells within an overly dense image of many cell types, in some embodiments.

Microscopic optical recordings of electrical activity in cells present data capture and analysis challenges. One challenge to observing at microscopic levels rapid dynamics is that existing EMCCD cameras acquire data at frame rates less than 500 frames/sec at a pixel resolution of 128×128 pixels, or 1000 frames/sec at a resolution of 64×64 pixels. However, electrical activity in cells can be fast in comparison, e.g., an action potential lasts on the order of 1 ms. Accordingly, many cameras do not have sufficient temporal precision to observe certain types of events.

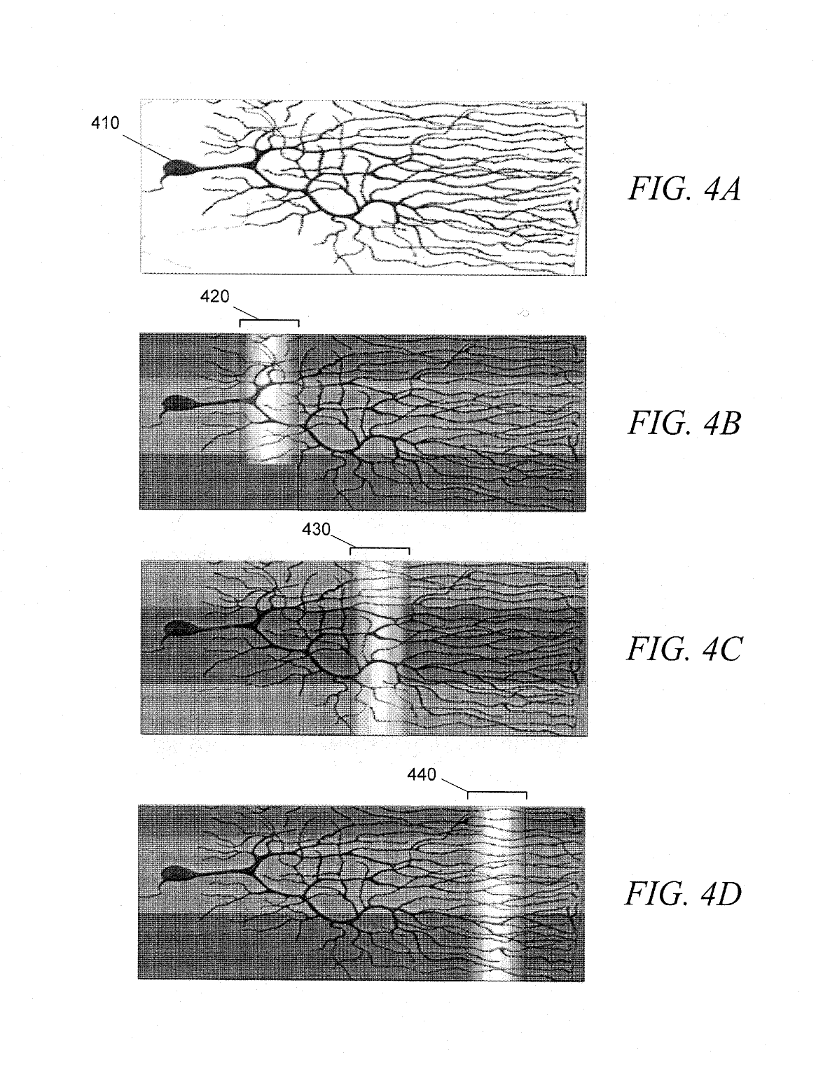

As a non-limiting example, one might wish to track the evolution of an action potential in a neuron using VIPs as depicted in FIGS. 4A-4C. FIG. 4A depicts a neuron with a cell body 410 and a plurality of axon terminals. For instance, one might wish to track the evolution of an action potential that might stimulate fluorescence via VIPs, as it propagates from the cell body 410 along one or more axons to axon terminals. With high temporal resolution, such an event might appear as depicted in FIGS. 4B-4C where the light-shaded portions 420, 430, 440 are meant to depict evolution of VIP-mediated fluorescence as the action potential propagates within the neuron. However, due to their frame rate limitations, many cameras lack adequate time resolution to observe sub-cellular dynamics of such fast electrical activities.

Accordingly, another aspect of the present invention is generally directed to temporally resolving a time-varying image. Such systems and methods as described below may be used in conjunction with the microscopy system discussed herein and/or the VIPs, but they are not so limited. In other embodiments, the systems and methods discussed herein may be used to temporally resolve a time-varying image at a resolution or a precision that is less than the time bins or frame rate used to acquire the time-varying image, i.e., temporal super-resolution of the time-varying image may be obtained, as is discussed in detail herein. In one set of embodiments, the temporal super-resolution may be obtained by fitting the signal values of the time-varying image to a pre-defined temporal waveform, e.g., the algorithm makes use of a known or suspected temporal profile for a dynamic event that is to be resolved.

As an example, temporal super-resolution of an action potential will be described. In this example, data collected from a detector, such as a camera, can be processed according to a temporal super-resolution algorithm developed to reveal sub-cellular dynamics. However, it should be understood that this is by way of example only, and in other embodiments of the invention, other types of time-varying images may be analyzed. The sample need not be a neuron, and may be for example, a cardiac cell or other cell, a biological sample, or any other sample. For example, a high-speed chemical reaction may be imaged at high time resolutions, as is discussed herein. In addition, it should be understood that the systems and methods discussed herein are not limited to only detecting fluorescence images. Other types of microscope images, or other types of images, may also be studied at high time resolutions. Examples include, but are not limited to, magnetic resonance imaging, X-ray imaging, video images (e.g., microscopic or non-microscopic), or the like. Any time-varying image that is acquired using time bins or a frame rate may be studied in various embodiments of the invention. In some cases, as discussed below, the time-varying image may be studied using a known or suspected temporal profile for a dynamic event captured within the time-varying image. For example, if the temporal profile is not actually known, an estimated temporal profile, such as a Gaussian distribution, may be used in accordance with certain embodiments of the invention.

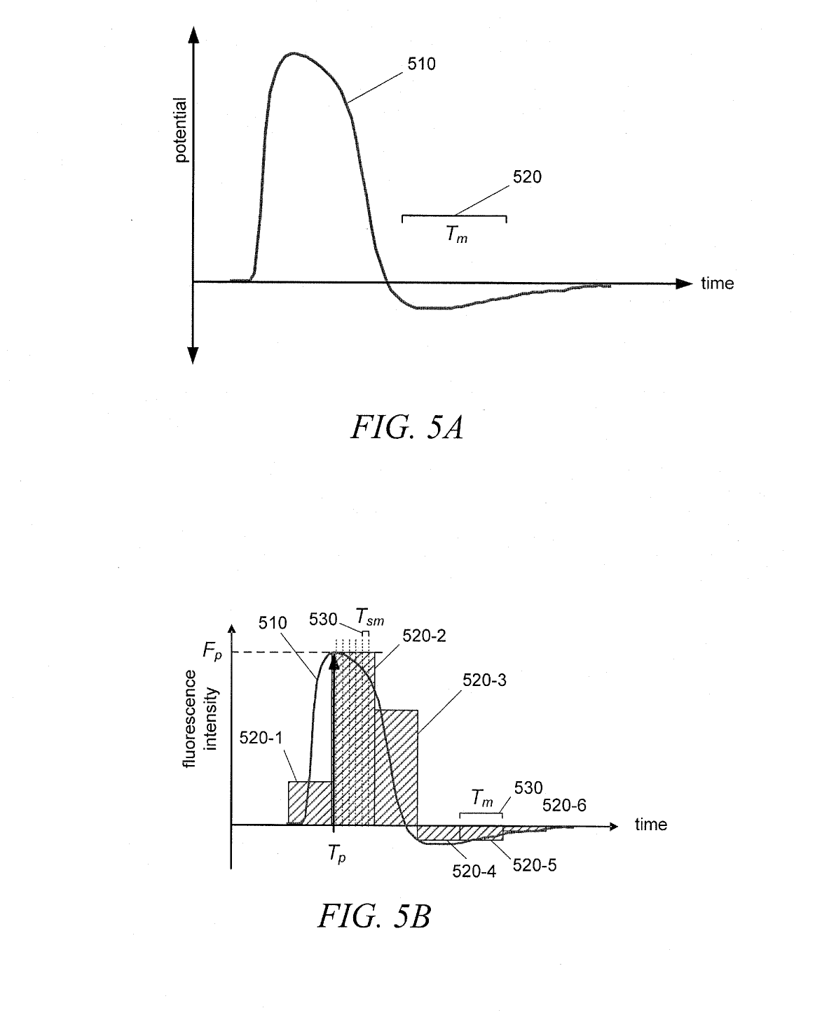

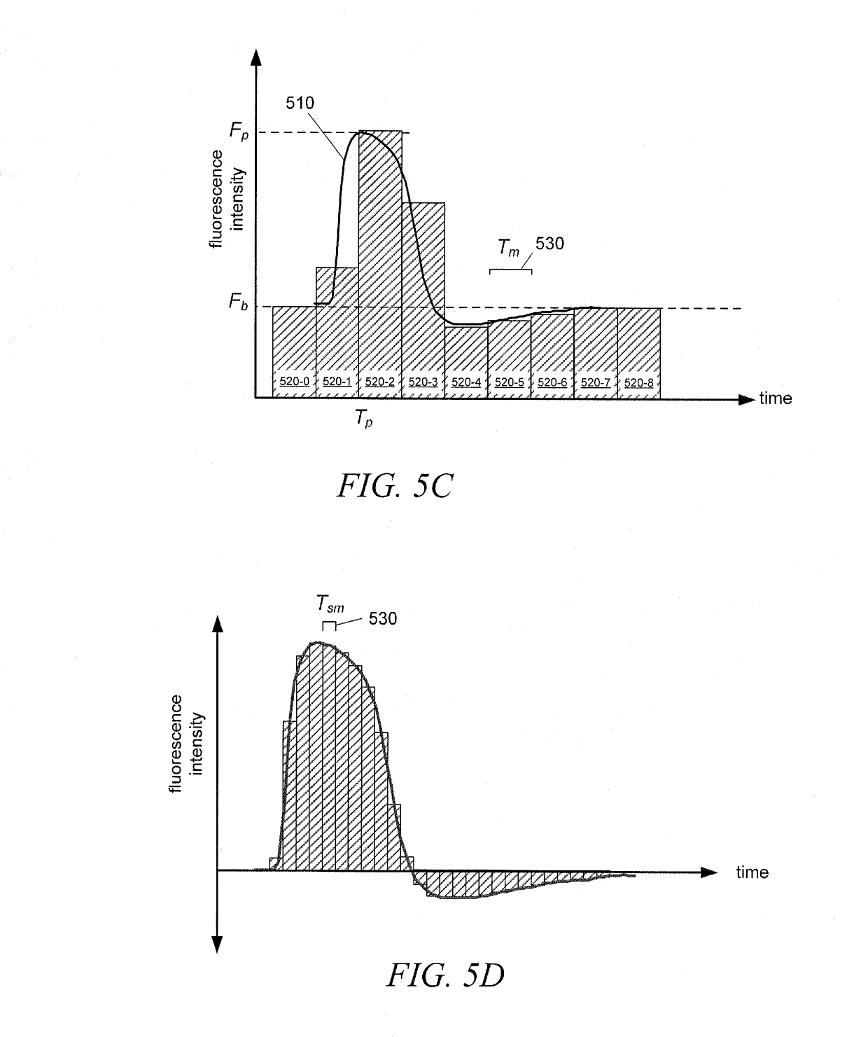

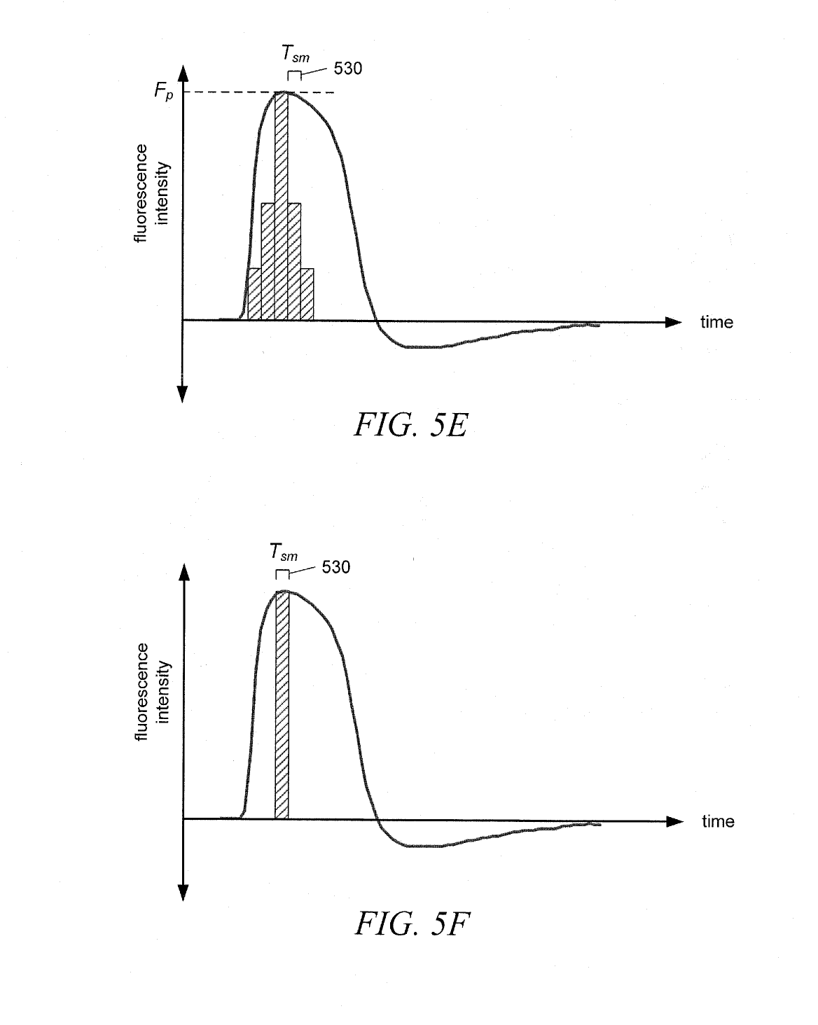

As mentioned, this example illustrates the evolution of VIP-mediated fluorescence as an action potential propagates within a neuron. The time course of an action potential is approximately known a priori, and its waveform is approximately as depicted in FIG. 5A, at least for certain types of neurons. When an action potential is recorded by a high-speed camera (or other suitable detector) using VIPs and the microscopy system described above, each pixel of the camera samples the waveform (integrates fluorescence emission from corresponding region of the sample) with a time resolution limited by the integration time for the pixel within the detector. The integration time may also be referred to as a measurement “time interval” or a measurement “time bin,” and for each pixel, this may be about equal to the inverse of the frame rate of the camera; for example, about 1 ms for a high-speed camera operating at low resolution (64×64 pixels). It should be noted that the time bins may be regularly spaced in time, but this is not a requirement; in some cases, irregular time bins may also be used.

In the present example, waveform 510 of the action potential is discretized by the detector 260, and may appear as a sequence of discrete values 520-1 to 520-6 as depicted in FIG. 5B. Given this relatively low time resolution, created by the frame rate of the camera or other detector, when the action potential propagates quickly within the cell, then the entire cell may appear to follow the same time-evolution simultaneously everywhere in the cell, and sub-cellular dynamics would not be resolved using such detectors.

However, since the waveform 510 of the action potential is known, the underlying waveform 510 may be fit to the measured discretized data, for some or all of the pixels, using one or more parameters of the waveform as a fitting parameter, e.g., start of waveform, peak value, half-peak values, width of peak, zero-crossing value, or the like. In some embodiments, repeated measurements may be taken to obtain average values for discretized data 520-1 to 520-6, for example, in samples involving repeated time-varying events, e.g., that are substantially identical. As is discussed herein, the fitting procedure can be performed with a precision much smaller than the frame rate (i.e., such that the temporal resolution has a precision smaller than the duration of a time bin or a single frame). The signal values corresponding to a time-varying image can be fit independently at each pixel with the underlying waveforms, resulting in temporal resolutions that are finer or more precise than the signal integration time for each pixel, thereby achieving temporal super-resolution.

After fitting the underlying waveforms to recorded signal values at each pixel, an occurrence of an event characterized by the waveform may be determined in some embodiments of the invention. For example, an occurrence of a peak (Fₚ occurring at time Tₚ as depicted in FIG. 5B) in the waveform may be determined from the fitted waveform 510 to a resolution Tₛₘ much higher than the measurement time interval Tₘ. Occurrences of other events may be determined, e.g., onset of the action potential, zero-crossing of the potential, etc., based on knowledge of the temporal waveform.

The particular shape used for the underlying waveform 510 is not necessarily critical in certain embodiments of the invention. In some cases, a waveform shape may be used consistently throughout to produce temporal super-resolution, even if the underlying waveform is not known with precision, or even if the underlying waveform selected is incorrect. In other embodiments, it may be known a priori that the underlying waveform varies across a sample (for example, varies as a function of location, or as a function of the number of events, etc.), and the fitting waveform may be varied accordingly. In some embodiments, a Gaussian waveform may be used, in one embodiment a Lorentzian waveform may be used, in one embodiment a lognormal waveform may be used, in one embodiment a waveform comprising one or more exponentials may be used. It will be appreciated that various waveforms known to be representative of biological processes, or a process to be observed, can be fit to the measured signal values. In some cases, even if the temporal profile for a dynamic event is not known with certainty, the dynamic event may still be studied as discussed herein by using an estimate of the temporal profile for the dynamic event. For example, temporal waveforms such as Gaussians, Lorentzians, or lognormals may be used to study a dynamic event even if little is known about the temporal waveform itself; for example, the only knowledge of the event may be that it occurs over a finite period of time.

In some cases, the waveform used may include a constant offset, e.g., an offset Fₚ representative of a background signal as shown in FIG. 5C. The measured signal values 520-0 to 520-8 may include a contribution from the background, so that the waveform 510 rides on top of the background. In other cases, a background signal value may be subtracted from the measured data prior to fitting a waveform to the data.

A new “movie” or series of time-varying images may be created of the time-varying image using results of the fitting, in some embodiments of the invention. This may be useful, for example, for visualization of a time-varying event. According to one embodiment, the measurement time intervals Tₘ may be subdivided into sub-intervals Tₛₘ and signal values for each sub-interval generated numerically. Tₛₘ may correspond to an uncertainty to which an occurrence of an event in the waveform is known, and may be dependent upon the signal-to-noise quality of the recorded signal values. In some embodiments, Tₛₘ may be between about ⅓ of Tₘ and about ⅛ of Tₘ. In some embodiments, Tₛₘ may be between about ⅛ of Tₘ and about 1/20 of Tₘ. In some embodiments, Tₛₘ may be between about 1/20 of Tₘ and about 1/50 of Tₘ. In some embodiments, Tₛₘ may be between about 1/50 of Tₘ and about 1/100 of Tₘ. In some embodiments, Tₛₘ may be between about 1/100 of Tₘ and about 1/200 of Tₘ. In some embodiments, Tₛₘ may be between about 1/200 of Tₘ and about 1/500 of Tₘ. The new movie may comprise sequential display, e.g., on a video monitor, video data comprising a sequence of at least some of the generated signal values for the sub-intervals. It will be appreciated that the temporal resolution of the new movie would correspond to a much higher framing rate of a camera. For example, if a time-varying image is recorded with measurement time intervals Tₘ of about 1 ms per frame and the time-varying image can be temporally resolved to about 1/100 of Tₘ using the methods described above, the an effective or equivalent framing rate of the camera would be about 100,000 frames/sec. Accordingly, the movie would have temporal super-resolution compared to the original time-varying image.

In various embodiments, new data values may be generated for each sub-interval and in correspondence with each imaging pixel. According to one embodiment, the data values for each sub-interval may correspond to a value of the underlying waveform 510 as shown in FIG. 5D. The new movie would then comprise displaying, in association with each pixel, a sequence of the data values generated for the sub-intervals. As will be appreciated, the temporal resolution of the recorded time-varying image improves from about Tₘ to about Tₛₘ.

In some embodiments, signal values for time intervals or time bins at times other than the occurrence of an event characteristic of the underlying waveform may be suppressed below the waveform as depicted in FIGS. 5E and 5F. By way of example, an event characteristic of the underlying waveform may be the peak of the waveform. All generated signal values may be suppressed to a null value or a pre-selected value except in the vicinity of the peak. Near the peak, the signal values may rise to a peak value Fₚ or a scaled peak value, as depicted in FIG. 5E. According to one embodiment, all signal values may be suppressed at time intervals other than the peak, as depicted in FIG. 5F. For this case, a flash may be displayed at the time corresponding to the peak of the fitted waveform.

In another set of embodiments, events that do not sufficiently correspond with an expected temporal waveform may be eliminated or suppressed. This may be useful, for example, to reduce or eliminate “noise” in a time-varying image, e.g., signals that are not part of a temporal event of interest, and thus can be eliminated from further consideration. For example, an event having a duration less than about half or less than about a third of the expected temporal waveform could be eliminated from further consideration as being suspect noise. Similarly, in some cases, an event having a duration of greater than 2, 3, or 4 times the duration of the expected temporal waveform could be eliminated from further consideration.

In some embodiments, suppression of generated signal values may be to a recorded background signal value for each pixel. The background signal values may be obtained prior, during, or after a measurement trial. For example, the background signal may be an average signal for each pixel in the absence of a dynamic process to be observed. Suppressing signals to an average background level can maintain an image of the sample when displaying a temporally-resolved video of the dynamic process.

In one implementation, various received signal values may be suppressed in any manner described above, e.g., when a characteristic event does not occur within the received signal value measurement interval Tₘ, or when a characteristic event does not occur as expected. In such an implementation, the original time-varying image may be replayed, at the same pixel and temporal resolution, but with at least some received signal values suppressed.

Suppressing signal values for times other than the occurrence of a characteristic event can improve the spatio-temporal resolution of a microscopy system for fast dynamical processes. For example, it can allow the tracking of a peak or crest of a waveform, such as an action potential, across a sample. In this manner, a time-varying image with high spatial and temporal resolution can be produced, recorded, and displayed. The time evolution crudely depicted in FIGS. 4B-4D would roughly resemble an actual spatial-temporal resolved movie of a dynamic biological process, according to one embodiment of the invention.

The fitting procedures described above may benefit, in some embodiments, from higher signal-to-noise ratios. In some implementations, a single-trial measurement lacks sufficient signal-to-noise ratio for providing accurate temporal super-resolution. In this case recorded movies of multiple trials may be temporally registered and averaged together to create an averaged movie with an adequate signal-to-noise ratio, which may then be used for waveform fitting and generating a temporal and/or spatio-temporal super-resolution movie of the process. Since some dynamic processes may be fast, e.g. a few milliseconds for an action potential, tens, hundreds, or even thousands of trials could be carried out within a few seconds, at least in some embodiments of the invention.

According to one embodiment, multiple time-varying images of an event (e.g., multiple action potential responses) may be recorded for a sample to improve signal-to-noise quality. The multiple events may be recorded, registered in time to a common reference, and then combined (e.g., summed or averaged) to increase the signal-to-noise ratio. In one example, each action potential response may last about 30 frames. About 100 videos of the AP response may be recorded, each from which a 30-frame snippet corresponding to the event may be extracted. The snippets may then be temporally registered to a common reference, e.g., initial excitation of the AP, maximum value of the AP, a selected signal value on a rising edge of the AP, etc. Then the snippets may be averaged together to create a 30-frame movie of an “average” AP. Waveform fitting may then be done using the averaged movie. In some embodiments, the event to be observed may have a duration that is greater than or less than 30 frames (e.g., between about 30 and about 100, between about 100 and about 200, between about 200 and about 500, or between about 10 and about 30, between about 4 and about 10) and the number of videos recorded for averaging may be greater than or less than 100 (e.g., between about 100 and about 200, between about 200 and about 500, between about 500 and about 1000, or between about 50 and about 100, between about 20 and about 50, between about 10 and about 20, between about 2 and about 10).

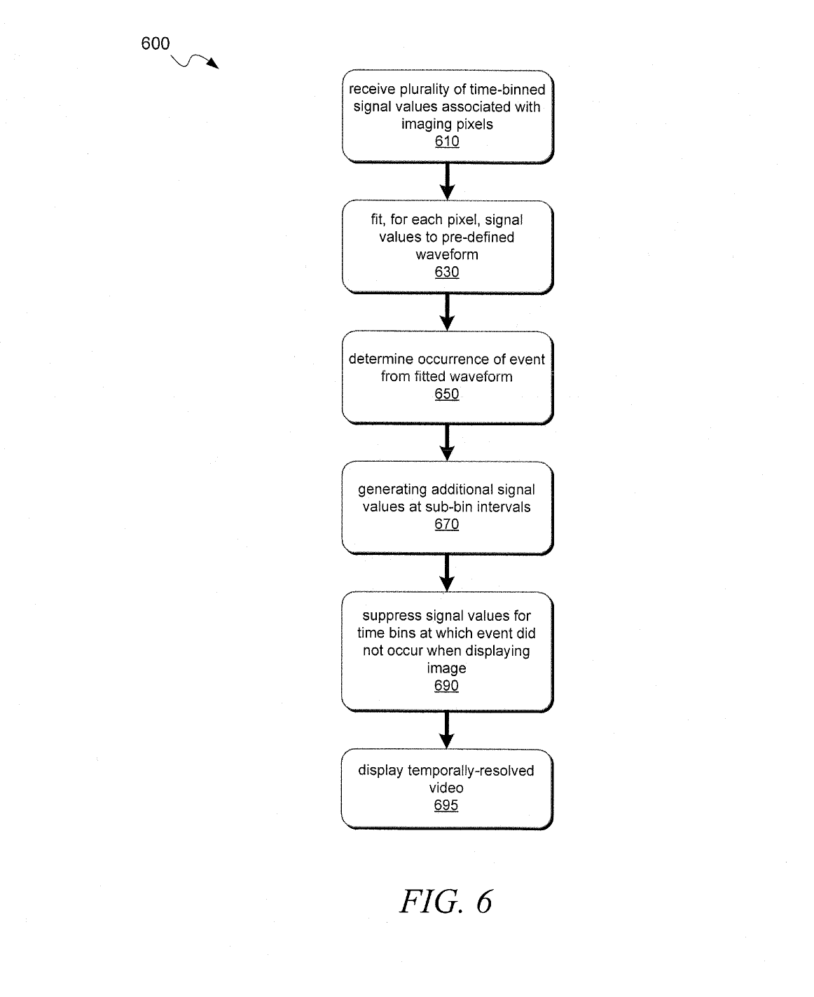

FIG. 6 illustrates, by a flow diagram, one embodiment of a method 600 for temporally resolving a time varying image. As previously discussed, variations on this method are also possible in other embodiments of the present invention. In this example, the method comprises an act of receiving 610, from a plurality of imaging pixels, a plurality of signal values associated with a plurality of measurement time bins during which the time-varying image was obtained. The time bins may be signal-integration times associated with the imaging pixels. The method may further comprise an act of fitting 630, for each of the pixels, a pre-defined temporal waveform to the respective signal values received for each pixel.

According to some embodiments, the method 600 may further include determining 650, for each pixel, an occurrence in time of an event characterized by the waveform. For example, the occurrence of a peak in the fitted waveform may be determined based upon the fit. Also included may be an act of generating 670, for each pixel, a plurality of additional signal values corresponding to measurement intervals less than signal integration times for each pixel. The generated signal values may be representative of time evolution of the time-varying image, e.g., approximately track the underlying waveform as depicted in FIG. 5D. In some implementations, the generated signal values may not be representative of time evolution of the time-varying image, e.g., emphasize a characteristic event in the fitted waveform as depicted in FIG. 5E or FIG. 5F.

The method 600 may further optionally include acts of suppressing 690 received signal values or generated signal values at time bins for which the event did not occur when displaying the time-varying image, and displaying 695 a temporally-resolved video of the measured time-varying image. The suppressing 690 of signal values may be to values less than values representative of the fitted waveform. In some embodiments, the suppressed signal values may be to a zero signal level or background signal level. The displaying may optionally comprise displaying the video on a video monitor of the temporally-resolved time-varying image. The method may further include, in some embodiments, storing the temporally-resolved time-varying image in a data storage device for subsequent retrieval and further data analysis.

As mentioned, the above discussion, although made in the context of determining a neuron in conjunction with a microscopy system as is discussed herein and certain VIPs, should not be understood to be limited as such. In various embodiments, the systems and methods discussed herein may be used to temporally resolve any time-varying image at a resolution or a precision that is less than the time bins or frame rate used to acquire the time-varying image.

### IV. Systems and Methods of Analysis of Voltage-Indicating Proteins

As mentioned, some aspects of the present invention are generally directed to systems and methods for studying various properties of cells, or other samples, using voltage-indicating proteins (VIPs). For example, in one set of embodiments, the systems and methods discussed herein may be used to screen drugs or other pharmaceutical agents that are suspected of modulating membrane potential or the electrical behavior of cells or other biological samples, as one non-limiting example. In some cases, various biological processes may be studied, e.g., to determine their response to potential drugs or other pharmaceutical agents. In certain cases, such study may include sub-millisecond dynamics at micron-level resolution or below in samples such as cells or a living organism.

Other areas of application include, but are not limited to: assays for hERG antagonists (hERG is a potassium ion channel) or cardiotoxicity; modulators of neuronal ion channels; modulators of cardiac ion channels; and compounds that direct the growth and differentiation of stem cells. Though a portion of the description herein is directed to the use of VIPs in neurons, it will be appreciated that this is by way of example only, and in other embodiments, other VIPs, in conjunction with microscopy systems, e.g. as described herein, can be used for other electrically active cells such as cardiomyocytes, immune cells, pancreatic beta cells, or the like.

For example, in one set of embodiments, a cell (or a portion thereof) may be excited or stimulated, and the response of the cell may be determined, for example, the voltage or membrane potential of the cell. For instance, the cell or a portion thereof may be excited or stimulated, and the voltage or membrane potential of the cell may be determined as a function of space and/or time after the cell has been stimulated. In certain embodiments, for example, no more than about 75%, no more than about 50%, no more than about 25%, or no more than about 10% of the cell may be stimulated, e.g., as discussed herein. As a specific non-limiting example, a specific portion of a neuron (e.g., an axon, a dendrite, a soma, etc.) may be stimulated, e.g., depolarized, and the voltage or membrane potential of the neuron may be studied in response to the stimulation. As another non-limiting example, a cardiac cell may be stimulated, and the voltage or membrane potential of the cardiac cell in response to the stimulation may be studied, e.g., to determine transmission of electrical signals within cardiac cells or tissue. In some cases, a cell may be tested while being exposed to a drug or other pharmaceutical agent (including potential drugs or pharmaceutical agents, e.g., as in a screening assay where the behavior of the cells in the presence of the potential drugs or pharmaceutical agents is determined).

In one set of embodiments, a cell (or portion thereof) may be stimulated using a light-sensitive moiety. The light-sensitive moiety may be any moiety that can react to light to stimulate or otherwise interact with the cell. Light may be used, for example, to produce a change in an electrical property of a cell, such as a change in the voltage or membrane potential of the cell. For example, light may be applied to the light-sensitive moiety and in response, an entity may be released by the light-sensitive moiety, a photosensitive reaction may occur, an ion channel may be opened or closed, or the like. In certain embodiments, the voltage-indicating protein and the light-sensitive moiety are each contained within the cell. For example, one or both may be present in the plasma membrane of the cell.

Thus, in one set of embodiments, a cell (or other sample) may comprise a voltage-indicating protein, and a light-sensitive moiety. The voltage-indicating protein and the light-sensitive moiety may be separately present within the cell (e.g., within the plasma membrane), and/or the voltage-indicating protein and the light-sensitive moiety are linked to each other, e.g., covalently bonded to each other or fused together to form a fused protein. Light may be applied to the light-sensitive moiety, e.g., opening or closing the ion channel and increasing or decreasing ion transport therethrough, causing release of an entity, etc. In some cases, for example, applying light to a light-sensitive moiety may be used to alter the voltage or membrane potential in the cell. In some cases, the alteration in voltage or membrane potential can be determined by determining the voltage-indicating protein, e.g., using fluorescence as is discussed herein.

For example, in one set of embodiments, the light-sensitive moiety is a light-gated ion channel. Typically, a light-gated ion channel is a protein that contains a pore or “channel” which is able to open or close in response to light. The light-gated ion channel may be a transmembrane protein in some cases. Specific non-limiting examples of light-gated ion channels include channelrhodopsins (e.g., channelrhodopsin-1, channelrhodopsin-2, or volvox channelrhodopsin). The light-gated ion channel may increase or decrease ion transport therethrough.

As specific non-limiting examples, certain channelrhodopsins are excited using blue light, which increases ion transport therethrough when excitation light is applied. For example, the light applied to activate the channelrhodopsin (or other light-gated ion channel) may have a wavelength of between about 460 nm and about 480 nm, e.g., about 470 nm. In some cases, the light may be substantially coherent (e.g., laser light), and/or the light may have a wavelength distribution of no more than about +/−50 nm, no more than about +/−20 nm, no more than about +/−5 nm, or no more than about +/−5 nm around the average wavelength. In other embodiments, other excitation wavelengths may be used.

Another example of a light-sensitive moiety are light-powered pumps which are able to hyperpolarize a cell, for example, by pumping positive ions out or negative ions in, which suppresses electrical activity in the cell. Non-limiting examples include halorhodopsins, archaerhodopsins or photoreceptor proteins (e.g., rhodopsin, phytochrome, bacteriorhodopsin, or bacteriophytochrome). Light may accordingly be applied to hyperpolarize a cell. For example, for rhodopsins such as halorhodopsin or archaerhodopsin, yellow light may be applied. For instance, the light may have a wavelength of between about 560 nm and about 580 nm, e.g., about 570 nm.

As yet another example of a light-sensitive moiety, a caged moiety may be used to release or deliver a neurotransmitter, which may be cause a change in the voltage or membrane potential of the cell. As a specific non-limiting example, caged glutamate may be applied to a cell, where the glutamate may be “uncaged” by exposure to ultraviolet light. Examples of caged glutamate include single-caged glutamate (e.g., gamma-(alpha-carboxynitrobenzyl)-glutamic acid) or double-caged glutamate (e.g., alpha,gamma-bis-(alpha-carboxynitrobenzyl)-glutamic acid) which may be uncaged using ultraviolet light, e.g., having a wavelength of about 355 nm, or between about 350 nm and about 360 nm.

The voltage-indicating protein and the light-sensitive moiety may be delivered or introduced into the cell using any suitable technique. For example, the voltage-indicating protein and/or the light-sensitive moiety may be delivered to cells in vitro using techniques such as membrane fusion, or one or both may be introduced into the cells using transfection, e.g., with a vector comprising a nucleic acid encoding the voltage-indicating protein and/or the light-sensitive moiety. In some cases, one or both may also include a targeting sequence able to target the protein to a specific site, such as the plasma membrane or an intracellular organelle. As non-limiting examples, the targeting sequence may include a C-terminal signaling sequence from the alpha-2 nicotinic acetylcholine receptor (MRGTPLLLVVSLFSLLQD; SEQ ID NO: 1)), an endoplasmic reticulum export motif (e.g., FCYENEV; SEQ ID NO: 2), a Golgi export sequence (e.g., RSRFVKKDGHCNVQFINV; SEQ ID NO: 3) or a membrane localization sequence (e.g., KSRITSEGEYIPLDQIDINV; SEQ ID NO: 4).

The voltage or membrane potential of the cell may be determined, in accordance with one set of embodiments, by using light emitted by the voltage-indicating protein, e.g., upon it entering a voltage-sensitive state, as discussed herein. Accordingly, in some embodiments, one or more than one emission wavelength may be determined from the cell (or other sample). In some cases the emission wavelength is compared to a reference indicative of membrane potential. In some cases, the light that is determined may have a wavelength of between about 680 nm and about 700 nm, e.g., about 687 nm. The light also may be substantially monochromatic, and/or the light may have a wavelength distribution of no more than about +/−50 nm, no more than about +/−20 nm, no more than about +/−5 nm, or no more than about +/−5 nm around the average wavelength. As previously discussed, certain aspects of the invention are generally directed to voltage-indicating proteins, and systems and techniques for making and using such voltage-indicating proteins.

### V. Voltage-Indicating Proteins

Various aspects as discussed above are generally directed to, or include in some embodiments, voltage-indicating proteins (VIPs). Non-limiting examples of voltage-indicating proteins include those described herein, and those in Int. Pat. Apl. Ser. No. PCT/US11/48793, filed Aug. 23, 2011 (see the appendices herein); U.S. 61/376,049, filed Aug. 23, 2010; and U.S. Pat. No. 61/412,972, filed Nov. 12, 2010; each of which is incorporated herein by reference in its entirety, including any and all sequences contained therein, whether submitted on paper or electronically.

The voltage-indicating protein may, in some embodiments, be a microbial rhodopsin protein. In some cases, the microbial rhodopsin protein comprising a mutated proton acceptor proximal to a Schiff base. One non-limiting example of such a voltage-indicating protein is Archaerhodopsin 3 from Halorubrum sodomense. The protein may be the wild-type (“WT”) form of Archaerhodopsin 3, and or a modified form, for example, modified by substitution of at least one amino acid residue. For instance, the protein may be modified by the substitution of at least 1, 2, 3, 4, or 5 amino acid residues. In some cases, the protein may be modified by substitution of at least one and no more than three amino acid residues. Specific non-limiting examples include D95N (where the 95th amino acid residue is mutated from aspartic acid to asparagine), D85N (where the 85th amino acid residue is mutated from aspartic acid to asparagine) or other mutations as discussed herein or in Int. Pat. Apl. Ser. No. PCT/US11/48793, incorporated herein by reference.

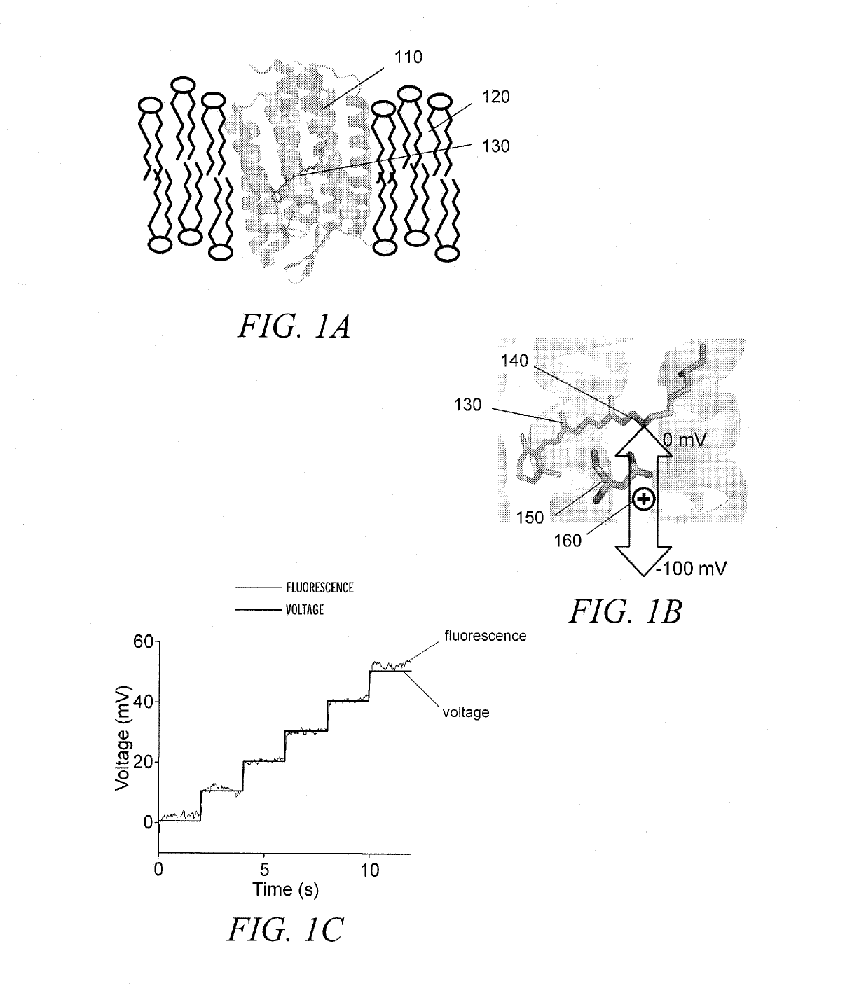

One non-limiting example of an engineered microbial rhodopsin is shown in FIG. 1A. Depicted is a D97N mutant of green proteorhodopsin 110 that spans a lipid bilayer membrane 120. The rhodopsin 110 includes a retinilydene chromophore 130 bound at the core of the protein. FIG. 1B depicts a close-up view of the chromophore 130. The chromophore is covalently linked to the protein backbone via a Schiff Base 140. For this rhodopsin, aspartic acid 97 in the wild-type structure has been mutated to asparagine 150 to decrease the pKa of the Schiff Base 140 from the wild-type value of >12 to a value of about 9.8. This mutation eliminates the proton-pumping photocycle.

When the rhodopsin is incorporated in a membrane, as in FIG. 1A, and a potential is applied across the membrane 120, a change in the local electrochemical potential is induced. Such a change can affect the acid-base equilibrium in the vicinity of the rhodopsin and the protonation of the Schiff Base 140. For example, application of a potential across the membrane 120 can move a proton 160 near or away from Schiff Base 140. The absorption spectrum and fluorescence of the retinal 130 depend on the state of protonation of the Schiff Base 140. In certain embodiments, the protonated form is fluorescent and the deprotonated form is not fluorescent. In some embodiments, the amount of fluorescence depends upon an amount of applied voltage, as can be seen in FIG. 1C. Accordingly in some implementations, the local voltage or electrochemical potential within a sample may be determined by measuring an amount of fluorescence from the rhodopsins.

As discussed herein, the level of fluorescence emitted by the voltage-indicating protein may be indicative of the voltage experienced by the protein. In certain cases, the level of fluorescence may be compared to a reference that is indicative of the membrane potential or voltage of the cell. For instance, with respect to microbial rhodopsin proteins such as Archaerhodopsin 3 from Halorubrum sodomense, or modifications thereof, the cell may be illuminated by light having a wavelength of between about 594 nm and about 645 nm, between about 625 nm and about 650 nm, between about 525 nm and about 570 nm, or any other suitable light having an intensity and/or frequency able to cause the voltage-indicating protein to enter a voltage-sensitive state. Specific non-limiting examples of potentially useful frequencies include about 640 nm, about 633 nm, about 558 nm, about 585 nm, or about 532 nm. In some cases, the light may be substantially coherent (e.g., laser light), and/or the light may have a wavelength distribution of no more than about +/−50 nm, no more than about +/−20 nm, no more than about +/−5 nm, or no more than about +/−5 nm around the average wavelength.

Microbial rhodopsins are a large class of proteins typically characterized by seven transmembrane domains and a retinilydene chromophore bound in the protein core to a lysine via a Schiff base. Over 5,000 microbial rhodopsins are known, and these proteins are found in all kingdoms of life. Microbial rhodopsins serve a variety of functions for their hosts: some are light-driven proton pumps (bacteriorhodopsin, proteorhodopsins), others are light-driven ion channels (channelrhodopsins), chloride pumps (halorhodopsins), or serve in a purely photosensory capacity (sensory rhodopsins). The retinilydene chromophore imbues microbial rhodopsins with unusual optical properties. The linear and nonlinear responses of the retinal may be highly sensitive to interactions with the protein host: small changes in the electrostatic environment can lead to large changes in absorption spectrum. These electro-optical couplings provide the basis for voltage sensitivity in microbial rhodopsins.

Some of the voltage-indicating proteins described herein are natural proteins without modifications and are used in cells that do not normally express the microbial rhodopsin transfected to the cell, such as eukaryotic cells. For example, wild type Arch3 can be used in neural cells to specifically detect membrane potential and changes thereto.

Some of the voltage-indicating protein used herein are derived from a microbial rhodopsin protein by modification of the protein to reduce or inhibit light-induced ion pumping of the rhodopsin protein. Such modifications allow the modified microbial rhodopsin proteins to sense voltage without altering the membrane potential of the cell with its native ion pumping activity and thus altering the voltage of the system. Other mutations impart other advantageous properties to microbial rhodopsin voltage sensors, including increased fluorescence brightness, improved photostability, tuning of the sensitivity and dynamic range of the voltage response, increased response speed, and/or tuning of the absorption and emission spectra, etc.

Mutations that eliminate pumping in microbial rhodopsins include mutations to the Schiff base counterion; a carboxylic amino acid (Asp or Glu) conserved on the third transmembrane helix (helix C) of the rhodopsin proteins. The amino acid sequence is RYX(DE) where X is a non-conserved amino acid. Mutations to the carboxylic residue may affect the proton conduction pathway, eliminating proton pumping. Most typically the mutation is to Asn or Gln, although other mutations are possible. Thus, some embodiments of the present invention are generally directed to mutants which also result in reduced or absent ion pumping by the microbial rhodopsin protein. In one embodiment, the modified microbial rhodopsin proteins comprise the Asp to Asn or Gln mutations, or Glu to Asn or Gln mutation. In some embodiments, the protein consists essentially of an Asp to Asn or Gln mutation, or Glu to Asn or Gln mutation. In some embodiments, the protein consists of Asp to Asn or Gln mutations, or Glu to Asn or Gln mutations.

Table 1a includes exemplary microbial rhodopsins useful in certain embodiments of the present invention. For example, mutations that eliminate pumping in microbial rhodopsins generally comprise mutations to the Schiff base counterion; a carboxylic amino acid (Asp or Giu) conserved on the third transmembrane helix (helix C) of the rhodopsin proteins. Table 1a refers to the amino acid position in the sequence provided as the exemplary Genbank or SEQ ID number. However, the position may be numbered slightly differently based on the variations in the available amino acid sequences. Based on the description of the motif described herein, other embodiments of the invention are directed to similar mutations into other microbial rhodopsin genes to achieve the same functional feature, i.e. reduction in the pumping activity of the microbial rhodopsin in question.

TABLE 1a
Exemplary microbial rhodopsins useful according to the present invention.

| Microbial | | | |
|---|---|---|---|
| Rhodopsi | Abbreviation | Genbank number | Amino acid mutation |
| Green-absorbing | GPR | AF349983; wild-type, | D99N (SEQ ID NO: 7) in the |
| proteorhodopsin: a | | (Nucleotide and protein | specification, this mutation is |
| light-driven proton | | disclosed as SEQ ID | also referred to as D97N |
| pump .found in | | NOS 5-6, respectively) | |
| marine bacteria | | | |
| Blue-absorbing | BPR | AF349981; wild-type; | D99N (SEQ ID NO: 10) |
| proteorhodopsin: a | | (Nucleotide and protein | |
| light-driven proton | | disclosed as SEQ ID | |
| pump found in | | NOS 8-9, respectively) | |
| marine bacteria. | | | |
| Natronomonas | NpSRII | Z35086.1; In one | D75N (SEQ ID NO: 13) |
| pharaonis sensory | | embodiment only the | |
| rhodopsin II: a light- | | sensory domain, | |
| activated signaling | | given by nucleotides | |
| protein found in the | | 2112-2831 of | |
| halophilic bacterium | | sequence Z35086, is | |
| N. pharaonis. In the | | used (Nucleotide and | |
| wild the sensory | | “sensory domain” | |
| domain is paired with | | protein disclosed as | |
| a transducer domain | | SEQ ID NOS 11-12, | |
| | | respectively) | |
| Bacteriorhodopsin: a | BR | NC_010364.1, | D98N |
| light-driven proton | | nucleotides 1082241 | (SEQ ID NO: 16) |
| pump found in | | to 1083029, or | |
| Halobacterium | | GenBank sequence | |
| salinarum | | M11720.1; | |
| | | (“M11720.1” | |
| | | nucleotide and | |
| | | protein disclosed as | |
| | | SEQ ID NOS 14-15, | |
| | | respectively) | |
| Archaerhodopsi.n | Arch 3 (or Ar | Chow B. Y. et al., | D95N (SEQ ID NO: 18) |
| Arch 3: a light-driven | 3) | Nature 463: 98-102; | |
| proton pump found | | (“Arch 3” wild-type | |
| in Halobacterium | | protein disclosed as | |
| sodomense | | SEQ ID NO: 17) | |

The following Table 1b includes exemplary additional rhodopsins that can be mutated and used in some embodiments of the invention:

TABLE 1b

| | | Genbank | Nucleic acid | Amino |
|---|---|---|---|---|
| Microbial Rhodopsin | Abbreviation | number | mutation | Acid |
| Fungal Opsin Related | Mac | AAG01180 | G415 to A | D139N (SEQ ID |
| Protein | | (SEQ ID NO: | | NO: 20) |
| | | 19) | | |
| Cruxrhodopsin | Crux | BAA06678 | G247 to A | D83N (SEQ ID |
| | | (SEQ ID NO: | | NO: 22) |
| | | 21) | | |
| Algal | Ace | AAY82897 (SEQ | G265 to A | D89N (SEQ ID |
| Bacteriorhodopsin | | ID NO: 23) | | NO: 24) |
| Archaerhodopsin 1 | Ar1 | P69051 (SEQ ID | G289 to A | D97N (SEQ |
| | | NO: 25) | | ID NO: 26) |
| Archaerhodopsin 2 | Ar2 | P29563 (SEQ ID | G286 to A | D96N (SEQ ID |
| | | NO: 27) | | NO: 28) |
| Archaerhodopsin 3 | Ar3 | P96787 (SEQ ID | G283 to A | D95N (SEQ ID |
| | | NO: 29) | | NO: 30) |
| Archaerhodopsin 4 | Ar4 | AAG42454 (SEQ | G292 to A | D98N (SEQ ID |
| | | ID NO: 31 | | NO: 32) |

As discussed, certain embodiments of the invention are generally directed to voltage indicating proteins (“VIP”). In one set of embodiments, the voltage indicating proteins include any protein of a family of fluorescent voltage-indicating proteins (VIPs) based on Achaerhodopsins. The proteins may be able to function in mammalian cells, including neurons and human stem cell-derived cardiomyocytes, in some embodiments. These proteins can indicate electrical dynamics with sub-millisecond temporal resolution and sub-micron spatial resolution. In certain embodiments of the invention, the voltage indicating proteins exhibit non-contact, high-throughput, and/or high-content studies of electrical dynamics in mammalian cells and tissues, e.g., by using optical measurement of membrane potential such as is discussed herein. These VIPs are broadly useful in various applications, for example, in eukaryotic cells, such as mammalian cells, including human cells.

In some embodiments, the VIPs may be based on Archaerhodopsin 3 (Arch 3) and/or its homologues. Arch 3 is Archaerhodopsin from H. sodomense and it is known as a genetically-encoded reagent for high-performance yellow/green-light neural silencing. Gene sequence at GenBank: GU045593.1 (synthetic construct Arch 3 gene, complete cds. Submitted Sep. 28, 2009). In some cases, these proteins localize to the plasma membrane in eukaryotic cells and show voltage-dependent fluorescence.

In certain embodiments, the VIPs may exhibit further improved membrane localization, with comparable voltage sensitivity, in ArchT, gene sequence at GenBank: HM367071.1 (synthetic construct ArchT gene, complete cds. Submitted May 27, 2010). ArchT is Archaerhodopsin from Halorubrum sp. TP009: genetically-encoded reagent for high-performance yellow/green-light neural silencing, 3.5× more light sensitive than Arch 3.

Other examples of voltage-indicating proteins include the Proteorhodopsin Optical Proton Sensor (PROPS), Arch 3 WT, and Arch 3 D95N. For instance, in certain embodiments, PROPS may be used in bacteria, while Arch 3 WT and Arch 3 D95N may be used in mammalian cells.

Table 2 shows exemplary approximate characteristics of fluorescent voltage indicating proteins and contains representative members of all families of fluorescent indicators.

TABLE 2
Representative members of all families of fluorescent indicators.

| | Approx ΔF/F | Approx | | |
|---|---|---|---|---|
| Molecule | per 100 mV | response time | | Comments |
| VSFP 2.3, Knopfel, T. | 9.5% | 78 | ms | Ratiometric |
| et al. J. Neurosci, 30, | | | | (ΔR/R) |
| 14998-15004 (2010) | | | | |
| VSFP 2.4 Knopfel, T. | 8.9% | 72 | ms | Ratiometric |
| et al. J. Neurosci, 30, | | | | (ΔR/R) |
| 14998-15004 (2010) | | | | |
| VSFP 3.1, Lundby, A., | 3% | 1-20 | ms | Protein |
| et al., PLoS One 3, | | | | |
| 2514 (2008) | | | | |
| Mermaid, Perron, A. et | 9.2% | 76 | | Ratiometric |
| al. Front Mol Neurosci. | | | | (ΔR/R) |
| 2, 1-8 (2009) | | | | |
| SPARC, Ataka, K. & | 0.5% | 0.8 | ms | Protein |
| Pieribone, V. A. | | | | |
| Biophys. J. 82, 509-516 | | | | |
| (2002) | | | | |
| Flash, Siegel, M. S. & | 5.1% | 2.8-85 | ms | Protein |
| Isacoff, E. Y. Neuron | | | | |
| 19, 735-741 (1997) | | | | |
| PROPS, described | 150% | 5 | ms | Protein |
| herein; SEQ ID NO: | | | | |
| Arch 3 WT, described | 66% | <0.5 | ms | Protein |
| herein | | | | |
| Arch D95N | 100% | 41 | ms | Protein |

In one embodiment, green-absorbing proteorhodopsin (GPR) is used as the starting molecule. This molecule is selected for its relatively red-shifted absorption spectrum and its ease of expression in heterologous hosts such as E. coli. In another embodiment, the blue-absorbing proteorhodopsin (BPR) is used as an optical sensor of voltage. It is contemplated herein that a significant number of the microbial rhodopsins found in the wild can be engineered as described herein to serve as optical voltage sensors.

Microbial rhodopsins are sensitive to quantities other than voltage. Mutants of GPR and BPR, as described herein, are also sensitive to intracellular pH. It is also contemplated that mutants of halorhodopsin may be sensitive to local chloride concentration.

In one embodiment, the voltage sensor is selected from a microbial rhodopsin protein (wild-type or mutant) that provides a voltage-induced shift in its absorption or fluorescence. The starting sequences from which these constructs can be engineered include, but are not limited to, sequences listed in Tables 1a-1b, that list the rhodopsin and an exemplary mutation that can be made to the gene to enhance the performance of the protein product.

Some embodiments of the invention are generally directed to mutations to minimize the light-induced charge-pumping capacity. For instance, in some embodiments, the retinal chromophore may be linked to a lysine by a Schiff base. A conserved aspartic acid serves as the proton acceptor adjacent to the Schiff base. Mutating this aspartic acid to asparagine suppresses proton pumping. Thus, in some embodiments, the mutations are selected from the group consisting of: D97N (green-absorbing proteorhodopsin), D99N (blue-absorbing proteorhodopsin), D75N (sensory rhodopsin II), and D85N (bacteriorhodopsin). In other embodiments, residues that can be mutated to inhibit pumping include (using bacteriorhodopsin numbering) D96, Y199, and R82, and their homologues in other microbial rhodopsins. In another embodiment, residue D95 can be mutated in archaerhodopsin to inhibit proton pumping (e.g., D95N).

Certain embodiments of the invention are generally directed to mutations that are introduced to shift the absorption and emission spectra into a desirable range. Residues near the binding pocket can be mutated singly or in combination to tune the spectra to a desired absorption and emission wavelength. In bacteriorhodopsin these residues include, but are not limited to, L92, W86, W182, D212, I119, and M145. Homologous residues may be mutated in other microbial rhodopsins. Thus, in some embodiments, the mutation to modify the microbial rhodopsin protein is performed at a residue selected from the group consisting of L92, W86, W182, D212, I119, or M145.

Certain embodiments of the invention are generally directed to mutations that are introduced to shift the dynamic range of voltage sensitivity into a desired band. Such mutations function by shifting the distribution of charge in the vicinity of the Schiff base, and thereby changing the voltage needed to add or remove a proton from this group. Voltage-shifting mutations in green-absorbing proteorhodopsin include, but are not limited to, E108Q, E142Q, L217D, either singly or in combination using green-absorbing proteorhodopsin locations as an example, or a homologous residue in another rhodopsin. In one embodiment, a D95N mutation is introduced into archaerhodopsin 3 to adjust the pKa of the Schiff base towards a neutral pH.

Certain embodiments of the invention are generally directed to mutations that are introduced to enhance the brightness and photostability of the fluorescence. Residues which when mutated may restrict the binding pocket to increase fluorescence include (using bacteriorhodopsin numbering), but are not limited to, Y199, Y57, P49, V213, and V48.

For example, one set of embodiments is generally directed to PROPS, which is an optogenetic voltage sensor derived from GPR. GPR has seven spectroscopically distinguishable states that it passes through in its photocycle. In principle the transition between any pair of states is sensitive to membrane potential. In one embodiment, the acid-base equilibrium of the Schiff base was chosen as the wavelength-shifting transition, hence the name of the sensor: Proteorhodopsin Optical Proton Sensor (PROPS).

A brief discussion of PROPS follows. In one embodiment, a single point mutation induces changes in GPR, where the pKa of the Schiff base can be shifted from its wild-type value of −12 to a value close to the ambient pH. When pKa ˜pH, the state of protonation becomes maximally sensitive to the membrane potential. In addition, the endogenous charge-pumping capability can be eliminated, because optimally, a voltage probe should not perturb the quantity under study. Mutating Asp97 to Asn eliminates a negative charge near the Schiff base, and destabilizes the proton on the Schiff base. The pKa shifts from ˜12 to 9.8. In wild-type GPR, Asp97 also serves as the proton acceptor in the first step of the photocycle, so removing this amino acid eliminates proton pumping.

In another embodiment, in an analogous voltage sensor derived from BPR, the homologous mutation Asp99 to Asn lowers the pKa of the Schiff base and eliminates the proton-pumping photocycle. Thus, in one embodiment, the VIP is derived from BPR in which the amino acid residue Asp99 is mutated to Asn.

In GPR, additional mutations shift the pKa closer to the physiological value of 7.4. In particular, mutations Glu108 to Gln and Glu142 to Gln individually or in combination lead to decreases in the pKa and to further increases in the sensitivity to voltage. Many mutations other than those discussed herein may lead to additional changes in the pKa and improvements in the optical properties of PROPS and are contemplated herein.

In some cases, fluorescence may be used to detect a VIP. For example, many microbial rhodopsin proteins and their mutants (including those described herein) produce measurable fluorescence. For example, PROPS fluorescence is excited by light with a wavelength between wavelength of 500 and 650 nm, and emission is peaked at 710 nm. The rate of photobleaching of PROPS decreases at longer excitation wavelengths, so one example of an excitation wavelength is in the red portion of the spectrum, near 633 nm. These wavelengths are further to the red than the excitation and emission wavelengths of any other fluorescent protein, a highly desirable property for in vivo imaging. Furthermore, the fluorescence of PROPS shows negligible photobleaching. When excited at 633 nm, PROPS and GFP emit a comparable numbers of photons prior to photobleaching. Thus microbial rhodopsins may be used as photostable, membrane-bound fluorescent markers.

In some cases, the fluorescence of PROPS may be sensitive to the state of protonation of the Schiff base in that only the protonated form fluoresces. Thus voltage-induced changes in protonation lead to changes in fluorescence in certain embodiments. In some embodiments, the fluorescence of PROPS is detected using e.g., a fluorescent microscope, a fluorescent plate reader, FACS sorting of fluorescent cells, etc.

The fluorescence emitted by the voltage-indicating protein may also be compared, in certain embodiments, to a reference value. The invention provides, in another set of embodiments, systems and methods for measuring membrane potential in a cell expressing a nucleic acid encoding a microbial rhodopsin protein. In some embodiments, the method comprises the steps of exciting at least one cell comprising a nucleic acid encoding a microbial rhodopsin protein with light of at least one wave length, and detecting at least one optical signal from the at least one cell. In some cases, the level of fluorescence emitted by the at least one cell compared to a reference is indicative of the membrane potential of the cell.

The term “reference” as used herein refers to a baseline value of any kind that one skilled in the art can use as discussed herein. In some embodiments, the reference is a cell that has not been exposed to a stimulus capable of or suspected to be capable of changing membrane potential. In one embodiment, the reference is the same cell transfected with the microbial rhodopsin but observed at a different time point. In another embodiment, the reference is the fluorescence of a homologue of Green Fluorescent Protein (GFP) operably fused to the microbial rhodopsin.

In certain embodiments, the present invention is generally directed to detecting fluorescence from a modified microbial rhodopsin. In some embodiments of the invention, the cells are excited with a light source so that the emitted fluorescence can be detected. The wavelength of the excitation light may depend on the fluorescent molecule. For example, archerhodopsin may be excited using light with wavelengths varying between about 594 nm and about 645 nm. In some cases, the range may be between about 630 nm and about 645 nm. For example, a commonly used helium-neon laser emits at 632.8 nm and can be used in excitation of the fluorescent emission.

In some embodiments, a second light may be used. For example, a cell (or other sample) may contain a reference fluorescent molecule or a fluorescent molecule that is used to detect another feature of the cell, such as pH or calcium concentration. In some cases, the second wavelength differs from the first wavelength. Examples of useful wavelengths include wavelengths in the range of about 447 nm to about 594 nm, for example, 473 nm, 488 nm, 514 nm, 532 nm, or 561 nm.

In some embodiments, imaging in deep tissue or thicker samples may require techniques such as confocal microscopy or lateral sheet illumination microscopy. In some cases, deep imaging may require nonlinear microscopies, including two-photon fluorescence or second harmonic generation. Conventional epifluorescence imaging may be used in some cases, e.g., for cells in culture. In one set of embodiments, total internal reflection fluorescence (TIRF) may be used.

In some embodiments sub-millisecond temporal resolution may be achieved with high-speed CCDs, or high-speed confocal microscopes which can scan custom trajectories. Slower dynamics and quasi steady state voltages can be measured with conventional cameras. These measurements can be used, for example, in methods and assays that are directed to screening of agents in cardiac cells, such as cardiomyocytes. Other examples of determination of VIPs are discussed herein.

In some cases, spectral shift fluorescence resonance energy transfer (FRET) may be used to detect a VIP. FRET is a useful tool to quantify molecular dynamics in biophysics and biochemistry, such as protein-protein interactions, protein-DNA interactions, and protein conformational changes. For monitoring the complex formation between two molecules (e.g., retinal and microbial rhodopsin), one of them is labeled with a donor and the other with an acceptor, and these fluorophore-labeled molecules are mixed. When they are dissociated, the donor emission is detected upon the donor excitation. On the other hand, when the donor and acceptor are in proximity (1-10 nm) due to the interaction of the two molecules, the acceptor emission is predominantly observed because of the intermolecular FRET from the donor to the acceptor.

In some embodiments, a fluorescent molecule fused to a microbial rhodopsin can transfer its excitation energy to the retinal, e.g., if the absorption spectrum of the retinal overlaps with the emission spectrum of the fluorophore. Changes in the absorption spectrum of the retinal may in some cases lead to changes in the fluorescence brightness of the fluorophore. To perform spectral shift FRET, a fluorescent protein may be fused with the microbial rhodopsin voltage sensor, and the fluorescence of the protein is monitored. Thus, in some embodiments, voltage-induced changes in the absorption spectrum of microbial rhodopsins are detected using spectral shift FRET.

A voltage-indicating protein may also be determined, for example, using a spectral shift FRET (ssFRET) for enhanced brightness and/or 2-photon imaging, ratiometric voltage imaging, and multimodal sensors for simultaneous measurement of voltage and/or concentration. In some embodiments, a system of the present invention may comprise an intense red laser, a high numerical aperture objective, and an electron-multiplying CCD (EMCCD) camera. In other embodiments, however, the VIP is bright enough to image on a conventional wide-field or confocal fluorescence microscope, or a 2-photon confocal microscope for in vivo applications.

Certain VIPs as discussed herein show relatively high sensitivity. For example, in mammalian cells, some VIPs as discussed herein show about a 3-fold increase in fluorescence between −150 mV and +150 mV, and the response is linear over most of this range. The VIPs may be measured via membrane voltage with a precision of <1 mV in a 1 s interval.

In some embodiments, the VIPs discussed herein show high speed or response, e.g., to a change in voltage or membrane potential. For example, Arch 3 WT shows 90% of its step response in <0.5 ms. A neuronal action potential lasts 1 ms, so this speed meets the benchmark for imaging electrical activity of neurons. In some cases, Arch 3 WT retains the photoinduced proton-pumping, so illumination may slightly hyperpolarize the cell.

As another example, the modified microbial rhodopsin, Arch 3 D95N, has a 40 ms response time and lacks photoinduced proton pumping. Arch 3 D95N may be used, for example, to indicate membrane potential and action potentials in other types of cells, for example, in cardiomyocytes and does not perturb membrane potential in the cells wherein it is used.

In some embodiments, rhodopsin optical lock-in imaging (ROLI) may be used to detect a VIP. The absorption spectrum of many of the states of retinal is temporarily changed by a brief pulse of light. In ROLI, periodic pulses of a “pump” beam are delivered to the sample. A second “probe” beam measures the absorbance of the sample at a wavelength at which the pump beam induces a large change in absorbance. Thus the pump beam imprints a periodic modulation on the transmitted intensity of the probe beam. These periodic intensity changes are detected by a lock-in imaging system. In contrast to conventional absorption imaging, ROLI provides retinal-specific contrast. Modulation of the pump at a high frequency allows detection of very small changes in absorbance.

In certain embodiments, Raman spectroscopy may be used to detect a VIP (which may be a VIP construct). Raman spectroscopy is a technique that can detect vibrational, rotational, and other low-frequency modes in a system. The technique relies on inelastic scattering of monochromatic light (e.g., a visible laser, a near infrared laser or a near ultraviolet laser). The monochromatic light interacts with molecular vibrations, phonons or other excitations in the system, resulting in an energy shift of the laser photons. The shift in energy provides information about the phonon modes in the system. Retinal in microbial rhodopsin molecules is known to have a strong resonant Raman signal. This signal is dependent on the electrostatic environment around the chromophore, and therefore is sensitive to voltage.

In some embodiments, second harmonic generation (SHG) may be used to detect a VIP (which may be a VIP construct). Second harmonic generation, also known in the art as “frequency doubling” is a nonlinear optical process, in which photons interacting with a nonlinear material are effectively “combined” to form new photons with twice the energy, and therefore twice the frequency and half the wavelength of the initial photons. For example, SHG signals have been observed from oriented films of bacteriorhodopsin in cell membranes. SHG is an effective probe of the electrostatic environment around the retinal in optical voltage sensors. Furthermore, SHG imaging involves excitation with infrared light. Thus SHG imaging can be used for three-dimensional optical voltage sensing as described herein.

In some embodiments, rhodopsin state control may be used in fluorescence imaging with VIPs. Optical excitation of a VIP may induce a conformational transition in the protein. In some cases, only one state in the photocycle of the VIP may exhibit voltage-sensitive state. The voltage-sensitive state may be a dark-adapted state, or it may be a photogenerated intermediate. In either case, in some embodiments, one wants to maximize the fraction of the time that the protein is in the voltage-sensitive state.

“Rhodopsin state control” can be achieved by judicious control of the timing and choice incident light used to excite the proteins. To detect fluorescence from the voltage-sensitive state, the VIP may be optically excited with incident radiation of a selected first wavelength or selected first band of wavelengths, e.g., the wavelengths as discussed herein. However in some embodiments, the selected excitation may drive the protein into other, voltage-insensitive states.

In some embodiments, a “ground state” of the protein may not be photosensitive. To counter these properties, light of a selected second wavelength or selected second band of wavelengths may be used to drive or “pump” the VIP into, or back into, a voltage-sensitive state. Thus by illuminating the sample with two or more wavelengths or wavelength bands (e.g., in a pump-probe manner), the fraction of the time that the protein is in the voltage-sensitive state is enhanced, thereby enhancing fluorescence signal levels from voltage-dependent states.

Thus, in some cases, a secondary beam used for repopulating a voltage-sensitive state may generate undesirable background fluorescence. Unwanted background fluorescence may be mitigated by rapidly alternating sample illumination between the excitation and pumping radiations. Additionally, time-gated detection may be employed to detect only those photons emitted during excitation illumination. In some implementations, background fluorescence may not be significant and the pumping and excitation radiations may be applied simultaneously.

Certain embodiments of the present invention are generally directed to a fusion protein with a moiety that produces an optical signal. Although microbial rhodopsin proteins or other VIPs as discussed herein are themselves fluorescent in response to changes in voltage, in some applications it may desired or necessary to enhance the level of fluorescence or provide another optical signal (e.g., a colorimetric signal) to permit detection of voltage changes. Further, a moiety that produces an optical signal can be attached to the VIP to monitor the subcellular localization of the VIP. Thus, in some embodiments, the VIP further comprises a moiety that produces an optical signal, thereby enhancing the optical signal measured from the VIP or permitting localization studies to be performed for the VIP.

For example, a gene for a fluorescent protein of the GFP family or a homolog thereof, or other suitable fluorophore can optionally be appended or as referred to in the claims “operably linked” to the nucleic acid encoding the VIP. Non-limiting of examples of other suitable fluorophores include, YFP, eGFP, eYFP, BFP, eBFB, DsRed, RFP and fluorescent variants thereof. In one embodiment, the identity of the fluorescent protein, its linker to the voltage-sensing complex, and the location of this linker in the overall protein sequence are selected to serve as an indicator of the level and distribution of gene expression products, and/or to serve as an alternative readout of voltage, independent of the endogenous fluorescence of the VIP.

For example, when the fluorescent protein serves as an indicator of protein localization, it may allow quantitative optical voltage measurements that are not confounded by cell-to-cell variation in expression levels. For instance, the fluorescence of the fluorescent protein and the VIP can be measured simultaneously and the ratio of these two signals provides a concentration-independent measure of membrane potential.

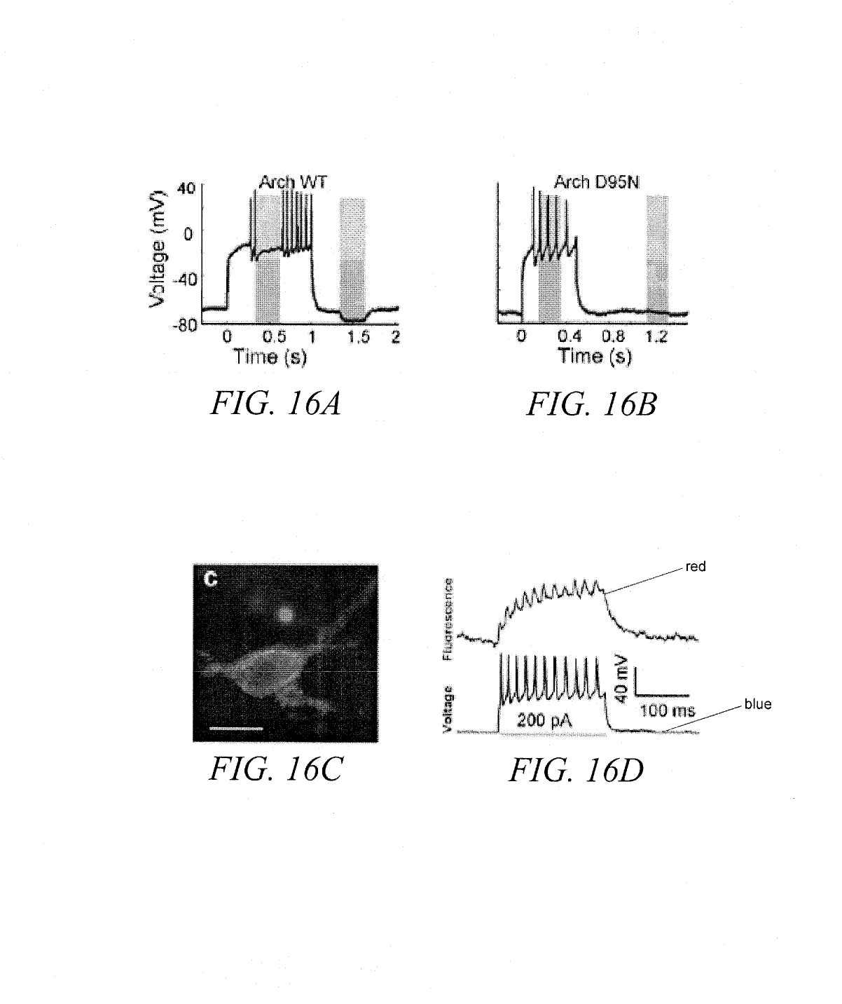

Thus, certain embodiments of the present invention are generally directed to the generation of fusions between microbial rhodopsins or other VIPs, and GFP homologues or other fluorophores with additional or improved properties. In one set of embodiments, for example, VIPs may be fused with GFP-homologue proteins as voltage indicators. FIG. 16 of the appendices illustrates examples of these constructs and the corresponding legend provides the sequences for these constructs. Accordingly, it should be understood that a voltage-indicating protein as discussed herein includes, in some embodiments, a modified VIP (e.g., a VIP fused with a GFP homologues or other fluorophores with additional or improved properties), although in other embodiments, a VIP may not necessarily be modified.

In some embodiments, a GFP-homologue (generically referred to as GFP) is fused to the microbial rhodopsin or other VIP). Voltage-dependent changes in the absorption spectrum of the retinal may lead to voltage-dependent rates of nonradiative fluorescence resonance energy transfer (FRET) between the GFP and the retinal. Retinal in its absorbing, fluorescent state may be able to quench the GFP, while retinal in the non-absorbing, nonfluorescent state does not quench the GFP.

Thus in one embodiment, the invention provides a fusion protein comprising a GFP that is fused to a microbial rhodopsin or a modified microbial rhodopsin, such as a proteorhdopsin or archaerhodopsin. Such fusion proteins can be used in any and all of the methods described in various embodiments the present invention.

For example, one set of embodiments is generally directed to a PROPS fusion protein comprising a fluorescent protein, for example, an N-terminal fusion of PROPS with the fluorescent protein Venus. This protein may be used to provide a stable reference indicating localization of PROPS within the cell, or permitting ratiometric imaging of Venus and PROPS fluorescence. Ratiometric imaging permits quantitative measurements of membrane potential because this technique is insensitive to the total quantity of protein within the cell. Other fluorescent proteins may be used in lieu of Venus with similar effects. In some embodiments, the fluorescent polypeptide is selected from the group consisting of GFP, YFP, EGFP, EYFP, EBFB, DsRed, RFP and fluorescent variants thereof.

In one set of embodiments, a chromophore may be used. Wild-type microbial rhodopsins contain a bound molecule of retinal which serves as the optically active element. These proteins will also bind and fold around many other chromophores with similar structure, and possibly preferable optical properties. Analogues of retinal with locked rings cannot undergo trans-cis isomerization, and therefore have higher fluorescence quantum yields. Analogues of retinal with electron-withdrawing substituents have a Schiff base with a lower pKa than natural retinal and therefore may be more sensitive to voltage.

Certain embodiments of the invention are generally directed to multiplexing with other optical imaging and control. For example, in some cases, imaging of VIPs may be combined with other structural and functional imaging, of e.g. pH, calcium, or ATP. Imaging of VIPs may also be with optogenetic control of membrane potential using e.g. channelrhodopsin, halorhodopsin, and archaerhodopsin. In addition, certain embodiments of the invention are generally directed to spectroscopic readouts of voltage-induced shifts in microbial rhodopsins.

In certain embodiments, VIPs may be targeted to intracellular organelles. Examples of intracellular organelles that can be targeted by VIPs include mitochondria, the endoplasmic reticulum, the sarcoplasmic reticulum, synaptic vesicles, and phagosomes. Accordingly, in one embodiment, the invention provides constructs, such as expression constructs, e.g., viral constructs comprising a VIP operably linked to a sequence targeting the protein to an intracellular organelle, including a mitochondrium, an endoplasmic reticulum, a sarcoplasmic reticulum, a synaptic vesicle, or a phagosome. The invention provides, in some embodiments, cells expressing the constructs, and/or methods of measuring membrane potential changes in the cells expressing such constructs as well as methods of screening for agents that affect the membrane potential of one or more of the intracellular membranes.

Thus, in certain embodiments, the VIPs discussed herein show high targetability. For example, in some embodiments, certain VIPs as discussed herein may be used to image primary neuronal cultures, cardiomyocytes (HL-1 and human iPSC-derived), IIEK cells, Gram positive and Gram negative bacteria, or the like. For example, a VIP as discussed herein may be targeted to the endoplasmic reticulum, or to mitochondria. The VIPs may also be useful for in vivo imaging in C. elegans, zebrafish, mice, etc.

Certain embodiments of the invention are generally directed to applications for VIPs in screens for drugs that target the following tissues or processes. For example, the VIPs disclosed herein can be used in methods for drug screening, e.g., for drugs targeting the nervous system. In a culture of cells expressing specific ion channels, one can screen for agonists or antagonists without the labor of applying patch clamp to cells one at a time. In neuronal cultures, one can probe the effects of drugs on action potential initiation, propagation, and synaptic transmission. Application in human iPSC-derived neurons may be used in studies on genetically determined neurological diseases, as well as studies on the response to environmental stresses (e.g. anoxia).

Similarly, the optical voltage sensing using the VIPs provided herein provide methods to screen for drugs that modulate the cardiac action potential and its intercellular propagation, in other embodiments of the invention. These screens may be useful for determining safety of candidate drugs, or to identify new cardiac drug leads. Identifying drugs that interact with the hERG channel is a particularly promising direction because inhibition of hERG is associated with ventricular fibrillation in patients with long QT syndrome. Application in human iPSC-derived cardiomyocytes may allow studies on genetically determined cardiac conditions, as well as studies on the response to environmental stresses (e.g. anoxia).

Additionally, the VIPs of the present invention can be used in some embodiments in methods to study of development and wound healing. The role of electrical signaling in normal and abnormal development, as well as tissue repair, is poorly understood. VIPs as discussed herein can be used in studies of voltage dynamics over long times in developing or healing tissues, organs, and organisms, and lead to drugs that modulate these dynamics.

In yet another embodiment, the invention provides systems and methods to screen for drugs that affect membrane potential of mitochondria. Mitochondria play an essential role in ageing, cancer, and neurodegenerative diseases. VIPs such as those described herein may be used as a probe for determining mitochondrial membrane potential, which may be used in searches for drugs that modulate mitochondrial activity.

The invention further provides, in another set of embodiments, systems and methods to screen for drugs that modulate the electrophysiology of a wide range of medically, industrially, and environmentally significant microorganisms.

In yet another set of embodiments, VIPs such as those described herein may be used to measure membrane potential in a prokaryote, e.g., a bacteria. In some cases, bacteria have complex electrical dynamics. VIPs such as those described herein may be used to screen for drugs that modulate the electrophysiology of a wide range of medically, industrially, and environmentally significant microorganisms. For instance, electrical activity may be correlated with efflux pumping in E. coli.

Changes in membrane potential are also associated with activation of macrophages. However, this process is poorly understood due to the difficulty in applying patch clamp to motile cells. In one set of embodiments, VIPs such as described herein may be used in the study of the electrophysiology of macrophages and other motile cells, including sperm cells for fertility studies. Thus the VIPs or herein can be used in systems or methods to screen for drugs or agents that affect, for example, immunity and immune diseases, as well as fertility.

For example, in one embodiment, the invention provides a method wherein a cell expressing a microbial rhodopsin is further exposed to a stimulus capable of or suspected to be capable of changing membrane potential.

Stimuli that can be used include candidate agents, such as drug candidates, small organic and inorganic molecules, larger organic molecules and libraries of molecules and any combinations thereof. One can also use a combination of a known drug, such as an antibiotic with a candidate agent to screen for agents that may increase the effectiveness of the one or more of the existing drugs, such as antibiotics.

The systems and methods of the invention may also be useful, in some embodiments, for in vitro toxicity screening and drug development. For example, using the systems and methods described herein a human cardiomyocyte from induced pluripotent cells can be prepared that stably express a modified archaerhodopsin wherein the proton pumping activity is substantially reduced or abolished. Such cells may be particularly useful for in vitro toxicity screening in drug development.

In some embodiments, robotics and custom software may be used for screening large libraries or large numbers of conditions which are typically encountered in high throughput drug screening methods.

In some embodiments, robotics and custom software may be used for screening large libraries or large numbers of conditions which are typically encountered in high throughput drug screening methods.

In one embodiment, the design of a gene for a VIP as discussed herein comprises, consists of, or consists essentially of selecting at least three elements: a promoter, a microbial rhodopsin voltage protein or other voltage-inducing protein, one or more targeting motifs, and an optional accessory fluorescent protein. Some non-limiting examples for each of these elements are listed in Tables 1a and 1b, and Table 3. In one embodiment, at least one element from each column is selected to create an optical voltage sensor with desired properties. In some embodiments, methods and compositions for voltage sensing as described herein involves selecting: 1) A microbial rhodopsin protein, 2) one or more mutations to imbue the protein with sensitivity to voltage or to other quantities of interest and to eliminate light-driven charge pumping, 3) codon usage appropriate to the host species, 4) a promoter and targeting sequences to express the protein in cell types of interest and to target the protein to the sub-cellular structure of interest, 5) an optional fusion with a conventional fluorescent protein to provide ratiometric imaging, 6) a chromophore to insert into the microbial rhodopsin, and 7) an optical imaging scheme.

TABLE 3
Exemplary optical sensor combinations

| | | | Accessory fluorescent |
|---|---|---|---|
| Promoter | Voltage sensor | Targeting motif | protein |
| CMV (SEQ ID | hGPR (D97N) (SEQ | SS (β2nAChR) (SEQ | Venus (SEQ ID NO: 45) |
| NO: 33) | ID NO: 37) | ID NO: 41) | |
| 14x UAS-Elb | hGPR (D97N, ±E108Q, | SS (PPL) (SEQ ID | EYFP (SEQ ID NO: 46) |
| (SEQ II) NO: | ±E142Q, +L217D) (SEQ | NO: 42) | |
| 34) | ID NO: 38) | | |
| HuC (SEQ ID | hBPR (D99N) (SEQ | ER export motif (SEQ | TagRFP (SEQ ID NO: 47) |
| NO: 35) | ID NO: 39) | ID NO: 43) | |
| ara (SEQ ID | hNpSRII (D75N) (SEQ | TS from Kir2.1 (SEQ | |
| NO: 36) | II) NO: 40) | ID NO: 44) | |
| lac | | MS | |

The genes for microbial rhodopsins (e.g., GPR) express well in E. coli. In one embodiment, to enable expression in eukaryotes a version of the gene with codon usage appropriate to eukaryotic (e.g., human) cells is designed and synthesized. This procedure can be implemented for any gene using publicly available software, such as e.g., the Gene Designer 2.0 package (available on the world wide web at dna20.com/genedesigner2/). Some of the “humanized” genes are referred to herein by placing the letter “h” in front of the name, e.g. hGPR. The Arch 3 rhodopsins and mutants thereof described herein and in the examples are all optimized for human codon usage.

In one embodiment, the VIP gene includes a delivery vector. Such vectors include but are not limited to: plasmids (e.g. pBADTOPO, pCI-Neo, pcDNA3.0), cosmids, and viruses (such as a lentivirus, an adeno-associated virus, or a baculovirus).

Replacement of one codon for another can be achieved using standard methods known in the art. For example codon modification of a parent polynucleotide can be effected using several known mutagenesis techniques including, for example, oligonucleotide-directed mutagenesis, mutagenesis with degenerate oligonucleotides, and region-specific mutagenesis. Exemplary in vitro mutagenesis techniques are described for example in U.S. Pat. Nos. 4,184,917, 4,321,365 and 4,351,901 or in the relevant sections of Ausubel, et al. (CURRENT PROTOCOLS IN MOLECULAR BIOLOGY, John Wiley & Sons, Inc. 1997) and of Sambrook, et al., (MOLECULAR CLONING. A LABORATORY MANUAL, Cold Spring Harbor Press, 1989). Instead of in vitro mutagenesis, the synthetic polynucleotide can be synthesized de novo using readily available machinery as described, for example, in U.S. Pat. No. 4,293,652. However, it should be noted that the present invention is not dependent on, and not directed to, any one particular technique for constructing the synthetic polynucleotide.

As previously discussed, in certain embodiments of the invention, membrane fusion techniques may be used to deliver a voltage-indicating protein and/or a light-emitting moiety. In one set of embodiments, the present invention is generally directed to membrane fusion mediated delivery of a voltage-indicating protein. Membrane fusion reactions are common in eukaryotic cells. Membranes are fused intracellularly in processes including endocytosis, organelle formation, inter-organelle traffic, and constitutive and regulated exocytosis. Membrane fusion has also been induced artificially by the use of liposomes, in which the cell membrane is fused with the liposomal membrane, and by various chemicals or lipids, which induce cell-cell fusion to produce heterokaryons. Naturally occurring proteins shown to induce fusion of biological membranes are mainly fusion proteins of enveloped viruses. Thus, in some embodiments, the voltage-indicating protein is administered using a liposome comprising a fusogenic protein.

Proteins that may be used to induce intercellular fusion of biological membranes include those of enveloped viruses and two proteins from nonenveloped viruses. Enveloped viruses may encode proteins responsible for fusion of the viral envelope with the cell membrane. These viral fusion proteins may be used for infection of susceptible cells. The mechanism of action of fusion proteins from enveloped viruses have served as a paradigm for protein-mediated membrane fusion. Examples of enveloped virus fusion proteins that can be used herein include relatively large, multimeric, type I membrane proteins, as typified by the influenza virus HA protein, a low pH-activated fusion protein, and the Sendai virus F protein, which functions at neutral pH. These are structural proteins of the virus with the majority of the fusion protein oriented on the external surface of the virion to facilitate interactions between the virus particle and the cell membrane.

According to the mechanism of action of fusion proteins from enveloped viruses, fusion of the viral envelope with the cell membrane is mediated by an amphipathic alpha-helical region, referred to as a fusion peptide motif, that is present in the viral fusion protein. This type of fusion peptide motif is typically 17 to 28 residues long, hydrophobic (average hydrophobicity of about 0.6±0.1), and contains a high content of glycine and alanine, typically 36%±7%.

The enveloped virus fusion proteins are believed to function via extensive conformational changes that, by supplying the energy to overcome the thermodynamic barrier, promote membrane fusion. These conformational changes are frequently mediated by heptad repeat regions that form coiled coil structures. Recognition of the importance of fusion peptide motifs in triggering membrane fusion has resulted in the use of small peptides containing fusion peptide motifs to enhance liposome-cell fusion.

Enveloped virus fusion proteins may also be used in some embodiments to trigger cell-cell fusion, resulting in the formation of polykaryons (syncytia). Synthesis of the viral fusion protein inside the infected cell results in transport of the fusion protein through the endoplasmic reticulum and Golgi transport system to the cell membrane, an essential step in the assembly and budding of infectious progeny virus particles from the infected cell. The synthesis, transport, and folding of the fusion protein may be facilitated by a variety of components, including signal peptides to target the protein to the intracellular transport pathway, glycosylation signals for N-linked carbohydrate addition to the protein, and a transmembrane domain to anchor the protein in the cell membrane These proteins have been used in reconstituted proteoliposomes (‘virosomes’) for enhanced, protein-mediated liposome-cell fusion in both cell culture and in vivo.

Thus, in some embodiments of the methods and compositions described herein, a micelle, liposome or other artificial membrane comprising a voltage-indicating protein is administered to a cell. In one embodiment, the composition further comprises a targeting sequence to target the delivery system to a particular cell type. If desired, the exogenous lipid of an artificial membrane composition can further comprise a targeting moiety (e.g., ligand) that binds to mammalian cells to facilitate entry. For example, the composition can include as a ligand an asialoglycoprotein that binds to mammalian lectins (e.g., the hepatic asialoglycoprotein receptor), facilitating entry into mammalian cells. Single chain antibodies, which can target particular cell surface markers, are also contemplated herein for use as targeting moieties. Targeting moieties can include, for example, a drug, a receptor, an antibody, an antibody fragment, an aptamer, a peptide, a vitamin, a carbohydrate, a protein, an adhesion molecule, a glycoprotein, a sugar residue or a glycosaminoglycan, a therapeutic agent, a drug, or a combination of these.

For methods using membrane fusion mediated delivery, in some embodiments of the invention, it is contemplated that the voltage-indicating protein to be used is expressed and produced in a heterologous expression system. Different expression vectors comprising a nucleic acid that encodes an optical sensor or derivative as described herein for the expression of the optical sensor can be made for use with a variety of cell types or species. The expression vector should have the necessary 5′ upstream and 3′ downstream regulatory elements such as promoter sequences, ribosome recognition and binding TATA box, and 3′ UTR AAUAAA transcription termination sequence for efficient gene transcription and translation in the desired cell. In some embodiments, the optical sensors are made in a heterologous protein expression system and then purified for production of lipid-mediated delivery agents for fusion with a desired cell type. In such embodiments, the expression vector can have additional sequences such as 6×-histidine, V5, thioredoxin, glutathione-S-transferase, c-Myc, VSV-G, HSV, FLAG, maltose binding peptide, metal-binding peptide, HA and “secretion” signals (e.g., Honeybee melittin Pho, BiP), which are incorporated into the expressed recombinant optical sensor for ease of purification. In addition, there can be enzyme digestion sites incorporated after these sequences to facilitate enzymatic removal of additional sequence after they are not needed. These additional sequences are useful for the detection of optical sensor expression, for protein purification by affinity chromatography, enhanced solubility of the recombinant protein in the host cytoplasm, for better protein expression especially for small peptides and/or for secreting the expressed recombinant protein out into the culture media, into the periplasm of the prokaryote bacteria, or to the spheroplast of yeast cells. The expression of recombinant optical sensors can be constitutive in the host cells or it can be induced, e.g., with copper sulfate, sugars such as galactose, methanol, methylamine, thiamine, tetracycline, infection with baculovirus, and (isopropyl-beta-D-thiogalactopyranoside) IPTG, a stable synthetic analog of lactose, depending on the host and vector system chosen.

Examples of other expression vectors and host cells are the pET vectors (Novagen), pGEX vectors (Amersham Pharmacia), and pMAL vectors (New England Labs. Inc.) for protein expression in E. coli host cells such as BL21, BL21(DE3) and AD494(DE3)pLysS, Rosetta (DE3), and Origami(DE3) (Novagen); the strong CMV promoter-based pcDNA3.1 (Invitrogen) and pCIneo vectors (Promega) for expression in mammalian cell lines such as CHO, COS, HEK-293, Jurkat, and MCF-7; replication incompetent adenoviral vector vectors pAdeno X, pAd5F35, pLP-Adeno-X-CMV (Clontech), pAd/CMV/V5-DEST, pAd-DEST vector (Invitrogen) for adenovirus-mediated gene transfer and expression in mammalian cells; pLNCX2, pLXSN, and pLAPSN retrovirus vectors for use with the Retro-X™ system from Clontech for retroviral-mediated gene transfer and expression in mammalian cells; pLenti4/V5-DEST™, pLenti6/V5-DEST™, and pLenti6.2/V5-GW/lacZ (Invitrogen) for lentivirus-mediated gene transfer and expression in mammalian cells; adenovirus-associated virus expression vectors such as pAAV-MCS, pAAV-IRES-hrGFP, and pAAV-RC vector (Stratagene) for adeno-associated virus-mediated gene transfer and expression in mammalian cells; BACpak6 baculovirus (Clontech) and pFastBac™ HT (Invitrogen) for the expression in Spodopera frugiperda 9 (Sf9) and Sf11 insect cell lines; pMT/BiP/V5-His (Invitrogen) for the expression in Drosophila Schneider S2 cells; Pichia expression vectors pPICZα, pPICZ, pFLDα and pFLD (Invitrogen) for expression in Pichia pastoris and vectors pMETα and pMET for expression in P. methanolica; pYES2/GS and pYD1 (Invitrogen) vectors for expression in yeast Saccharomyces cerevisiae. Large scale expression of heterologous proteins in Chlamydomonas reinhardtii may also be used. Foreign heterologous coding sequences are inserted into the genome of the nucleus, chloroplast and mitochondria by homologous recombination. The chloroplast expression vector p64 carrying the versatile chloroplast selectable marker aminoglycoside adenyl transferase (aadA), which confers resistance to spectinomycin or streptomycin, can be used to express foreign protein in the chloroplast. The biolistic gene gun method can be used to introduce the vector in the algae. Upon its entry into chloroplasts, the foreign DNA is released from the gene gun particles and integrates into the chloroplast genome through homologous recombination.

Cell-free expression systems are also contemplated for use in certain embodiments of the invention. Cell-free expression systems offer several advantages over traditional cell-based expression methods, including the easy modification of reaction conditions to favor protein folding, decreased sensitivity to product toxicity and suitability for high-throughput strategies such as rapid expression screening or large amount protein production because of reduced reaction volumes and process time. The cell-free expression system can use plasmid or linear DNA. Moreover, improvements in translation efficiency have resulted in yields that exceed a milligram of protein per milliliter of reaction mix. As an example, a cell-free translation system capable of producing proteins in high yield may be used. The method uses a continuous flow design of the feeding buffer which contains amino acids, adenosine triphosphate (ATP), and guanosine triphosphate (GTP) throughout the reaction mixture and a continuous removal of the translated polypeptide product. The system uses E. coli lysate to provide the cell-free continuous feeding buffer. This continuous flow system is compatible with both prokaryotic and eukaryotic expression vectors. As an example, large scale cell-free production of the integral membrane protein EmrE multidrug transporter may be. Other commercially available cell-free expression systems include the Expressway™ Cell-Free Expression Systems (Invitrogen) which utilize an E. coli-based in vitro system for efficient, coupled transcription and translation reactions to produce up to milligram quantities of active recombinant protein in a tube reaction format; the Rapid Translation System (RTS) (Roche Applied Science) which also uses an E. coli-based in vitro system; and the TNT Coupled Reticulocyte Lysate Systems (Promega) which uses a rabbit reticulocyte-based in vitro system.

### VI. Conclusion

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention, e.g., machine-readable instructions for executing methods for temporal super-resolution of measured time-varying images, machine-readable instructions for automated or semi-automated control of microscopy system 200, may be embodied at least in part as a computer-readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

### EXAMPLES

For further purposes of understanding, results of preliminary experimental trials are provided below. These examples are intended to illustrate certain embodiments of the present invention, but do not exemplify the full scope of the invention. Details of these examples may also be found in “Optical recording of action potential in mammalian neurons using a microbial rhodopsin,” to J. M. Kralj et al., Nature Methods, published online Nov. 27, 2011, which is incorporated herein by reference in its entirety.

In the experimental trials, reliable optical detection of single action potentials in mammalian neurons was observed using a genetically encoded voltage-indicating protein which had approximately 10-fold improvements in sensitivity and speed over other protein-based voltage indicators. The endogenous fluorescence of a microbial rhodopsin protein, Archaerhodopsin 3 (Arch), showed a roughly linear 2-fold increase in brightness between −150 mV and +150 mV, with a sub-millisecond response time. Due to its light-induced proton pumping activity, Arch caused a membrane hyperpolarization upon exposure to the imaging laser. Nonetheless, single electrically triggered action potentials yielded bursts of fluorescence with optical signal-to-noise ratio greater than about 10. The mutant Arch D95N showed 50% greater sensitivity than wild-type and lacked endogenous proton pumping, but had a slower response (41 ms). Arch was still capable of resolving individual action potentials. In view of the experiments, microbial rhodopsin-based voltage indicators may enable optical interrogation of complex neural circuits, and electrophysiology in systems for which electrode-based techniques are challenging.

This example illustrates a voltage indicator based on green-absorbing proteorhodopsin (GPR). This Proteorhodopsin Optical Proton Sensor (PROPS) revealed electrical spiking in E. coli, but efforts to use PROPS in eukaryotic cells failed because the protein did not localize to the plasma membrane. Addition of targeting and localization sequences to PROPS did not help. Other microbial rhodopsins were tested as putative voltage sensors, focusing on proteins that localize to the eukaryotic plasma membrane. Archaerhodopsin 3 (Arch) from Halorubrum sodomense is a light-driven outward proton pump, capturing solar energy for its host. Arch may be expressed in mammalian neurons, wherein it enables optical silencing of neural activity, and has been shown to be minimally perturbative to endogenous function in the dark. This example shows that a membrane potential could alter the optical properties of the protein, and thereby provide a voltage sensor that functioned through a mechanism similar to PROPS.

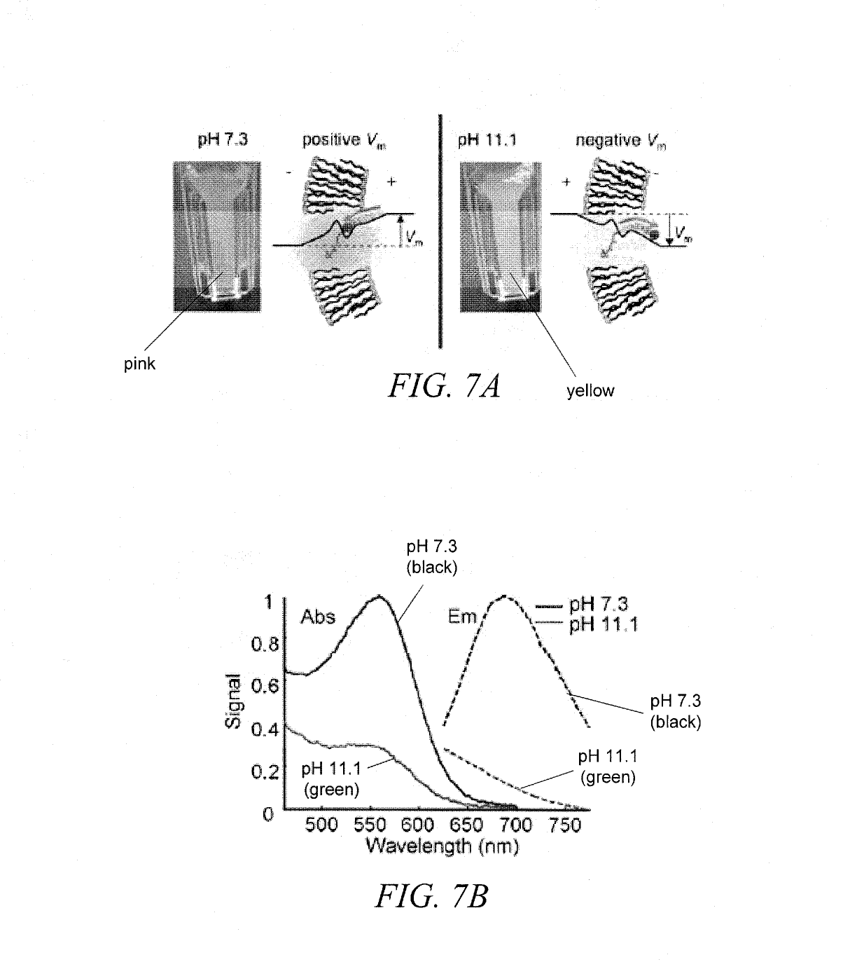

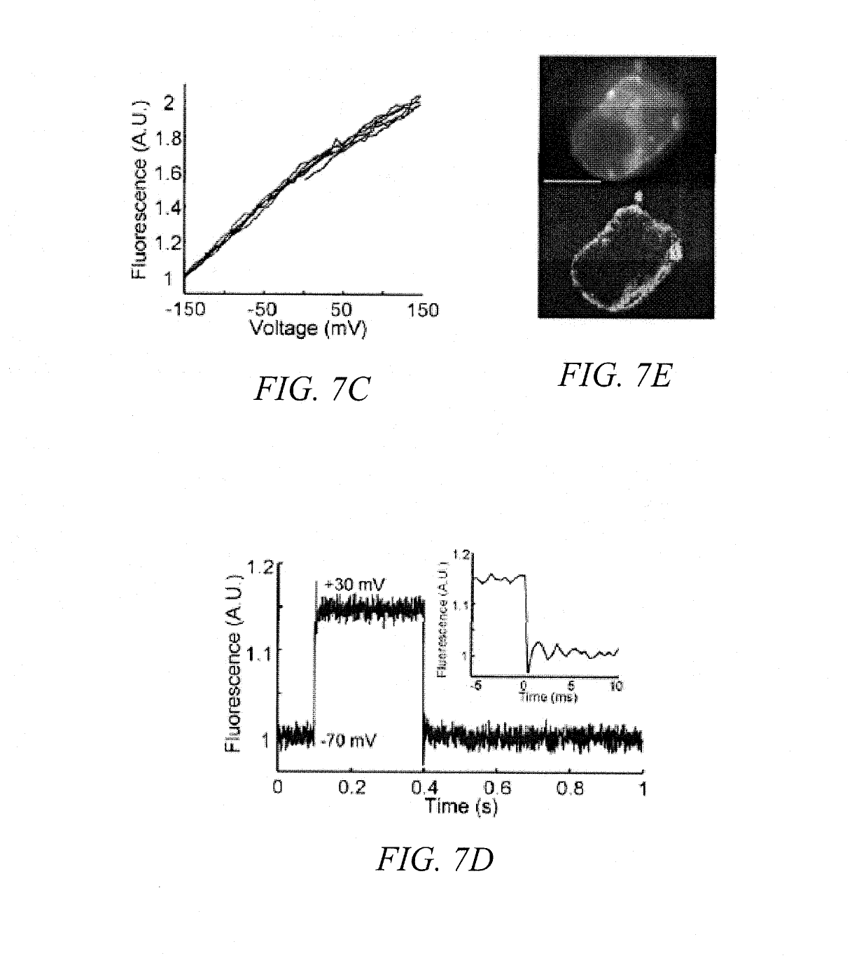

Arch was bacterially expressed in this example. At neutral pH, the bacterially expressed Arch was pink, but at high pH the protein turned yellow (see FIG. 7A), with a pKₐ for the transition of 10.1 (Methods 1). Based on homology to other microbial rhodopsins, it was believed that the pH-induced color change to deprotonation of the Schiff Base (SB) which links the retinal chromophore to the protein core. It was believed that a change in membrane potential might change the local electrochemical potential of the proton at the SB, tipping the acid-base equilibrium and inducing a similar color shift (FIG. 7A). This mechanism of voltage-induced color shift has previously been reported in dried films of bacteriorhodopsin, and formed the hypothesized basis of voltage sensitivity in PROPS.

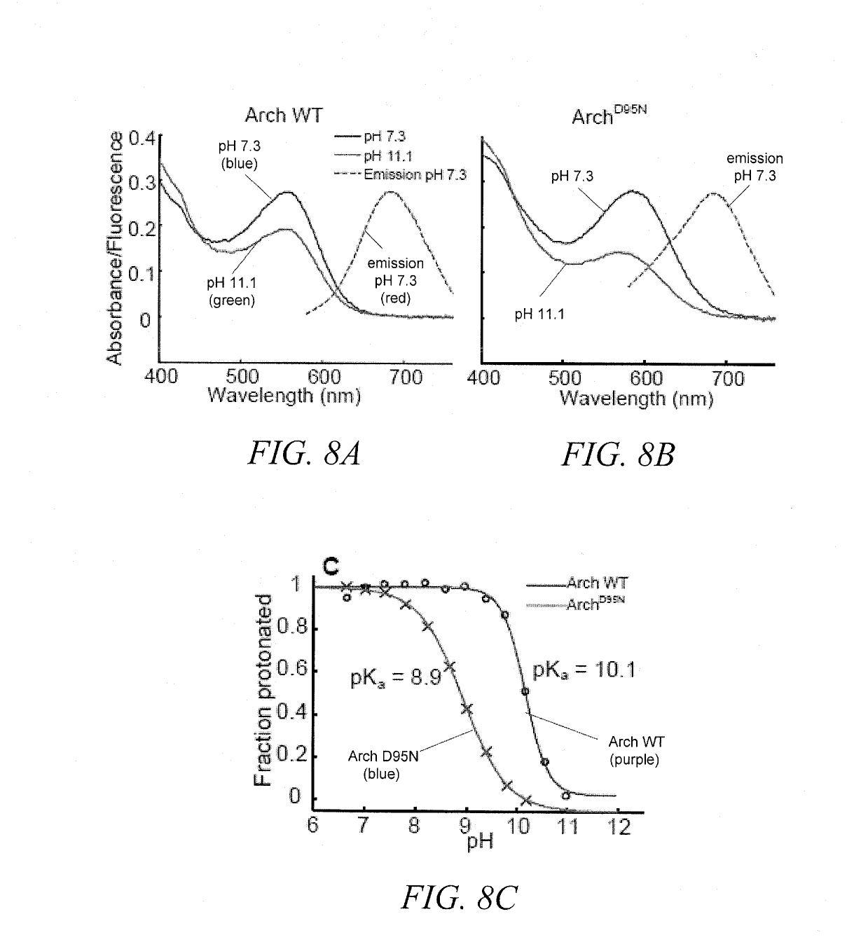

Most microbial rhodopsins are weakly fluorescent, so Arch was characterized (Methods 1-3) as a prospective fluorescent indicator (Table 4). At neutral pH, Arch emitted far red fluorescence (λₑₘ≈687 nm), while at high pH Arch was not fluorescent (see FIG. 7B and FIGS. 8A-8C). The fluorescence quantum yield of Arch was low (about 9×10⁻⁴) but the photostability was comparable to members of the GFP family. A comparison of photobleaching rates of Arch (excited at about 640 nm) with eGFP (excited at about 488 nm) in a 1:1 Arch-eGFP fusion, showed that the mean numbers of photons emitted per molecule prior to photobleaching were approximately in the ratio 1:3.9 (Arch:eGFP). The broad absorption peak enabled excitation of Arch at λ≈640 nm, a wavelength where few other cellular components absorb, and the far red emission occurred in a spectral region of little background autofluorescence.

TABLE 4

| | λₘₐₓ | λₘₐₓ | | | Photostability | | | Noise in | |
|---|---|---|---|---|---|---|---|---|---|
| | abs | em⁽¹⁾ | ε₆₃₃⁽²⁾ | | relative to | pKₐ of | τᵣₑₛₚₒₙₛₑ⁽⁶⁾ | \hat{V}_{FL}⁽⁷⁾ | Photo- |
| | (nm) | (nm) | (M⁻¹ cm⁻¹) | QY⁽³⁾ | eGFP⁽⁴⁾ | SB⁽⁵⁾ | (ms) | (μV/Hz^{1/2}) | current |
| Arch WT | 558 | 687 | 6,300 | 9 × 10⁻⁴ | 0.25 | 10.1 | < 0.5 | 625 | yes |
| Arch D95N | 585 | 687 | 37,500 | 4 × 10⁻⁴ | 0.1 | 8.9 | 41 | 260 | no |

Table 4 describes optical and electrical responses of Arch WT and D95N. Notes are as follows: ⁽¹⁾ Excitation at λ=532 nm; ⁽²⁾ absorption spectra calibrated assuming the same peak extinction coefficient as Bacteriorhodopsin, 63,000 M⁻¹ cm⁻¹ (see Methods 2); ⁽³⁾ Determined via comparison to Alexa 647 with excitation at λ=633 nm; ⁽⁴⁾ measured in a 1:1 fusion with eGFP; ⁽⁵⁾ determined via singular value decomposition on absorption spectra; ⁽⁶⁾ determined from step-response (Arch D95N has a minor component of its response (about 20%) that is fast (less than about 500 s); ⁽⁷⁾ \hat{V}_{FL} is the membrane potential estimated from fluorescence. Noise was determined at frequencies f≧0.1 Hz in HEK cells. (Further details of these measurements are described in the Methods section.)

Fluorescence of Arch in HEK 293 cells supplemented with about 5 μM all-trans retinal (See Methods 4) was readily imaged in an inverted fluorescence microscope with red illumination (λ=640 nm, about 20 mW, and about I=540 W/cm²), a high numerical aperture objective (NA), a Cy5 filter set, and an EMCCD camera (See Methods 5, FIG. 3A). The cells exhibited fluorescence predominantly localized to the plasma membrane as could be observed in a video recording of the sample using a microscopy system 300 as depicted in FIG. 3A. Cells not expressing Arch were not fluorescent. Cells showed about 17% photobleaching over a continuous 10-minute exposure, and retained normal morphology during this interval.

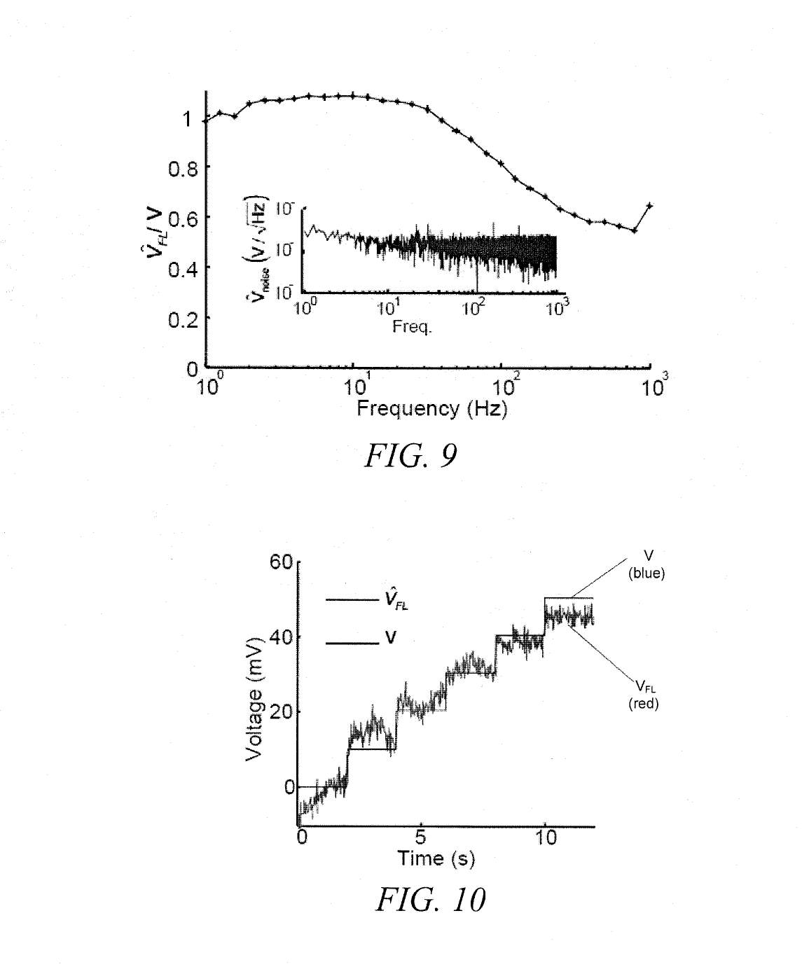

The fluorescence of HEK cells expressing Arch was found to be highly sensitive to membrane potential, as determined via whole-cell voltage clamp as could also be observed in a video recording of the sample using the microscopy system (Methods 6). Fluorescence of Arch in the plasma membrane increased by a factor of about 2 between about −150 mV and about +150 mV, with a nearly linear response throughout this range (FIG. 7C). The response of fluorescence to a step in membrane potential occurred within the 500 μs time resolution of the imaging system on both the rising and falling edge (FIG. 1d, Methods 7). Application of a sinusoidally varying membrane potential led to sinusoidally varying fluorescence; at a frequency f≈1 kHz, the fluorescence oscillations retained about 55% of their low-frequency amplitude (Methods 8, FIG. 9). Arch retained its endogenous proton-pumping capability, and illumination with the imaging laser generated outward photocurrents of about 10 pA to about 20 pA.

For the data of FIG. 9, a chirped sine wave with an amplitude of about 50 mV and frequency from about 1 Hz to about 1 kHz was applied to the cell. Membrane potential \hat{V}_{FL} was determined from fluorescence and the Fourier transform of \hat{V}_{FL} was calculated. The uptick at about 1 kHz is an artifact of electronic compensation circuitry. Inset: power spectrum of noise in \hat{V}_{FL}, under voltage clamp at constant V=0 mV shows a shot-noise limited noise floor of about 470 μV/(Hz)^{1/2} at frequencies above about 10 Hz. The noise figures reported here are specific to our imaging system and serve primarily as an indicator of the possible sensitivity of Arch.

A linear regression algorithm was developed to identify pixels whose intensity co-varied with an external “training” stimulus (Methods 9). When trained on the unweighted whole-field fluorescence, this algorithm identified pixels associated with the cell membrane (FIG. 7E) and rejected pixels corresponding to bright but voltage-insensitive intracellular aggregates. Application of the pixel weight matrix to the raw fluorescence led to estimates of voltage-induced changes in fluorescence with improved signal-to-noise ratio (SNR) relative to unweighted whole-field fluorescence. This use of the pixel weighting algorithm made no use of electrophysiology data.

Fluorescence data alone was insufficient to determine true membrane potential, because cell-to-cell variation in expression level and membrane localization led to an a priori unknown offset and scale factor between fluorescence and voltage. When trained on the electrophysiology data, the algorithm returned pixel weight coefficients that could be used to convert fluorescence images into a maximum likelihood estimate of the membrane potential, (Methods 7). After training on a voltage sweep from about −150 mV to about +150 mV, the fluorescence-based \hat{V}_{FL} matched the electrically recorded Vₘ with an accuracy of about 625 μV/(Hz)^{1/2} (See FIG. 10). Over timescales longer than ˜10 s, laser power fluctuations and cell motion degraded the sub-mV precision of the voltage determination, but had no effect on the ability to detect fast transients in Vₘ.

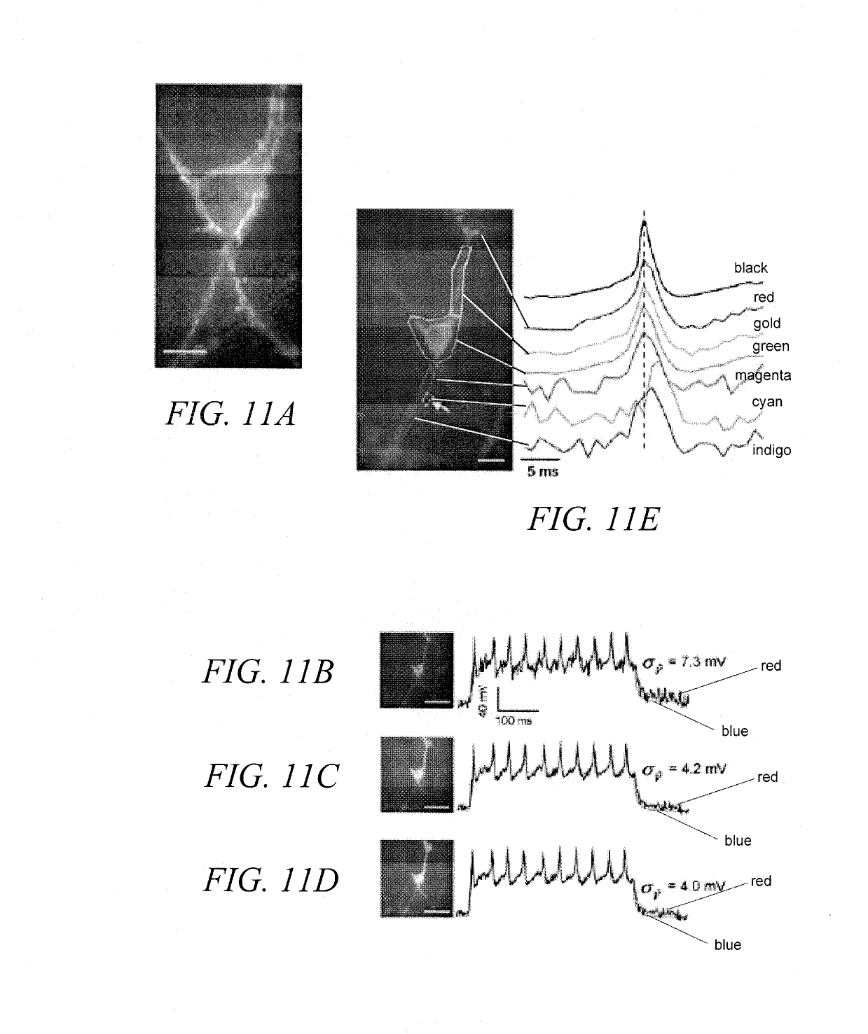

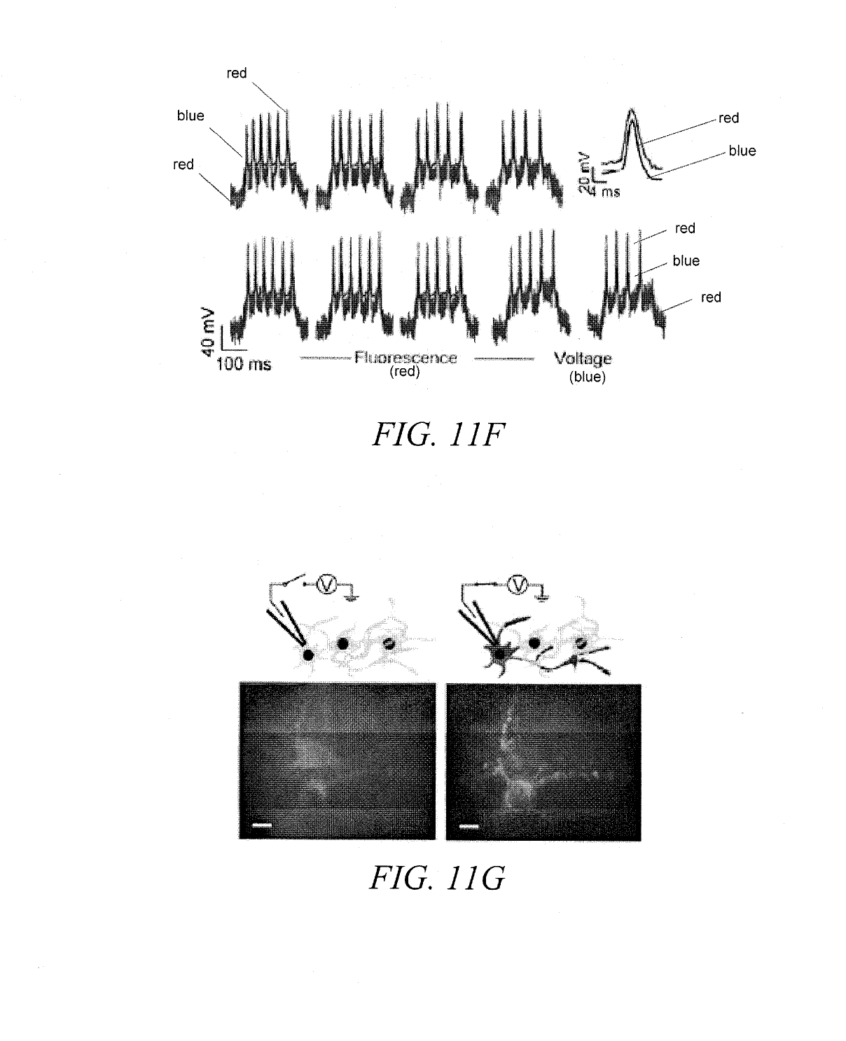

Arch was tested as a voltage indicator in cultured rat hippocampal neurons, using viral delivery (Methods 10-11). Neurons expressing Arch showed membrane-localized fluorescence (FIG. 11A). Under whole cell current clamp, cells exhibited spiking upon injection of current pulses of about 200 pA. Individual spikes were accompanied by clearly identifiable increases of whole-field fluorescence (FIG. 11B). Preferentially weighting pixels whose intensity co-varied with the whole-field fluorescence led to an about 74% improvement in SNR (FIG. 11C). This training procedure made no use of the electrical recording. Training the pixel-weighting algorithm on the electrical recording led to a further 5% increase in SNR. (FIG. 11D).

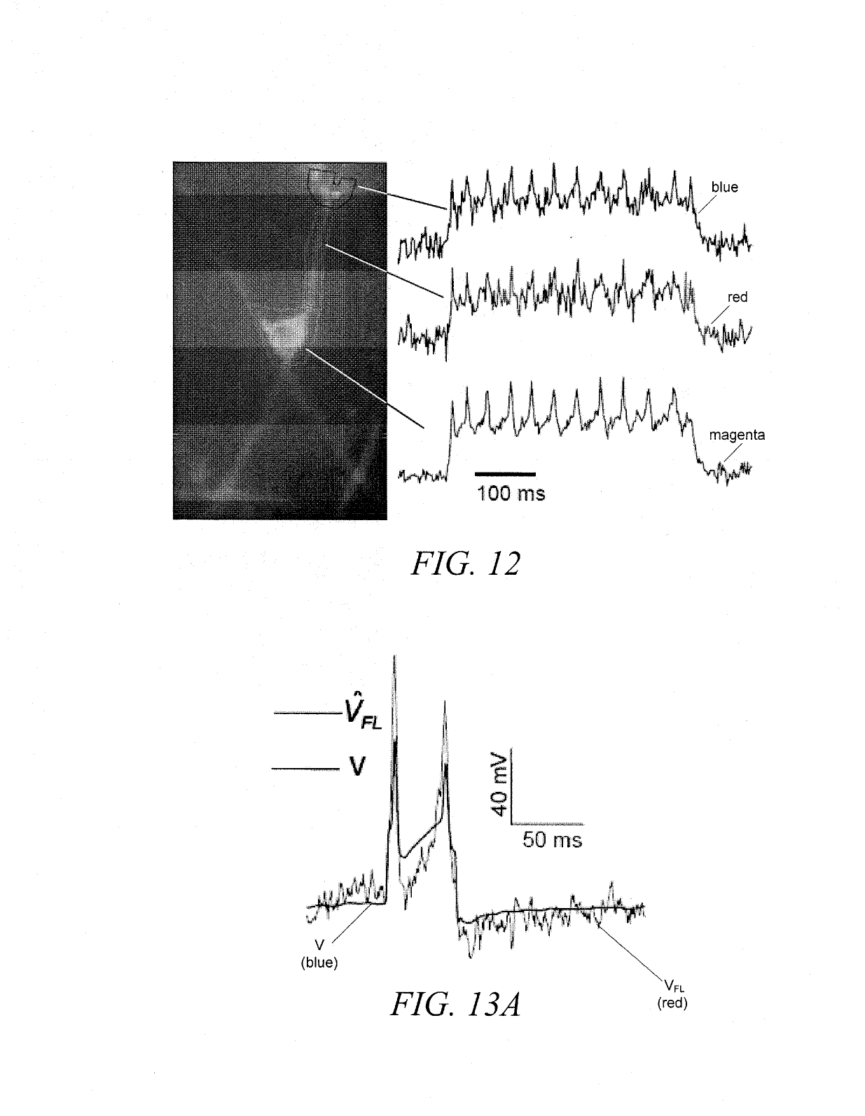

The dynamics of APs were imaged with sub-cellular resolution using the microscopy system as depicted in FIG. 3A to produce a video of the AP dynamics (also see FIG. 12). To improve the signal-to-noise ratio multiple movies were registered and averaged temporally of single spikes (see FIG. 11E). APs appeared to occur nearly simultaneously throughout most regions of the cell, as expected given the field of view (100 μm) and exposure time (2 ms). However, in localized regions the AP lagged by 2-3 ms. This lag is particularly apparent in the recorded videos. The present results suggest that Arch may be used to map intracellular dynamics of APs in genetically specified neurons, in a manner similar to a recent demonstration with voltage sensitive dyes.

FIG. 11F shows a gallery of single-trial optical and electrical recordings. At a 2 kHz frame rate, the signal-to-noise ratio in the fluorescence (spike amplitude:baseline noise) was about 10.5. A spike-finding algorithm correctly identified 99.6% of the spikes (based on comparison to simultaneously recorded membrane potential), with a false-positive rate of 0.7% (n=269 spikes) (Methods 12). The average AP waveform determined by fluorescence coincided with the waveform recorded electrically. Single cells were observed for up to 4 minutes of cumulative exposure, with no detectable change in resting potential or spike frequency.

A procedure was developed to electrically tag a single cell in an otherwise overgrown field of neurons. The average fluorescence of the population of cells, all expressing Arch, did not show clearly resolved cellular structures (FIG. 11G). A whole-cell patch was formed on one cell, which was then subjected to a voltage clamp triangle wave of amplitude 150 mV, under video observation. The weight matrix, indicating which pixels contained information about the applied voltage, yielded a clear image of the target cell and all of its processes. Electrical tagging provides a complement to genetic and chemical methods which are currently used to label single neurons.

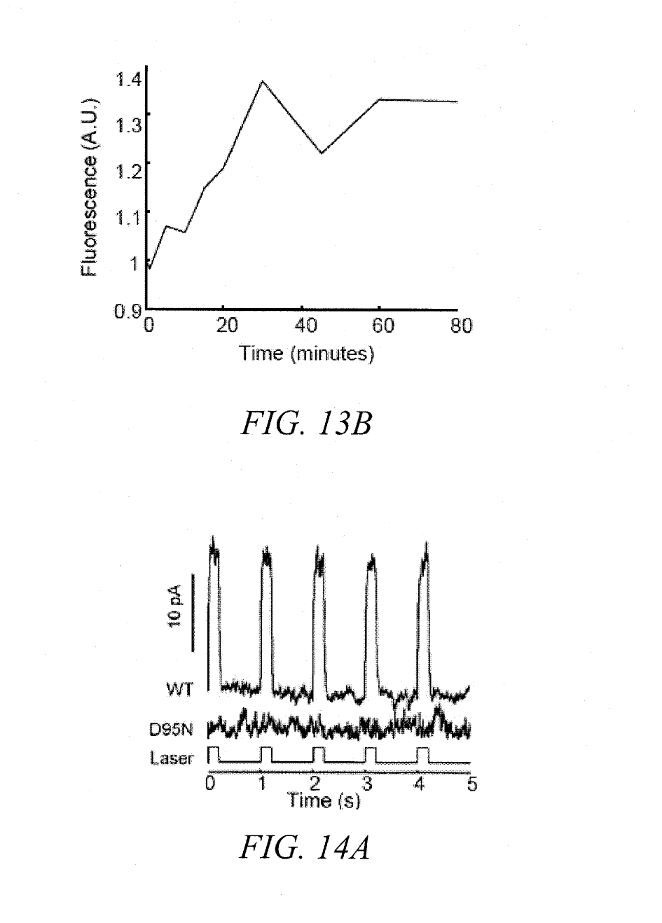

In the absence of added retinal, neurons expressing Arch showed clearly identifiable fluorescence flashes accompanying individual spikes (FIG. 13A), indicating that neurons contained sufficient endogenous retinal to populate some of the protein. In FIG. 13A, a single-trial recording of APs from a 14 DIV neuron expressing Arch WT, without exogenous retinal, shows electrical (blue) and fluorescence (red) traces. APs are clearly resolved. Addition of supplemental retinal led to an about 30-60% increase in fluorescence over 30 minutes (FIG. 13B). FIG. 13B shows fluorescence of a single neuron as a function of time after addition of 10 μM retinal. To avoid conflation of voltage dynamics with the effects of retinal incorporation, the neuron was depolarized by treatment with CCCP prior to the experiment. Experiments with Arch and other microbial rhodopsins in vivo have shown that endogenous retinal is sufficient for optogenetic control of neural activity. Thus Arch may function as a voltage indicator in vivo without exogenous retinal.

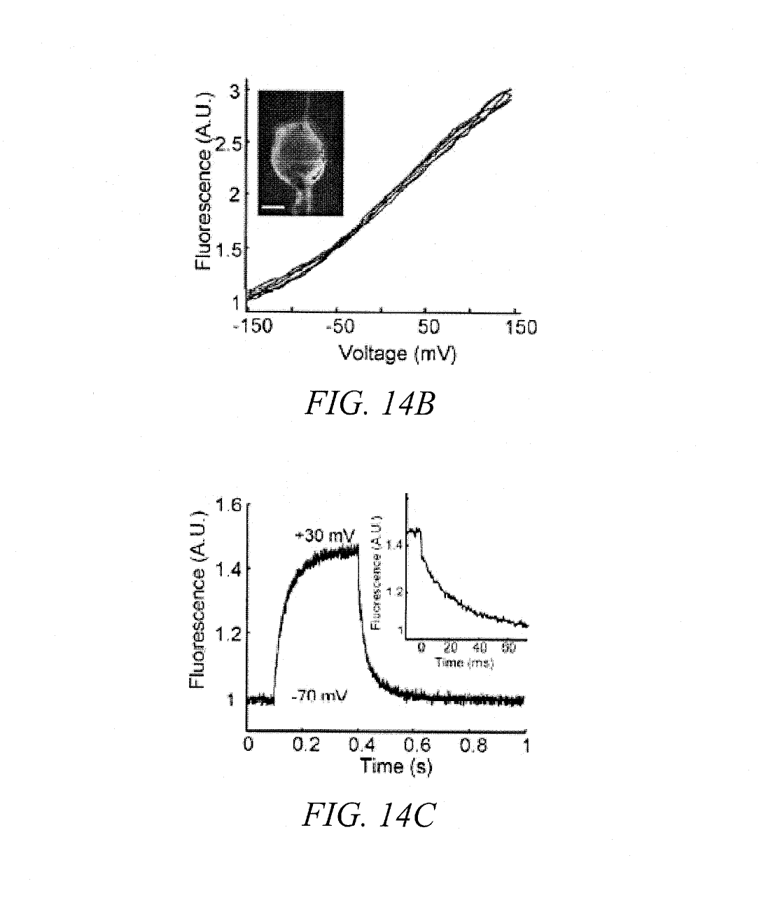

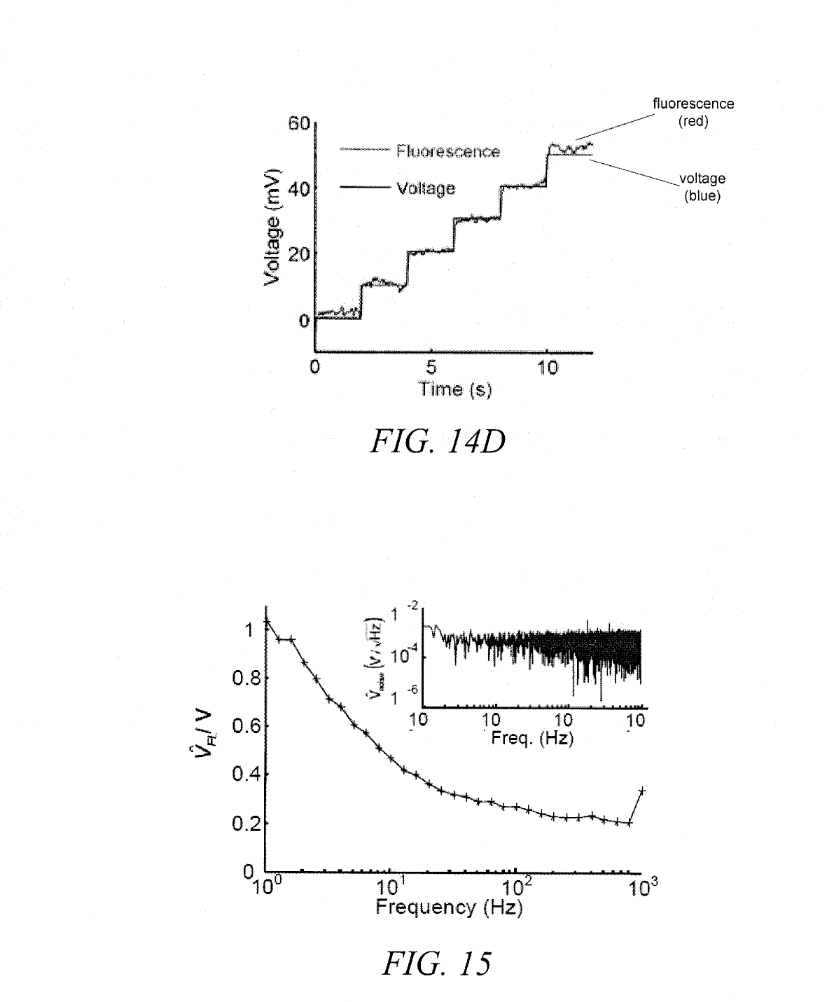

Illumination at 640 nm was far from the peak of the Arch absorption spectrum (λ=558 nm), but the imaging laser nonetheless induced photocurrents of about 10-20 pA in HEK cells expressing Arch (FIG. 14A). A mutant was sought which did not perturb the membrane potential, yet which maintained voltage sensitivity. The mutation D85N in bacteriorhodopsin eliminated proton pumping, so the homologous mutation, D95N, was introduced into Arch. This mutation eliminated the photocurrent (FIG. 14A) and shifted several other photophysical properties of importance to voltage sensing (Table 4, FIGS. 14A-14D, FIG. 15). Movies of the fluorescence response to changes in membrane potential were recorded using a microscopy system as depicted I FIG. 3A. ArchD95N was more sensitive than Arch WT, but had a slower response (FIGS. 14B-14D).

Under illumination conditions typically used for imaging neural activity (I=1800 W/cm² in total internal reflection (TIR) mode), the light-induced outward photocurrent was typically about 10 pA in neurons expressing Arch WT. Under current-clamp conditions this photocurrent shifted the resting potential of the neurons by up to −20 mV. For neurons near their activation threshold, this photocurrent could suppress firing (FIG. 16A), so the non-pumping variant D95N was explored as a voltage indicator in neurons. Illumination of ArchD95N did not perturb membrane potential in neurons (FIG. 16B).

ArchD95N reported neuronal APs on a single-trial basis (FIG. 16C). The response to a depolarizing current pulse was dominated by the slow component of the step response; yet the fast component of the response was sufficient to indicate APs.

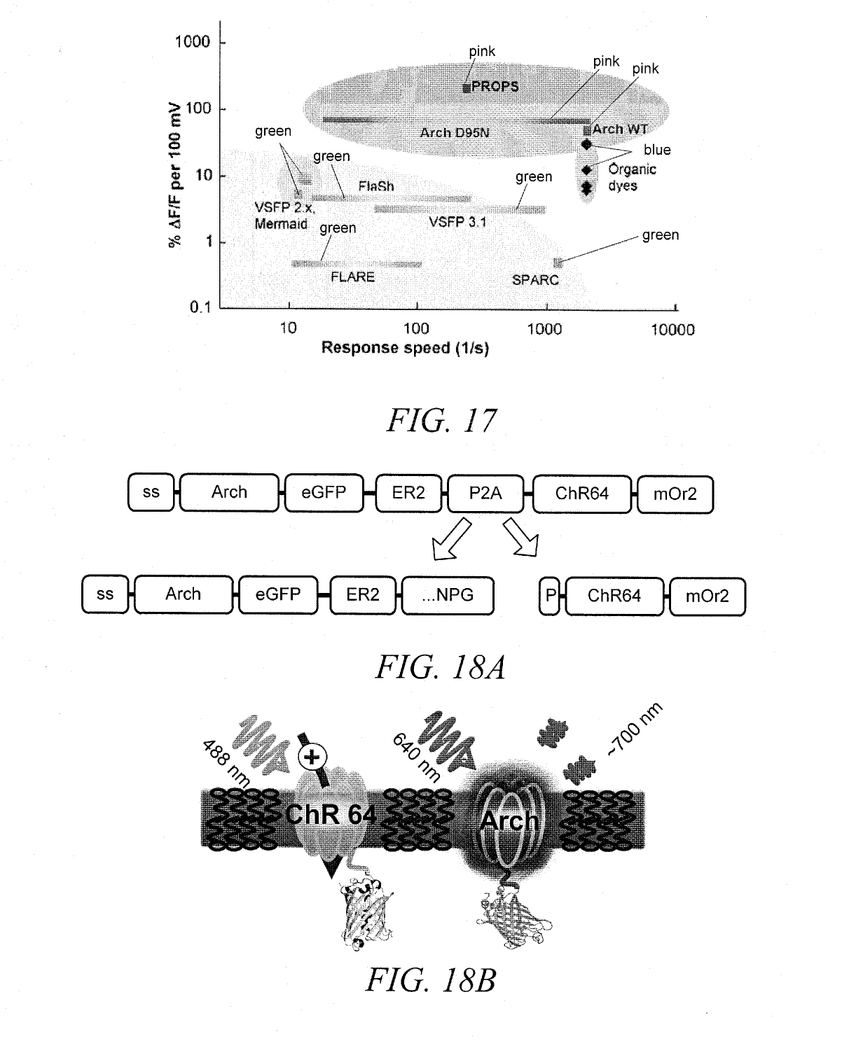

FIG. 17 shows a comparison of Arch WT and D95N to other fluorescent voltage indicators, plotted according to sensitivity and response speed. The positions of existing indicators are approximate and obtained from literature data. The most sensitive fluorescent proteins, the VSFP 2.x family, have changes in fluorescence of approximately 10% per 100 mV of voltage, with a response time of approximately 100 ms. The SPARC family of voltage sensors has a 1 ms response time, and shows a fluorescence change of less than 1% per 100 mV. Microbial rhodopsin-based indicators are significantly more sensitive than other probes. The most sensitive microbial rhodopsin-based indicator is the Proteorhodopsin Optical Proton Sensor (PROPS), but PROPS only functions in prokaryotes. Fluorescent voltage sensitive dyes (VSDs) are also shown in FIG. 17. Some of these compounds have enabled optical recording of action potentials in brain slice with signal-to-noise exceeding that of Arch. Table 5 contains the data on which FIG. 17 is based. Table 5 shows approximate characteristics of fluorescent voltage indicating proteins. In some cases numbers were estimated from published plots. The table contains representative members of all families of fluorescent indicators but omits many.

TABLE 5

| | Approx ΔF/F | Approx | | |
|---|---|---|---|---|
| Molecule | per 100 mV | response time | | Comments |
| VSFP 2.3¹ | 9.5% | 78 | ms | Ratiometric (ΔR/R) |
| VSFP 2.4¹ | 8.9% | 72 | ms | Ratiometric (ΔR/R) |
| VSFP 3.1² | 3% | 1-20 | ms | Protein |
| Mermaid³ | 9.2% | 76 | | Ratiometric (ΔR/R) |
| SPARC⁴ | 0.5% | 0.8 | ms | Protein |
| FlaSb⁵ | 5.1% | 2.8-85 | ms | Protein |
| Flare⁶ | 0.5% | 10-100 | ms | Protein |
| PROPS⁷ | 150% | 5 | ms | Protein |
| di-4-ANEPPS⁸ | 8% | <1 | ms | Dye |
| di-8-ANEPPS⁹ | 10% | <1 | ms | Dye |
| RH237¹⁰ | 11% | <1 | ms | Dye |
| RH421¹¹ | 21% | <1 | ms | Dye |
| ANNINE-dplus¹² | 30% | <1 | ms | Dye |
| hVOS¹³ | 34% | <1 | ms | hybrid |
| DIO/DPA¹⁴ | 56% | <1 | ms | hybrid |

Arch is one of approximately 5,000 known microbial rhodopsins. This family of proteins may be explored for its ability to label biological membranes with a color-tunable, photostable, and environmentally sensitive chromophore, with no homology to GFP. Screens of wild-type and mutated microbial rhodopsins may be used to identify variants that are fast, like Arch WT, but that lack pumping, like ArchD95N. Efforts to increase the brightness or to find other non-fluorescent imaging modalities are also contemplated. Initial efforts to observe two-photon fluorescence from Arch were not successful; but the excitation of Arch is red-shifted relative to most two-photon fluorophores, so additional studies with spectrally tuned two-photon excitation are warranted. Fusions of Arch with other fluorescent proteins may enable ratiometric voltage measurements, as well as simultaneous measurements of voltage and pH or Ca2+. Ratiometric measurements may be useful, because they are substantially insensitive to variations in expression level or to movement artifacts. The combination of optogenetic voltage measurement with the recently established techniques of optogenetic voltage control may enable progress toward all-optical electrophysiology.

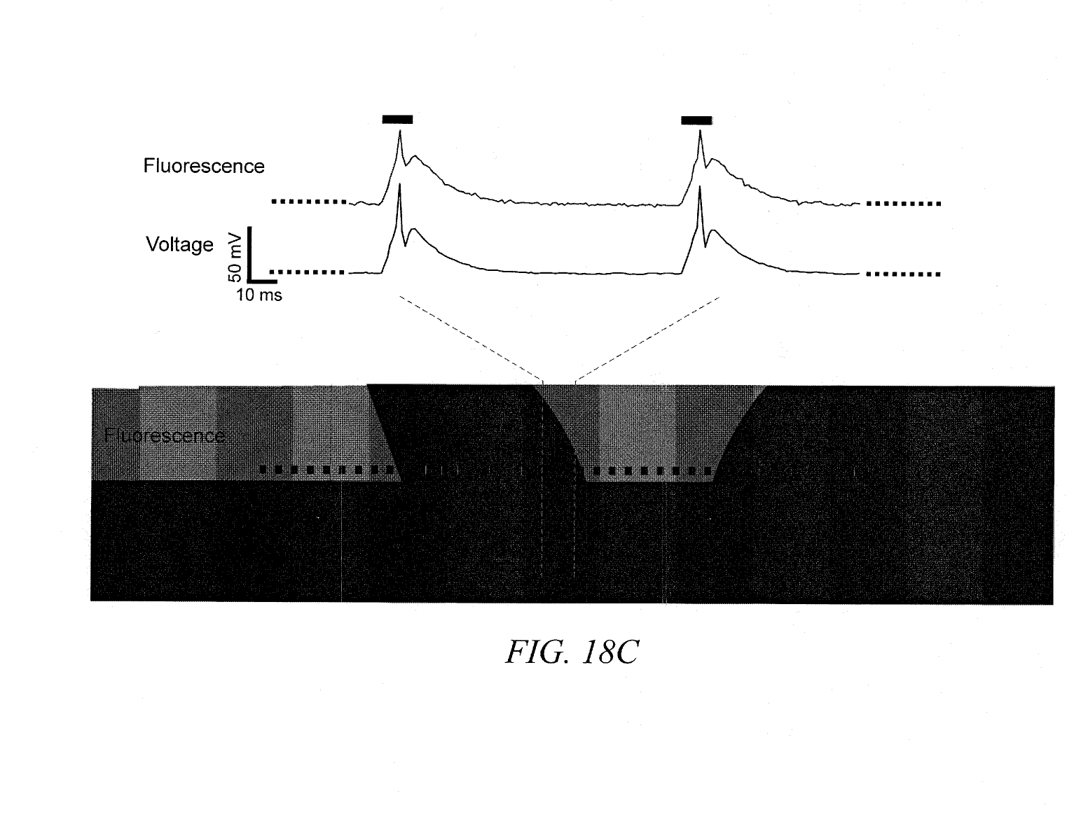

In another example, a genetic construct termed “Optopatch” was used to provide simultaneous optical stimulation and recording from neurons. One embodiment of the Optopatch construct consisted of a bicistronic vector for co-expression of channelrhopsin 64 (ChR64)-mOrange II and archaerhodopsin 3 (Arch)-eGFP. This construct is depicted in FIG. 18A. The abbreviations used in the figure may be interpreted as follows. ss: Signaling sequence designed to improve the trafficking of Arch to the plasma membrane; Arch: Archaerhodopsin 3; eGFP: Enhanced green fluorescent protein; ER2: Endoplasmic reticulum export motif, designed to improve the trafficking of Arch to the plasma membrane; P2A: porcine teschovirus-1 2A sequence, a ribosomal skip-site leading to expression of two proteins from a single mRNA transcript; ChR64: Channelrhodopsin 64, a blue light-activated ion channel; mOr2: mOrange 2 fluorescent protein.

The construct contained a ribosomal skip sequence (a P2A linker peptide) to produce two proteins in a 1:1 stoichiometry from a single mRNA transcript, as illustrated in the depiction of FIG. 18B. This construct was optimized for expression level, membrane trafficking, stoichiometric co-expression, and spectral separability of the actuator and reporter. ChR64 had a blue-shifted action spectrum, high expression, and large photocurrents compared to the more commonly used Channelrhodopsin 2. Arch had an advantageous red-shifted illumination wavelength (640 nm), high sensitivity, and high speed.

The optopatch construct was expressed under control of the CamKIIa or hSynapsin1 promoter in cultured mouse hippocampal neurons. Illumination with red light under standard wide-field imaging conditions (230 W/cm², 640 nm) led to an outward photocurrent mediated by Arch of 34±7 pA (n=6 cells). This current hyperpolarized cells by 6.1±1.1 mV (n=8 cells). Despite this hyperpolarization, neurons expressing Optopatch showed spontaneous bursts of red fluorescence, indicative of spontaneous activity most likely driven by synaptic transmission in the culture. Illumination with dim blue light (15 mW/cm², 488 nm), led to an inward photocurrent mediated by ChR64 of 216±114 pA (n=7 cells). Thus, the hyperpolarizing Arch photocurrent was easily overwhelmed by the depolarizing ChR64 photocurrent.

Whole-field illumination with pulses of blue light (20 mW/cm², 10 ms, 488 nm, repeated at 10 Hz) led to flashes of red fluorescence (em: 660-760 nm), detected on a high speed EMCCD camera. A simultaneous patch clamp recording showed that each flash corresponded to a single action potential. The optically-recorded fluorescence waveform coincided closely with the electrically recorded waveform on a single-trial basis (as shown in FIG. 18C), with a noise in the optically recorded voltage of 1.1 mV at a 1 kHz acquisition rate.

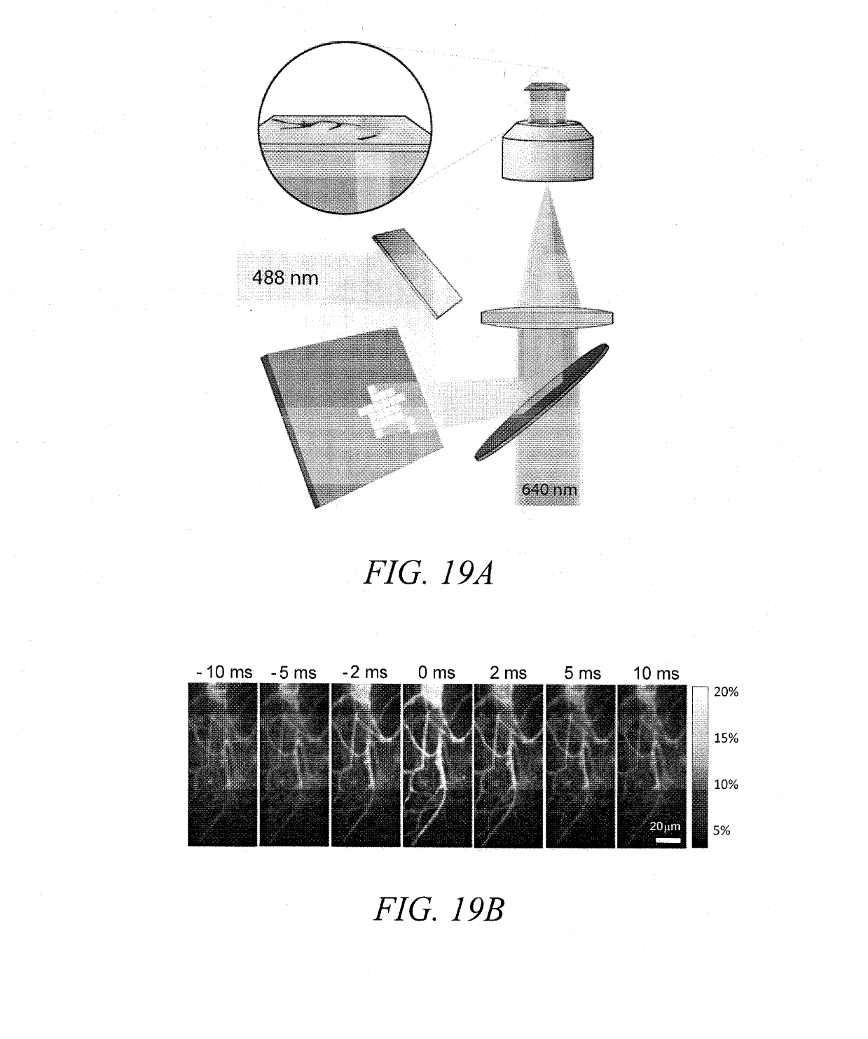

A digital micromirror device (DMD; 608×684 pixels, 4000 frames/s) was incorporated into the 488 nm excitation path to stimulate the Optopatch construct in a spatially and temporally resolved manner. An arrangement of the DMD is shown in FIG. 19A. The configuration permits simultaneous spatially patterned illumination with blue light (488 nm) and imaging of fluorescence with red light (640 nm). Light from a blue laser reflects off a digital micromirror device (DMD). Each pixel of the DMD is separately addressable and can either direct the light toward the microscope or into a beam dump. A dichroic mirror combines the patterned illumination from the DMD with a beam from a red (640 nm) laser. A relay lens focuses both beams onto the back focal plane of the objective lens. The objective lens projects the image of the DMD onto the sample, while providing wide-field illumination with red light. Relay optics (not shown in FIG. 2a) projected a demagnified image of the DMD onto the sample. Each pixel of the DMD corresponded to 0.65 μm in the sample plane. Custom software mapped DMD coordinates to EMCCD camera coordinates, enabling precise optical targeting of any user-selected region of the sample.

In a typical experiment a user acquired an image of one or more neurons using wide-field illumination. The user selected one or more regions to stimulate, and specified a temporal profile of the stimulus. The excitation apparatus then delivered the stimulus in a pattern of blue illumination. The EMCCD camera recorded the ensuing near infrared fluorescence of Arch, at 500-2000 frames/s, depending on the desired tradeoff between pixel count and speed. Experimental runs consisted of 30-50 s of continuous recording with optical stimulation at 5-10 Hz. Several such runs could typically be conducted without an apparent change in action potential waveform, leading to data sets of 1,000-2,000 action potentials.

FIG. 19B shows results from a typical Optopatch experiment. The soma of a neuron was targeted with blue light (150 mW/cm², 10 ms). This elicited an action potential response. For one excitation event, the entire neuron (soma and processes) showed a spike in fluorescence which lasted 2-3 ms, indicating a single action potential response. The stimulus was repeated 400 times at 100 ms intervals. FIG. 19B shows the fluorescence response, averaged over 397 repetitions of the stimulus. The images in FIG. 19B are composites showing average Arch fluorescence (gray), changes in Arch fluorescence (δF/F heat map), and the optical stimulus (blue).

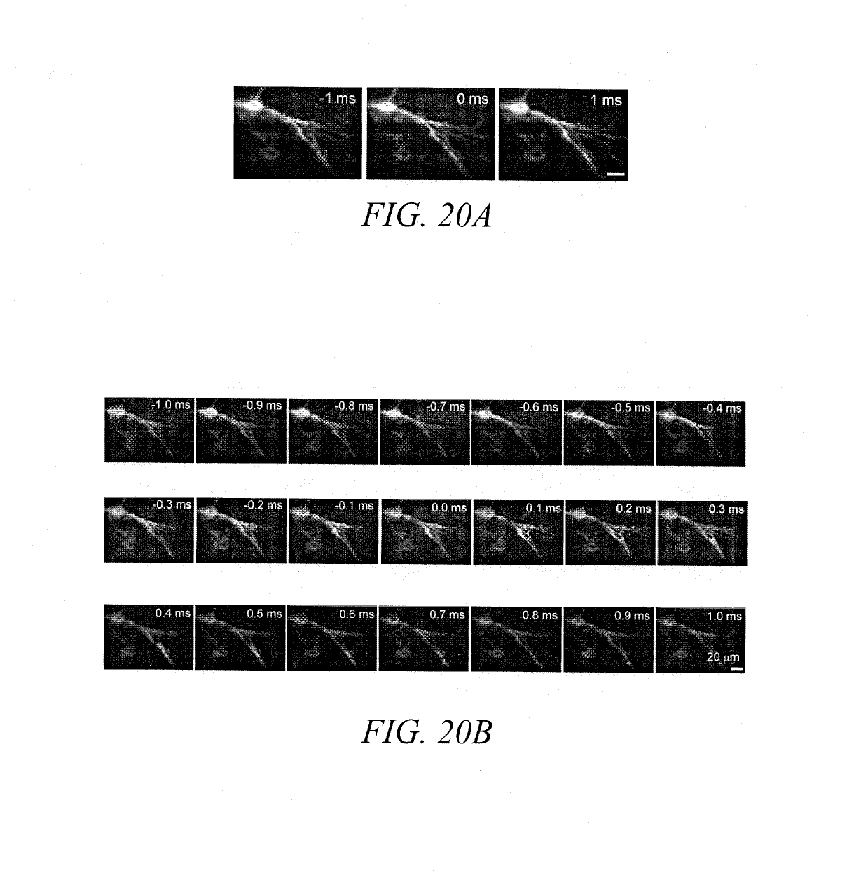

The Optopatch technique was combined with the temporal super-resolution technique described previously. The soma of a neuron expressing the Optopatch construct was targeted with optical stimulation, generating a series of action potentials. Fluorescence of Arch reported these action potentials, which were recorded on an EMCCD camera at about 1 ms/frame. FIG. 20A shows that the propagation of the action potential was not clearly resolved in the raw images, even though the camera was operated at its maximum frame rate of 1 ms/frame. FIG. 20B shows a series of super-resolution images of the action potential, calculated every 100 μs. While the propagation was not apparent in the raw data, the super-resolution procedure clearly indicated that the AP originated at the point of stimulation and propagated outward at nearly constant velocity.

### Methods

The following are various methods useful in the examples described above.

(1) Protein constructs and Membrane fractionation. All experiments were performed with an Arch-eGFP fusion. A lentiviral backbone plasmid encoding Arch-eGFP (FCK:Arch-EGFP) was a generous gift from Dr. Edward Boyden (MIT). The gene was cloned into pet28b vector using the restriction sites EcoRI and NcoI. The D95N mutation was created using the QuikChangeII kit (Agilent) using the forward primer (5′-TTATGCCAGGTACGCCAACTGGCTGTTTACCAC; SEQ ID NO: 48) and the reverse primer (5′-GTGGTAAACAGCCAGTTGGCGTACCTGGCATAA; SEQ ID NO: 49).

Arch and its D95N mutant were expressed in E. coli. Briefly, E. coli (strain BL21, pet28b plasmid) was grown in 1 L of LB with 100 micrograms/mL kanamycin, to an O.D 600 of 0.4 at 37° C. All-trans retinal (5 micromolar) and inducer (IPTG 0.5 mM) were added and cells were grown for an additional 3.5 hours in the dark. Cells were harvested by centrifugation and resuspended in 50 mM Tris, 2 mM MgCl₂ at pH 7.3 and lysed with a tip sonicator for 5 minutes. The lysate was centrifuged and the pellet was resuspended in PBS supplemented with 1.5% dodecyl maltoside (DM). The mixture was homogenized with a glass/Teflon Potter Elvehjem homogenizer and centrifuged again. The solubilized protein in the supernatant was used for experiments.

(2) Spectroscopic characterization of Arch WT and D95N. The absorption spectra of fractionated E. coli membranes containing Arch WT and D95N were determined using an Ocean Optics USB4000 spectrometer with a DT-MINI-2-GS light source (FIG. 8). The peak extinction coefficients of microbial rhodopsins vary across rhodopsin types from 48,000 to 63,000 M⁻¹ cm⁻¹. Due to the high homology between Arch and bacteriorhodopsin (BR), the BR extinction coefficient, 63,000 M⁻¹ cm⁻¹, was used for Arch. The differing wavelengths of maximum absorption of Arch WT (558 nm) and D95N (585 nm) led to significantly different extinction coefficients at 633 nm, as shown in Table 1. For Arch WT, 633 nm was in the tail of the absorption while for Arch D95N 633 nm lay halfway down the shoulder. The relative extinction coefficients of Arch WT and D95N at 633 nm was independent of the choice to use BR as the reference for the peak extinction coefficient. Absorption spectra for Arch WT and D95N were measured as a function of pH between pH 6 and 11.

The fluorescence emission spectra of Arch WT and D95N were determined using illumination with a 100 mW, 532 nm laser (Dragon Lasers, 532GLM100) or a 25 mW, 633 nm HeNe laser (Spectra-Physics) (FIG. 8). Scattered laser light was blocked with a 532 nm Raman notch filter (Omega Optical, XR03) or a 710/100 emission filter (Chroma), and fluorescence was collected perpendicular to the illumination with a 1000 micron fiber, which passed the light to an Ocean Optics QE65000 spectrometer. Spectra were integrated for 2 seconds. Arch WT and D95N both had emission maxima at 687 nm.

The fluorescence quantum yields of Arch WT and D95N were determined by comparing the integrated emission intensity to emission of a sample of the dye Alexa 647. Briefly, the concentrations of micromolar solutions of dye and protein were determined using a visible absorption spectrum. The extinction coefficients of 270,000 M⁻¹cm⁻¹ for Alexa 647 and 63,000 M⁻¹ cm⁻¹ for Arch WT and D95N were used, assuming that these microbial rhodopsins have the same extinction coefficient as bacteriorhodopsin. The dye solution was then diluted 1:1000 to yield a solution with comparable fluorescence emission to the Arch. The fluorescence emission spectra of dye and protein samples were measured with 633 nm excitation. The quantum yield was then determined by the formula

$${QY}_{Arch} = \frac{{Fl}_{Arch}}{{Fl}_{Alexa}} * \frac{{ɛ}_{Alexa}}{{ɛ}_{Arch}} * \frac{{c}_{Alexa}}{{c}_{Arch}} * {QY}_{Alexa}$$

where Fl is the integrated fluorescence from 660 to 760 nm, epsilon (∈) is the extinction coefficient at 633 nm and c is the concentration.

(3) Relative photostability of Arch and eGFP. To perform a direct comparison of photostability of Arch and eGFP the photobleaching of the Arch-eGFP fusion was studied. This strategy guaranteed a 1:1 stoichiometry of the two fluorophores, simplifying the analysis. The experiments were performed on permeabilized cells, in the microscope, with video recording as the cells photobleached. A movie of photobleaching of Arch was first recorded under 640 nm illumination; then on the same field of view photobleaching of eGFP under 488 nm illumination was recorded, with illumination intensity adjusted to yield approximately the same initial count rate as for Arch. Fluorescence background levels were obtained from nearby protein-free regions of each movie and were subtracted from the intensity of the protein-containing regions. The area under each photobleaching timetrace was calculated, yielding an estimate of the total number of detected photons from each fluorophore. The eGFP emission (lambda-max=509 nm) and the Arch emission (lambda-max=687 nm) were collected through different emission filters, so the raw counts were corrected for the transmission spectra of the filters and the wavelength-dependent quantum yield of the EMCCD camera. The result was that the relative number of photons emitted prior to photobleaching for eGFP:Arch WT was 3.9:1, and for eGFP:ArchD95N this ratio was 10:1.

(4) HEK cell culture. HEK-293 cells were grown at 37° C., 5% CO₂, in DMEM supplemented with 10% FBS and penicillin-streptomycin. Plasmids were transfected using Lipofectamine and PLUS reagent (Invitrogen) following the manufacturer's instructions, and assayed between 48-72 hours later. The day before recording, cells were re-plated onto glass-bottom dishes (MatTek) at a density of ˜5000 cells/cm².

The concentration of endogenous retinal in the HEK cells was not known, so the cells were supplemented with retinal by diluting stock retinal solutions (40 mM, DMSO) in growth medium to a final concentration of 5 micromolar, and then placing the cells back in the incubator for 1-3 hours. All imaging and electrophysiology were performed in Tyrode buffer (containing, in mM: 125 NaCl, 2 KCl, 3 CaCl₂, 1 MgCl₂, 10 HEPES, 30 glucose pH 7.3, and adjusted to 305-310 mOsm with sucrose). Only HEK cells having reversal potentials between −10 and −40 mV were included in the analysis.

(5) Microscopy. Simultaneous fluorescence and whole-cell patch clamp recordings were acquired on a home-built, inverted epifluorescence microscope, operated at room temperature. A detailed specification is given in FIG. 3A. One goal was to collect fluorescence with high efficiency, while also achieving a large enough field of view to image an entire neuron and its processes. Typically, microscope objectives offer a tradeoff between magnification and light-gathering capacity (numerical aperture). Additionally, the ability to change magnification while maintaining a patch on a single cell was important in some cases. Typically the vibrations associated with switching objectives—particularly water or oil immersion objectives—are incompatible with simultaneous patch clamp. In addition, in some cases, the capability to split the field of view into two wavelength bands, and to change magnification without changing the registration of the two halves of the image was important.

To achieve these goals simultaneously, a microscope was designed around a 60×NA 1.45 oil immersion objective (Olympus 1-U2B616 60× Oil NA 1.45), with variable zoom camera lenses to change illumination area and magnification. The magnification was continuously variable between 10× and 66×, without touching the objective. The microscope readily converted between single-band and dual-band imaging, with only minor realignment.

It was found that laser illumination and EMCCD detection were necessary for observing Arch fluorescence. On an upright electrophysiology setup retrofitted with a laser and EMCCD camera, a dipping objective (Olympus LUMPlanF1-40× W/IR; NA 0.8) collected enough light to record voltage-dependent fluorescence of HEK cells. However, recording of APs with high signal-to-noise ratio required a high NA objective (e.g. Olympus 1-U2B893 60× Water NA 1.2; or 1-U2B616 60× Oil NA 1.45).

(6) Electrophysiology. Filamented glass micropipettes (WPI) were pulled to a tip resistance of 3-10 megohm fire polished, and filled with internal solution (containing, in mM: 125 potassium gluconate, 8 NaCl, 0.6 MgCl₂, 0.1 CaCl₂, 1 EGTA, 10 HEPES, 4 Mg-ATP, 0.4 Na-GTP, pH 7.3; adjusted to 295 mOsm with sucrose). The micropipettes were positioned with a Burleigh PCS 5000 micromanipulator. Whole-cell, voltage clamp recordings were acquired using an AxoPatch 200B amplifier (Molecular Devices), filtered at 2 kHz with the internal Bessel filter, and digitized with a National Instruments PCIE-6323 acquisition board at 10 kHz. Ambient 60 Hz noise was removed using a HumBug Noise Eliminator (AutoMate Scientific). For experiments requiring rapid modulation of transmembrane potential, series resistance and whole-cell capacitance were predicted to 95% and corrected to ˜50%. Electrical stimuli were generated using the PCIE-6323 acquisition board and sent to the AxoPatch, which then applied these signals in either constant current or constant voltage mode.

Measurements of photocurrents were performed on HEK cells held in voltage clamp at 0 mV while being exposed to brief (200 ms) pulses of illumination at 640 nm at an intensity of 1800 W/cm².

All experiments were performed at room temperature.

(7) Ramp and step-response of Arch WT and D95N. To measure fluorescence as a function of membrane potential, a triangle wave was applied, with amplitude from −150 mV to +150 mV and period 12 s, with video recording at 100 ms per frame. A pixel weight matrix was calculated according to Eq. S2 (below) and applied to the movie images to generate a fluorescence number for each frame. These fluorescence values were divided by their minimum value (at V=−150 mV). The result is plotted as a function of V in FIGS. 11 and 14. This procedure preferentially weighted data from pixels at the cell membrane, but did not entail any background subtraction. Comparable results were obtained by manually selecting pixels corresponding to a region of plasma membrane, and plotting their intensity as a function of V, without background subtraction. Background subtraction from the raw fluorescence would have yielded considerably larger values of delta-F/F.

The step response was measured in a similar manner, except that test waveforms consisted of a series of voltage pulses, from −70 mV to +30 mV with duration 300 ms and period 1 s. Cells were subjected to 20 repetitions of the waveform, and the fluorescence response was averaged over all iterations.

(8) Frequency-dependent response functions of Arch WT and D95N. Test waveforms consisted of a concatenated series of sine waves, each of duration 2 s, amplitude 100 mV, zero mean, and frequencies uniformly spaced on a logarithmic scale between 1 Hz and 1 kHz (31 frequencies total). The waveforms were discretized at 10 kHz and applied to the cell, while fluorescence movies were acquired at a frame rate of 2 kHz.

The model parameters for extracting \hat{V}_{FL}(t) were calculated from the fluorescence response to low frequency voltages. These parameters were then used to calculate an estimated voltage at all frequencies.

The applied voltage was downsampled to 2 kHz to mimic the response of a voltage indicator with instantaneous response. For each applied frequency, the Fourier transform of \hat{V}_{FL}(t) was calculated and divided by the Fourier transform of the downsampled V(t). The amplitude of this ratio determined the response sensitivity. It was important in some cases to properly compensate pipette resistance and cell membrane capacitance to obtain accurate response spectra. Control experiments on cells expressing membrane-bound GFP showed little or no voltage-dependent fluo.

The power spectrum of \hat{V}_{FL}(t) under constant V=0 was also measured to enable calculations of signal-to-noise ratio for any applied V(t).

(9) Estimates of membrane potentials from fluorescence images. A common practice in characterizing fluorescent voltage indicators is to report a value of delta-F/F per 100 mV of membrane potential. However this was not used here. The value of delta-F/F in some cases is highly sensitive to the method of background subtraction, particularly for indicators in which F approaches zero at some voltage. Second, delta-F/F contains little or no information about signal-to-noise ratio, which depends on absolute fluorescence levels, background, and membrane targeting of the indicator. Third, the ratio delta-F/F contains little or no information about the temporal stability of the fluorescence. Fluctuations may arise due to intracellular transport, photobleaching, or other photophysics.

In these examples, a measure of the performance of a voltage indicator which reported the information content of the fluorescence signal was used, including an algorithm to infer membrane potential from a series of fluorescence images. The accuracy with which the estimated membrane potential matched the true membrane potential was used (as reported by patch clamp recording) as a measure of indicator performance.

The estimated membrane potential, \hat{V}_{FL}(t), was determined from the fluorescence in two steps. First a model was trained relating membrane potential to fluorescence at each pixel. A highly simplified model that the fluorescence signal, Sᵢ(t), at pixel i and time t, is given by:

Sᵢ(t)=aᵢ+bᵢV(t)+∈ᵢ(t), [S1]

where aᵢ and bᵢ are position-dependent but time-independent constants, the membrane potential V(t) is time-dependent but position independent, and ∈ᵢ(t) (epsilon) is spatially and temporally uncorrelated Gaussian white noise with pixel-dependent variance:

[symbol]

∈ᵢ(t₁)∈ⱼ(t₂) [symbol] =σᵢ²δ_{i|j}δ(t₁−t₂),

where indicates an average over time.

This model neglects nonlinearity in the fluorescence response to voltage, finite response time of the protein to a change in voltage, photobleaching, cell-motion or stage drift, and the fact that if ∈ᵢ(t) is dominated by shot-noise then its variance should be proportional to Si(t), and its distribution should be Poisson, not Gaussian. Despite these simplifications, the model of Eq. S1 provided good estimates of membrane potential when calibrated from the same dataset to which it was applied.

The pixel-specific parameters in Eq. 1 are determined by a least-squares procedure, as follows. Deviations from the mean fluorescence and mean voltage were defined by:

δV(t)=V(t)− [symbol] V(t) [symbol] .

Then the estimate for the slope \hat{b}ᵢ is:

$${\hat{b}}_{i} = \frac{〈 δ {S}_{i} δ V 〉}{{〈 δ V 〉}^{2}} ,$$

and the offset is:

aᵢ= [symbol] Sᵢ [symbol] −\hat{b}ᵢ [symbol] V [symbol] .

A pixel-by-pixel estimate of the voltage is formed from:

$${\hat{V}}_{i} ( t ) = \frac{{S}_{i} ( t )}{{\hat{b}}_{i}} - \frac{{\hat{a}}_{i}}{{\hat{b}}_{i}} .$$

The accuracy of this estimate is measured by

ζᵢ²= [symbol] \hat{V}ᵢ(t)−V(t))² [symbol] .

A maximum likelihood weight matrix is defined by:

$${w}_{i} ≡ \frac{1 / {ζ}_{i}^{2}}{{\sum }_{i} 1 / {ζ}_{i}^{2}} . \qquad [ S2 ]$$

This weight matrix favors pixels whose fluorescence is an accurate estimator of voltage in the training set.

To estimate the membrane potential, the pixel-by-pixel estimates are combined according to:

$${\hat{V}}_{FL} ( t ) = {\sum }_{i} {w}_{i} {\hat{V}}_{i} ( t ) \qquad [ S3 ]$$

Within the approximations underlying Eq. S1, Eq. S3 is the maximum likelihood estimate of V(t).

In cases where the membrane potential is not known, one can replace V(t) by the total intensity of the entire image I(t), provided that there is only a single cell with varying membrane potential within the image. In this case, the algorithm preferentially weights pixels whose intensity co-varies with the mean intensity. Such pixels are associated with the membrane. This modified procedure yields an estimate of the underlying intensity variations in the membrane. The output resembles the true membrane potential, apart from an unknown offset and scale factor. A key feature of this modified procedure is that it enables spike identification without a patch pipette.

On a video record of 30,000 frames taken (e.g., 30 s of data at 1,000 frames/s), the training phase of the algorithm took approximately 3 min to run on a desktop PC. Application of the weighting coefficients to incoming video data could be performed in close to real time.

(10) Molecular biology and virus production. Plasmids encoding Arch-EGFP (FCK:Arch-EGFP) were either used directly for experiments in HEK cells, or first used to produce VSVg-pseudotyped virus according to published methods. For pseudotyping, HEK-293 cells were co-transfected with pDelta 8.74, VSVg, and either of the Arch backbone plasmids using Lipofectamine and PLUS reagent (Invitrogen). Viral supernatants were collected 48 hours later and filtered using a 0.45 micrometer membrane. The virus medium was used to infect neurons without further concentration.

The D95N mutation was introduced using the QuickChange kit (Stratagene), according to the manufacturer's instructions using the same primers as the E. coli plasmid.

(11) Neuronal cell culture. E18 rat hippocampi were purchased from BrainBits and mechanically dissociated in the presence of 1 mg/mL papain (Worthington) before plating at 5,000 to 30,000 cells per dish on poly-L-lysine and Matrigel-coated (BD Biosciences) glass-bottom dishes. At this density synaptic inputs did not generate spontaneous firing. Cells were incubated in N+ medium (100 mL Neurobasal medium, 2 mL B27 supplement, 0.5 mM glutamine, 25 micromolar glutamate, penicillin-streptomycin) for 3 hours. An additional 300 microliter virus medium was added to the cells and incubated overnight, then brought to a final volume of 2 mL N+ medium. After two days, cells were fed with 1.5 mL N+ medium. Cells were fed with 1 mL N+ medium without glutamate at 4 DIV, and fed 1 mL every 3-4 days after. Cells were allowed to grow until 10-14 DIV. Cells were supplemented with retinal by diluting stock retinal solutions (40 mM, DMSO) in growth medium to a final concentration of 5 micromolar, and then placing the cells back in the incubator for 1 to 3 hours, after which they were used for experiments.

Whole-cell current clamp recordings were obtained from mature neurons under the same conditions used for HEK cells recordings. Series resistance and pipette capacitance were corrected. Only neurons having resting potentials between −50 and −70 mV were used in the analysis.

(12) Spike sorting. A spike identification algorithm was developed that could be applied either to electrically recorded V(t) or to optically determined \hat{V}_{FL}(t). The input trace was convolved with a reference spike. Sections of the convolved waveform that crossed a user-defined threshold were identified as putative spikes. Multiple spikes that fell within 10 ms (a consequence of noise-induced glitches near threshold) were clustered and identified as one.

What is claimed is:

1. A method for temporally resolving a time-varying image, the method comprising:
receiving, from a plurality of imaging pixels, a plurality of signal values associated with a plurality of measurement time bins during which the time-varying image was obtained; and
fitting, for at least some of the pixels, a pre-defined temporal waveform to the respective signal values received for each pixel.

2. The method of claim 1, wherein the fitting provides a temporal resolution finer than the smallest duration of any of the measurement time bins.

3. The method of any one of claim 1 or 2, wherein the time-varying image is obtained with a microscope.

4. The method of any one of claims 1-3, wherein the time-varying image is obtained with a fluorescence microscope.

5. The method of any one of claim 1 or 2, wherein the time-varying image is obtained with an X-ray imaging system.

6. The method of any one of claim 1 or 2, wherein the time-varying image is obtained with a magnetic resonance imaging system.

7. The method of any one of claims 1-6, wherein the time-varying image is obtained with a video recording system.

8. The method of any one of claims 1-7, wherein the plurality of signal values are obtained with a CCD imaging device.

9. The method of any one of claims 1-7, wherein the plurality of signal values are obtained with a MOSFET imaging array.

10. The method of any one of claims 1-7, wherein the plurality of signal values are obtained with an array of photomultipliers.

11. The method of any one of claims 1-7, wherein the plurality of signal values are obtained with an array of avalanche photodiodes.

12. The method of any one of claims 1-11, wherein the measurement time bins correspond to signal integration times for each respective imaging pixel.

13. The method of any one of claims 1-12, wherein the plurality of signal values are received as a series of frames, each frame comprising a plurality of signal values to form an image of a sample for one measurement time interval.

14. The method of any one of claims 1-13, wherein the pre-defined temporal waveform has a temporal resolution finer than an average value for the measurement time bins.

15. The method of any one of claims 1-14, wherein the pre-defined temporal waveform is a waveform representative of an action potential of a cell.

16. The method of any one of claims 1-14, wherein the pre-defined temporal waveform is a Gaussian waveform.

17. The method of any one of claims 1-14, wherein the pre-defined temporal waveform comprises an exponential portion.

18. The method of any one of claims 1-14, wherein the pre-defined temporal waveform is a lognormal waveform.

19. The method of any one of claims 1-18, further comprising:
determining, for each pixel, an occurrence in time of an event characterized by the waveform.

20. The method of claim 19, wherein the event corresponds to a specific characteristic in the waveform.

21. The method of any one of claim 19 or 20, wherein the event corresponds to a peak value.

22. The method of any one of claim 19 or 20, wherein the event corresponds to a minimum value.

23. The method of any one of claim 19 or 20, wherein the event corresponds to a pre-selected threshold value.

24. The method of any one of claims 19-23, further comprising:
suppressing, for each pixel, received signal values at time bins for which the event did not occur when displaying the time-varying image.

25. The method of claim 24, wherein the suppressing comprises reducing the signal values signal values at time bins for which the event did not occur to a zero value or background signal level value.

26. The method of any one of claims 19-25, further comprising:
generating, for each pixel, a plurality of additional signal values representative of time evolution of the time-varying image, the additional signal values corresponding to measurement intervals less than signal integration times for each pixel; and
displaying, in a time sequence, at least one of the additional signal values when displaying a temporally-resolved time-varying image of the time-varying image.

27. The method of claim 26, wherein each value of the additional signal values is representative of the pre-defined temporal waveform.

28. The method of any one of claim 26 or 27, wherein values of the additional signal values occurring at times other than occurrence of the event are suppressed to values less than values representative of the pre-defined temporal waveform.

29. An imaging system comprising:
an imaging array having a plurality of imaging pixels; and
a processor in communication with the imaging array, wherein the processor is configured to:
receive, from the plurality of imaging pixels, a plurality of signal values associated with a plurality of measurement time bins during which a time-varying image was obtained; and
fit, for each of the pixels, a pre-defined temporal waveform to the respective signal values received for each pixel.

30. A manufactured storage device comprising instructions that, when executed by a processor, adapt the processor to:
receive, from the plurality of imaging pixels, a plurality of signal values associated with a plurality of measurement time bins during which a time-varying image was obtained; and
fit, for each of the pixels, a pre-defined temporal waveform to the respective signal values received for each pixel.

31. An optical system, comprising:
an object region;
an objective lens having a numerical aperture greater than about 0.9 and located in an imaging optical path from the object region; and
a first zoom lens located in the imaging optical path.

32. The optical system of claim 31, wherein the optical system is configured for fluorescence microscopy.

33. The optical system of any one of claim 31 or 32, wherein the object region supports a biological sample.

34. The optical system of any one of claims 31-33, wherein the object region supports a living biological sample.

35. The optical system of any one of claims 31-34, wherein the object region supports a cell.

36. The optical system of any one of claims 31-35, wherein the object region is configured to support a patch clamp.

37. The optical system of any one of claims 31-36, wherein the object region comprises at least one microfluidic channel.

38. The optical system of any one of claims 31-37, wherein the objective lens is also in an illumination optical path.

39. The optical system of any one of claims 31-38, wherein the objective lens provides a magnification of more than about 20 times.

40. The optical system of any one of claims 31-39, wherein the objective lens provides a magnification of more than about 60 times.

41. The optical system of any one of claims 31-40, wherein the first zoom lens provides a focal length varying between about 18 mm and about 200 mm.

42. The optical system of any one of claims 31-41, wherein the first zoom lens provides an f-number between about 3 and about 7.

43. The optical system of any one of claims 31-42, wherein the objective lens is an immersion objective lens.

44. The optical system of any one of claims 31-43, wherein the objective lens is configured to provide total internal reflection illumination of a sample in the object region.

45. The optical system of any one of claims 31-44, wherein the objective lens is configured to provide slim-field glancing-incidence illumination of a sample in the object region.

46. The optical system of any one of claims 31-45, wherein the first zoom lens is configured to vary an image magnification at an imaging plane of the optical system of a sample in the object region without any adjustment to the objective lens.

47. The optical system of any one of claims 31-46, further comprising a relay optic disposed between the objective lens and the first zoom lens.

48. The optical system of claim 47, wherein the relay optic relays an image at the objective lens near an entrance pupil of the first zoom lens.

49. The optical system of any one of claims 47 or 48, wherein the relay optic comprises a first achromatic doublet and a second achromatic doublet spaced a distance apart.

50. The optical system of any one of claims 47-49, wherein the relay optic directs divergent radiation from the objective that would have been lost into the first zoom lens.

51. The optical system of any one of claims 31-50, further comprising a split, dichroic image-capture apparatus disposed in the imaging optical path after the first zoom lens.

52. The optical system of claim 51, wherein the image-capture apparatus includes an electron multiplying CCD camera.

53. The optical system of any one of claims 31-52, further comprising a second zoom lens located in an illumination path of the optical system.

54. The optical system of claim 53, wherein the second zoom lens is configured to vary an illumination area within the object region.

55. The optical system of any one of claims 53 or 54, further comprising:
a first radiation source providing a first radiation about a first wavelength; and
a second radiation source providing a second radiation about a second wavelength, wherein the first and second radiation are directed into the second zoom lens so as to illuminate the object region.

56. The optical system of claim 55, wherein the first radiation source comprises a broadband radiation source and an acousto-optic tunable filter.

57. The optical system of any one of claims 55 or 56, further comprising an adjustable mirror disposed in the illumination optical path configured to vary illumination in the object region between normal illumination, slim-field illumination, and total internal reflection illumination.

58. The optical system of any one of claims 55-57, further comprising a digital light mirror array disposed in the illuminating optical path and configured to impart a selected spatial pattern to the first radiation.

59. A method, comprising:
providing a sample comprising a voltage-indicating protein, and a light-sensitive moiety;
illuminating at least a portion of the sample with a first light having, at least, a first wavelength at an intensity that causes the light-sensitive moiety to increase ion transport therethrough; and
illuminating at least a portion of the sample with a second light having, at least, a second wavelength at an intensity that causes the voltage-indicating protein to fluoresce in a voltage-dependent manner.

60. The method of claim 59, wherein the light-sensitive moiety is a light-gated ion channel.

61. The method of claim 59, wherein the light-gated ion channel is a channelrhodopsin.

62. The method of any one of claims 59-61, wherein the sample further comprises a cell.

63. The method of claim 62, wherein the cell is a neuron.

64. The method of claim 63, further comprising illuminating only an axon of the neuron with the first wavelength.

65. The method of claim 63, further comprising illuminating only a dendrite of the neuron with the first wavelength.

66. The method of claim 63, further comprising illuminating only a soma of the neuron with the first wavelength.

67. The method of claim 62, wherein the cell is a cardiac cell.

68. The method of claim 62, wherein the voltage-indicating protein and the light-sensitive moiety are each contained within the cell.

69. The method of claim 62, wherein the voltage-indicating protein and the light-sensitive moiety are each present in the plasma membrane of the cell.

70. The method of any one of claims 59-69, further comprising determining at least one emission wavelength from the sample.

71. The method of claim 70, wherein the emission wavelength is compared to a reference indicative of membrane potential.

72. The method of any one of claim 70 or 71, further comprising acquiring at least one image of the sample using the at least one emission wavelength.

73. The method of claim 72, wherein the at least one image is acquired using an objective with a numerical aperture greater than about 0.9.

74. The method of any one of claim 72 or 873, comprising acquiring a plurality of images from the sample using the at least one emission wavelength.

75. The method of claim 74, wherein the plurality of images is acquired at a rate of at least 1 frame/1 ms.


SEQUENCE LISTING (49 sequences)

SEQ ID NO: 1 - protein, 18 aa, Artificial Sequence
  signaling sequence
MRGTPLLLVVSLFSLLQD

SEQ ID NO: 2 - protein, 7 aa, Artificial Sequence
  ER export motif
FCYENEV

SEQ ID NO: 3 - protein, 18 aa, Artificial Sequence
  Golgi export sequence
RSRFVKKDGHCNVQFINV

SEQ ID NO: 4 - protein, 20 aa, Artificial Sequence
  membrane localization sequence
KSRITSEGEYIPLDQIDINV

SEQ ID NO: 5 - DNA, 753 bp, Unknown
  source: /note=“Description of Unknown Green-absorbing proteorhodopsin polynucleotide from an uncultured marine bacterium”
accatgggtaaattattactgatattaggtagtgttattgcacttcctacatttgctgcaggtggtggtgaccttgatgctagtgattacactggtgtttctttttggttagttactgctgctctattagcatctactgtatttttctttgttgaaagagatagagtttctgcaaaatggaaaacatcattaactgtatctggtcttgttactggtattgctttctggcattacatgtacatgagaggggtatggattgagactggtgattcgccaactgtatttagatacattgattggttactaacagttcctctattgatatgtgaattctacttaattcttgctgctgcaacaaatgttgctgctggcctgtttaagaaattattggttggttctcttgttatgcttgtgtttggttacatgggtgaggcaggaattatgaacgcttggcctgcattcattattgggtgtttagcttgggtatacatgatttatgaactatatgctggagaaggaaaatctgcatgtaatactgcaagtccttcggttcaatcagcttacaacacaatgatggctatcatagtcttcggttgggcaatttatcctgtaggttatttcacaggttacctaatgggtgacggtggatcagctcttaacttaaaccttatttataaccttgctgactttgttaacaagattctatttggtttaattatatggaatgttgctgttaaagaatcttctaatgct

SEQ ID NO: 6 - protein, 251 aa, Unknown
  source: /note=“Description of Unknown Green-absorbing proteorhodopsin polypeptide from an uncultured marine bacterium”
TMGKLLLILGSVIALPTFAAGGGDLDASDYTGVSFWLVTAALLASTVFFFVERDRVSAKWKTSLTVSGLVTGIAFWHYMYMRGVWIETGDSPTVFRYIDWLLTVPLLICEFYLILAAATNVAAGLFKKLLVGSLVMLVFGYMGEAGIMNAWPAFIIGCLAWVYMIYELYAGEGKSACNTASPSVQSAYNTMMAIIVFGWAIYPVGYFTGYLMGDGGSALNLNLIYNLADFVNKILFGLIIWNVAVKESSNA

SEQ ID NO: 7 - protein, 251 aa, Artificial Sequence
  source: /note=“Description of Artificial Sequence Synthetic polypeptide”
TMGKLLLILGSVIALPTFAAGGGDLDASDYTGVSFWLVTAALLASTVFFFVERDRVSAKWKTSLTVSGLVTGIAFWHYMYMRGVWIETGDSPTVFRYINWLLTVPLLICEFYLILAAATNVAAGLFKKLLVGSLVMLVFGYMGEAGIMNAWPAFIIGCLAWVYMIYELYAGEGKSACNTASPSVQSAYNTMMAIIVFGWAIYPVGYFTGYLMGDGGSALNLNLIYNLADFVNKILFGLIIWNVAVKESSNA

SEQ ID NO: 8 - DNA, 756 bp, Unknown
  source: /note=“Description of Unknown Blue-absorbing proteorhodopsin polynucleotide from an uncultured marine bacterium”
accatgggtaaattattactgatattaggtagtgctattgcacttccatcatttgctgctgctggtggcgatctagatataagtgatactgttggtgtttcattctggctggttacagctggtatgttagcggcaactgtgttcttttttgtagaaagagaccaagtcagcgctaagtggaaaacttcacttactgtatctggtttaattactggtatagctttttggcattatctctatatgagaggtgtttggatagacactggtgataccccaacagtattcagatatattgattggttattaactgttccattacaagtggttgagttctatctaattcttgctgcttgtacaagtgttgctgcttcattatttaagaagcttctagctggttcattagtaatgttaggtgctggatttgcaggcgaagctggattagctcctgtattacctgctttcattattggtatggctggatggttatacatgatttatgagctatatatgggtgaaggtaaggctgctgtaagtactgcaagtcctgctgttaactctgcatacaacgcaatgatgatgattattgttgttggatgggcaatttatcctgctggatatgctgctggttacctaatgggtggcgaaggtgtatacgcttcaaacttaaaccttatatataaccttgctgactttgttaacaagattctatttggtttgatcatttggaatgttgctgttaaagaatcttctaatgct

SEQ ID NO: 9 - protein, 252 aa, Unknown
  source: /note=“Description of Unknown Blue-absorbing proteorhodopsin polypeptide from an uncultured marine bacterium”
TMGKLLLILGSAIALPSFAAAGGDLDISDTVGVSFWLVTAGMLAATVFFFVERDQVSAKWKTSLTVSGLITGIAFWHYLYMRGVWIDTGDTPTVFRYIDWLLTVPLQVVEFYLILAACTSVAASLFKKLLAGSLVMLGAGFAGEAGLAPVLPAFIIGMAGWLYMIYELYMGEGKAAVSTASPAVNSAYNAMMMIIVVGWAIYPAGYAAGYLMGGEGVYASNLNLIYNLADFVNKILFGLIIWNVAVKESSNA

SEQ ID NO: 10 - protein, 252 aa, Artificial Sequence
  source: /note=“Description of Artificial Sequence Synthetic polypeptide”
TMGKLLLILGSAIALPSFAAAGGDLDISDTVGVSFWLVTAGMLAATVFFFVERDQVSAKWKTSLTVSGLITGIAFWHYLYMRGVWIDTGDTPTVFRYINWLLTVPLQVVEFYLILAACTSVAASLFKKLLAGSLVMLGAGFAGEAGLAPVLPAFIIGMAGWLYMIYELYMGEGKAAVSTASPAVNSAYNAMMMIIVVGWAIYPAGYAAGYLMGGEGVYASNLNLIYNLADFVNKILFGLIIWNVAVKESSNA

SEQ ID NO: 11 - DNA, 3058 bp, Natronomonas pharaonis
gtcgacgagtacgccggttccctgccacttgcgggcatctgtctcggccagcaggtcatcgccaacgccctcggcggcgagaccgaaaagatggagttcggccaccgcggcgttaaccaaccggtcatggacctccggaccgaaaaggtcgtcatgacgacccagaaccacggctacaccgtctccgaaccgggcgagcttgatgtcacgcaggtcaacgtcaacgacgagacgcccgaaggtcgaaagcgacgaactcgatgtcatcacccgccagtaccaccccgaagccaaccccggtccccacgacaccctcgggttcttcgacgacgttctcggaatggtcgaggagccggcggcaacccagtagcgccacgggatatctgcttggtaccttttcacaagaaaaagagcttattagcgctttctacctatagattgcggtcgtttcgctccggcgattcggtttcgggtttttatgtgcagtcgcgtcaataacaccctatgtcgctgaacgtatcacggctccttctccccagccgtgtccggcacagttatacggggaagatgggtgccgttttcatcttcgtcggcgcgttgacggtgctttttggtgccatcgcgtacggtgaggtaaccgccgccgccgcgaccggtgatgccgcagccgtacaggaggcggcagtatcggccattctcgggctcatcatcctgctcgggatcaacctcggactcgttgctgccacgctgggcggtgacaccgccgcctcgctttcaacgctggccgcgaaggcctcgcggatgggcgacggcgacctcgatgtcgagcttgagacccgtcgcgaggacgaaatcggcgacctctatgcggccttcgacgagatgcgccaatcggtgcggacatcgctggaggacgccaagaacgctcgcgaggacgcagagcaggcacaaaagcgggcagaggagatcaacacggaactacaggccgaagccgagcgcttcggcgaggtgatggaccgctgtgccgacggcgactttacccagcggctcgacgccgaaacggacaacgaagcaatgcagtccatcgaggggtcatttaacgagatgatggacggcatcgaggcgcttgtcgggcgcatcgagcgcttcgccgacgcggtctccgaggacgcagaggccgtccgtgcgaacgccgaatcggtcatggaggccagcgaggacgtaaaccgcgccgtacagaacatctctgatgcagccggcgaccagaccgaaaccgtccagcagatcgcactggagatggacgacgtctcggcgacgaccgaagaggtcgccgccagcgccgacgacatcgccaagacggctcggcaggccgccgaaacgggcgaagccgggcgggagaccgccgagacggccatcaccgagatgaacgaggtcgagtcgaggaccgaacaggcagtcgcgtcgatggaagagctcaacgaagacgtccgcgaaatcggcgaggtatccgagatgattgcggatatcgccgagcagacgaacatcctcgcgctgaacgcctctatcgaggcagcacgggcggacggcaacagcgagggcttcgcggtcgtcgccgacgaggtcaaggcgctcgccgaggagacgaaggcggcgaccgaggaaatcgacgacctcatcgggaccgtccaggacagaacacagacaacggtcgacgacatccgcgagacaagcgaccaagtttcggagggcgtcgagacggtcgaagataccgtcgacgctctcgaacgtattgtcgacagcgtcgagcggaccaacgacgggattcaagagatcaaccagtcgacagacgcacaggctgacgccgcacagaaggcaacaacgatggtcgaagatatggctgcgacatccgaacagactgcaagcgacgccgagacggccgcggaaacgacggagacacaggccgagtctgtcaaagaggtcttcgacctcatcgatggtctttccgagcaggccgactcactcagcgaaacgctcagtcggaccgacaccgaagaggcgtcagcggccgaccttgatgaccagccgacgctcgcggcgggggatgattaacgatggtgggacttacgaccctcttttggctcggcgcaatcggcatgctcgtcggcacgctcgcgttcgcgtgggccggccgtgacgccggaagcggcgagcgacggtactacgtgacgcttgtcggcatcagtggtatcgcagcagtcgcctacgtcgtcatggcgctgggcgtcggctgggttcccgtggccgaacggactgtttttgccccccggtacattgactggattctcacaaccccgctcatcgtctacttcctcgggctgcttgcggggcttgatagtcgggagttcggcatcgtcatcacgctcaacaccgtggtcatgctcgccggcttcgccggggcgatggtgcccggtatcgagcgctacgcgctgttcggcatgggggcggtcgcattcctcggactggtctactacctcgtcgggccgatgaccgaaagtgccagccagcggtcctccggaatcaagtcgctgtacgtccgcctccgaaacctgacggtcatcctctgggcgatttatccgttcatctggctgcttggaccgccgggcgtggcgctgctgacaccgactgtcgacgtggcgcttatcgtctaccttgacctcgtcacgaaggtcggattcggcttcatcgcactcgatgctgcggcgacacttcgggccgaacacggcgaatcgctcgctggcgtcgatactgacgcgcctgcggtcgccgactaaaaagcgcctgtttttccgcgaacgtcccgtcgttattctacgtagcggtactgccgttcgcccattcgcccccagccgtcgaagacgaactccgagtcaggggccgtgaactcctcgacggccgtctcctcgtcgtagttgtgggcgtcgtggacgtcctcgtactcctcgaaatcgaggtcgtagcgcgattcgagctgctcgtcgatgttcagcgcatcgagctc

SEQ ID NO: 12 - protein, 239 aa, Natronomonas pharaonis
MVGLTTLFWLGAIGMLVGTLAFAWAGRDAGSGERRYYVTLVGISGIAAVAYVVMALGVGWVPVAERTVFAPRYIDWILTTPLIVYFLGLLAGLDSREFGIVITLNTVVMLAGFAGAMVPGIERYALFGMGAVAFLGLVYYLVGPMTESASQRSSGIKSLYVRLRNLTVILWAIYPFIWLLGPPGVALLTPTVDVALIVYLDLVTKVGFGFIALDAAATLRAEHGESLAGVDTDAPAVAD

SEQ ID NO: 13 - protein, 239 aa, Artificial Sequence
  source: /note=“Description of Artificial Sequence Synthetic polypeptide”
MVGLTTLFWLGAIGMLVGTLAFAWAGRDAGSGERRYYVTLVGISGIAAVAYVVMALGVGWVPVAERTVFAPRYINWILTTPLIVYFLGLLAGLDSREFGIVITLNTVVMLAGFAGAMVPGIERYALFGMGAVAFLGLVYYLVGPMTESASQRSSGIKSLYVRLRNLTVILWAIYPFIWLLGPPGVALLTPTVDVALIVYLDLVTKVGFGFIALDAAATLRAEHGESLAGVDTDAPAVAD

SEQ ID NO: 14 - DNA, 1229 bp, Halobacterium salinarum
gggtgcaaccgtgaagtccgccacgaccgcgtcacgacaggagccgaccagcgacacccagaaggtgcgaacggttgagtgccgcaacgatcacgagtttttcgtgcgcttcgagtggtaacacgcgtgcacgcatcgacttcaccgcgggtgtttcgacgccagccggccgttgaaccagcaggcagcgggcatttacagccgctgtggcccaaatggtggggtgcgctattttggtatggtttggaatccgcgtgtcggctccgtgtctgacggttcatcggttctaaattccgtcacgagcgtaccatactgattgggtcgtagagttacacacatatcctcgttaggtactgttgcatgttggagttattgccaacagcagtggagggggtatcgcaggcccagatcaccggacgtccggagtggatctggctagcgctcggtacggcgctaatgggactcgggacgctctatttcctcgtgaaagggatgggcgtctcggacccagatgcaaagaaattctacgccatcacgacgctcgtcccagccatcgcgttcacgatgtacctctcgatgctgctggggtatggcctcacaatggtaccgttcggtggggagcagaaccccatctactgggcgcggtacgctgactggctgttcaccacgccgctgttgttgttagacctcgcgttgctcgttgacgcggatcagggaacgatccttgcgctcgtcggtgccgacggcatcatgatcgggaccggcctggtcggcgcactgacgaaggtctactcgtaccgcttcgtgtggtgggcgatcagcaccgcagcgatgctgtacatcctgtacgtgctgttcttcgggttcacctcgaaggccgaaagcatgcgccccgaggtcgcatccacgttcaaagtactgcgtaacgttaccgttgtgttgtggtccgcgtatcccgtcgtgtggctgatcggcagcgaaggtgcgggaatcgtgccgctgaacatcgagacgctgctgttcatggtgcttgacgtgagcgcgaaggtcggcttcgggctcatcctcctgcgcagtcgtgcgatcttcggcgaagccgaagcgccggagccgtccgccggcgacggcgcggccgcgaccagcgactgatcgcacacgcaggacagccccacaaccggcgcggctgtgttcaacgacacacgatgagtcccccactcggtcttgtactc

SEQ ID NO: 15 - protein, 262 aa, Halobacterium salinarum
MLELLPTAVEGVSQAQITGRPEWIWLALGTALMGLGTLYFLVKGMGVSDPDAKKFYAITTLVPAIAFTMYLSMLLGYGLTMVPFGGEQNPIYWARYADWLFTTPLLLLDLALLVDADQGTILALVGADGIMIGTGLVGALTKVYSYRFVWWAISTAAMLYILYVLFFGFTSKAESMRPEVASTFKVLRNVTVVLWSAYPVVWLIGSEGAGIVPLNIETLLFMVLDVSAKVGFGLILLRSRAIFGEAEAPEPSAGDGAAATSD

SEQ ID NO: 16 - protein, 262 aa, Artificial Sequence
  source: /note=“Description of Artificial Sequence Synthetic polypeptide”
MLELLPTAVEGVSQAQITGRPEWIWLALGTALMGLGTLYFLVKGMGVSDPDAKKFYAITTLVPAIAFTMYLSMLLGYGLTMVPFGGEQNPIYWARYANWLFTTPLLLLDLALLVDADQGTILALVGADGIMIGTGLVGALTKVYSYRFVWWAISTAAMLYILYVLFFGFTSKAESMRPEVASTFKVLRNVTVVLWSAYPVVWLIGSEGAGIVPLNIETLLFMVLDVSAKVGFGLILLRSRAIFGEAEAPEPSAGDGAAATSD

SEQ ID NO: 17 - protein, 258 aa, Halobacterium salinarum
MDPIALQAGYDLLGDGRPETLWLGIGTLLMLIGTFYFLVRGWGVTDKDAREYYAVTILVPGIASAAYLSMFFGIGLTEVTVGGEMLDIYYARYADWLFTTPLLLLDLALLAKVDRVTIGTLVGVDALMIVTGLIGALSHTAIARYSWWLFSTICMIVVLYFLATSLRSAAKERGPEVASTFNTLTALVLVLWTAYPILWIIGTEGAGVVGLGIETLLFMVLDVTAKVGFGFILLRSRAILGDTEAPEPSAGADVSAAD

SEQ ID NO: 18 - protein, 258 aa, Artificial Sequence
  source: /note=“Description of Artificial Sequence Synthetic polypeptide”
MDPIALQAGYDLLGDGRPETLWLGIGTLLMLIGTFYFLVRGWGVTDKDAREYYAVTILVPGIASAAYLSMFFGIGLTEVTVGGEMLDIYYARYANWLFTTPLLLLDLALLAKVDRVTIGTLVGVDALMIVTGLIGALSHTAIARYSWWLFSTICMIVVLYFLATSLRSAAKERGPEVASTFNTLTALVLVLWTAYPILWIIGTEGAGVVGLGIETLLFMVLDVTAKVGFGFILLRSRAILGDTEAPEPSAGADVSAAD

SEQ ID NO: 19 - protein, 313 aa, Leptosphaeria maculans
MIVDQFEEVLMKTSQLFPLPTATQSAQPTHVAPVPTVLPDTPIYETVGDSGSKTLWVVFVLMLIASAAFTALSWKIPVNRRLYHVITTIITLTAALSYFAMATGHGVALNKIVIRTQHDHVPDTYETVYRQVYYARYIDWAITTPLLLLDLGLLAGMSGAHIFMAIVADLIMVLTGLFAAFGSEGTPQKWGWYTIACIAYIFVVWHLVLNGGANARVKGEKLRSFFVAIGAYTLILWTAYPIVWGLADGARKIGVDGEIIAYAVLDVLAKGVFGAWLLVTHANLRESDVELNGFWANGLNREGAIRIGEDDGA

SEQ ID NO: 20 - protein, 313 aa, Artificial Sequence
  Description of Artificial Sequence Synthetic polypeptide
MIVDQFEEVLMKTSQLFPLPTATQSAQPTHVAPVPTVLPDTPIYETVGDSGSKTLWVVFVLMLIASAAFTALSWKIPVNRRLYHVITTIITLTAALSYFAMATGHGVALNKIVIRTQHDHVPDTYETVYRQVYYARYINWAITTPLLLLDLGLLAGMSGAHIFMAIVADLIMVLTGLFAAFGSEGTPQKWGWYTIACIAYIFVVWHLVLNGGANARVKGEKLRSFFVAIGAYTLILWTAYPIVWGLADGARKIGVDGEIIAYAVLDVLAKGVFGAWLLVTHANLRESDVELNGFWANGLNREGAIRIGEDDGA

SEQ ID NO: 21 - protein, 250 aa, Haloarcula argentinensis
MPEPGSEAIWLWLGTAGMFLGMLYFIARGWGETDSRRQKFYIATILITAIAFVNYLAMALGFGLTIVEFAGEEHPIYWARYSDWLFTTPLLLYDLGLLAGADRNTITSLVSLDVLMIGTGLVATLSPGSGVLSAGAERLVWWGISTAFLLVLLYFLFSSLSGRVADLPSDTRSTFKTLRNLVTVVWLVYPVWWLIGTEGIGLVGIGIETAGFMVIDLTAKVGFGIILLRSHGVLDGAAETTGTGATPADD

SEQ ID NO: 22 - protein, 250 aa, Artificial Sequence
  Description of Artificial Sequence Synthetic polypeptide
MPEPGSEAIWLWLGTAGMFLGMLYFIARGWGETDSRRQKFYIATILITAIAFVNYLAMALGFGLTIVEFAGEEHPIYWARYSNWLFTTPLLLYDLGLLAGADRNTITSLVSLDVLMIGTGLVATLSPGSGVLSAGAERLVWWGISTAFLLVLLYFLFSSLSGRVADLPSDTRSTFKTLRNLVTVVWLVYPVWWLIGTEGIGLVGIGIETAGFMVIDLTAKVGFGIILLRSHGVLDGAAETTGTGATPADD

SEQ ID NO: 23 - protein, 279 aa, Acetabularia acetabulum
MSNPNPFQTTLGTDAQWVVFAVMALAAIVFSIAVQFRPLPLRLTYYVNIAICTIAATAYYAMAVNGGDNKPTAGTGADERQVIYARYIDWVFTTPLLLLDLVLLTNMPATMIAWIMGADIAMIAFGIIGAFTVGSYKWFYFVVGCIMLAVLAWGMINPIFKEELQKHKEYTGAYTTLLIYLIVLWVIYPIVWGLGAGGHIIGVDVEIIAMGVLDLLAKPLYAIGVLITVEVVYGKVGQGGSLAFDCLKILKWWKLLWFQLVSIHFSLCVCRVTSYFLLN

SEQ ID NO: 24 - protein, 279 aa, Artificial Sequence
  Description of Artificial Sequence Synthetic polypeptide
MSNPNPFQTTLGTDAQWVVFAVMALAAIVFSIAVQFRPLPLRLTYYVNIAICTIAATAYYAMAVNGGDNKPTAGTGADERQVIYARYINWVFTTPLLLLDLVLLTNMPATMIAWIMGADIAMIAFGIIGAFTVGSYKWFYFVVGCIMLAVLAWGMINPIFKEELQKHKEYTGAYTTLLIYLIVLWVIYPIVWGLGAGGHIIGVDVEIIAMGVLDLLAKPLYAIGVLITVEVVYGKVGQGGSLAFDCLKILKWWKLLWFQLVSIHFSLCVCRVTSYFLLN

SEQ ID NO: 25 - protein, 260 aa, Halobacterium sp.
MDPIALTAAVGADLLGDGRPETLWLGIGTLLMLIGTFYFIVKGWGVTDKEAREYYSITILVPGIASAAYLSMFFGIGLTEVQVGSEMLDIYYARYADWLFTTPLLLLDLALLAKVDRVSIGTLVGVDALMIVTGLVGALSHTPLARYTWWLFSTICMIVVLYFLATSLRAAAKERGPEVASTFNTLTALVLVLWTAYPILWIIGTEGAGVVGLGIETLLFMVLDVTAKVGFGFILLRSRAILGDTEAPEPSAGAEASAAD

SEQ ID NO: 26 - protein, 260 aa, Artificial Sequence
  Description of Artificial Sequence Synthetic polypeptide
MDPIALTAAVGADLLGDGRPETLWLGIGTLLMLIGTFYFIVKGWGVTDKEAREYYSITILVPGIASAAYLSMFFGIGLTEVQVGSEMLDIYYARYANWLFTTPLLLLDLALLAKVDRVSIGTLVGVDALMIVTGLVGALSHTPLARYTWWLFSTICMIVVLYFLATSLRAAAKERGPEVASTFNTLTALVLVLWTAYPILWIIGTEGAGVVGLGIETLLFMVLDVTAKVGFGFILLRSRAILGDTEAPEPSAGAEASAAD

SEQ ID NO: 27 - protein, 259 aa, Halobacterium sp.
MDPIALQAGFDLLNDGRPETLWLGIGTLLMLIGTFYFIARGWGVTDKEAREYYAITILVPGIASAAYLAMFFGIGVTEVELASGTVLDIYYARYADWLFTTPLLLLDLALLAKVDRVTIGTLIGVDALMIVTGLIGALSKTPLARYTWWLFSTIAFLFVLYYLLTSLRSAAAKRSEEVRSTFNTLTALVAVLWTAYPILWIVGTEGAGVVGLGIETLAFMVLDVTAKVGFGFVLLRSRAILGETEAPEPSAGADASAAD

SEQ ID NO: 28 - protein, 259 aa, Artificial Sequence
  Description of Artificial Sequence Synthetic polypeptide
MDPIALQAGFDLLNDGRPETLWLGIGTLLMLIGTFYFIARGWGVTDKEAREYYAITILVPGIASAAYLAMFFGIGVTEVELASGTVLDIYYARYANWLFTTPLLLLDLALLAKVDRVTIGTLIGVDALMIVTGLIGALSKTPLARYTWWLFSTIAFLFVLYYLLTSLRSAAAKRSEEVRSTFNTLTALVAVLWTAYPILWIVGTEGAGVVGLGIETLAFMVLDVTAKVGFGFVLLRSRAILGETEAPEPSAGADASAAD

SEQ ID NO: 29 - protein, 258 aa, Halorubrum sodomense; identical to SEQ ID NO: 17

SEQ ID NO: 30 - protein, 258 aa, Artificial Sequence; identical to SEQ ID NO: 18
  Description of Artificial Sequence Synthetic polypeptide

SEQ ID NO: 31 - protein, 255 aa, Halobacterium salinarum
MGMDPIALQAGFDLLGDGRPETLWLGIGTLLMIIGTFYFIAQGWGVTDKEAREYYAITILVPGIASAAYLAMFFGIGVTEVELASGAVLDIYYARYADWLFTTPLLLLDLALLAKVDRVSIGTLIGVDALMIVTGLIGALSKTPLARYTWWLFSTIAFLFVLYYLLTSLRSAAAQRSEEVQSTFNTLTALVAVLWTAYPILWIVGTEGAGVVGLGVETLAFMVLDVTAKVGFGFALLRSRAILGETEAPEPSAGT

SEQ ID NO: 32 - protein, 255 aa, Artificial Sequence
  Description of Artificial Sequence Synthetic polypeptide
MGMDPIALQAGFDLLGDGRPETLWLGIGTLLMIIGTFYFIAQGWGVTDKEAREYYAITILVPGIASAAYLAMFFGIGVTEVELASGAVLDIYYARYANWLFTTPLLLLDLALLAKVDRVSIGTLIGVDALMIVTGLIGALSKTPLARYTWWLFSTIAFLFVLYYLLTSLRSAAAQRSEEVQSTFNTLTALVAVLWTAYPILWIVGTEGAGVVGLGVETLAFMVLDVTAKVGFGFALLRSRAILGETEAPEPSAGT

SEQ ID NO: 33 - DNA, 655 bp, Artificial Sequence
  source: /note=“Description of Artificial Sequence Synthetic polynucleotide”
cgatgtacgggccagatatacgcgttgacattgattattgactagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggactatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagagctctctggctaactagagaacccactgcttactggcttatcgaaatt

SEQ ID NO: 34 - DNA, 419 bp, Artificial Sequence
  source: /note=“Description of Artificial Sequence Synthetic polynucleotide”
cggagtactgtcctccgggctggcggagtactgtcctccggcaaggtcggagtactgtcctccgacactagaggtcggagtactgtcctccgacgcaaggcggagtactgtcctccgggctgcggagtactgtcctccggcaaggtcggagtactgtcctccgacactagaggtcggagtactgtcctccgacgcaaggtcggagtactgtcctccgacactagaggtcggagtactgtcctccgacgcaaggtcggagtactgtcctccgacactagaggtcggagtactgtcctccgacgcaaggcggagtactgtcctccgggctggcggagtactgtcctccggcaagggtcgactctagagggtatataatggatcccatcgcgtctcagcctcactttgagctcctccacacg

SEQ ID NO: 35 - DNA, 8703 bp, Artificial Sequence
  source: /note=“Description of Artificial Sequence Synthetic polynucleotide”
ctattcctaaagaccttgggtgaccaaaatcttattttaataaataaaactgtttattaaaacttttttgtttcaaagaaccatatgtatagtgaaatttataaaaatatcaatttttaaaaagctggtgtactcatttatgttatgaactctaaaaccatatactgactgcaagtgatgatgtatagagtgatgtttacgagtaaacatatttagttgtatacatcctactgagcacattttgatgtatgaaataacattacaagctttatccaaattaagccattttaaaacactgccaattgaaaatacaaatcctggaaaaaatcgtctttagcgcagtcatttgagccatcctaatccgttacctcagaccataataagaagggataacactagctgtagcaatggaacacatctgtttcacacaatcatatctcctgcgccggtgctaagcagattcagcgtgatcataacatgctttccactcataaatgtaaatttacaatttgcacatgtaaaacagacacttttgagatattggataaaaaaacaagagtatattgcttagtttcatccaccagtcatccccacagcgtttggaaggccataaaaagtgtctaaaatcaatgatcattgaaagagcacaagagagactcttacgctgtaatgccactggggacaaaagtgacagtctcttaatgggctcttctggaggggctcctgaacattaaaaattatcagcgaaattaccgaaagagcttcaagcaactggcatgcttgatcctctgcgtcggggcggtgaataggtgcttcagatgccctcttacccacgggctggattcagctgccccgctaccagcggagaccccctaatgagcctctgcaattaagtttattcatgttaagtgtgaacggggtgcgtgcggaactgtgggcagctaacagacctgggttctttgtgccacaagtgctgcctttattcggctcacaaagcagaaaacaacacccgcacctataatggcgccctcggctgggtctaagaaacgtggcgagttgacagagcagagtgggcggggttaagacagactgacagcgggacccatctccatcctcttattaacgcttaacgagtgccttcctcatgcaatattcatcgccactaatatcatccaagctctgagctgagctggccacttatgtaaggcaattatgtaaaatatcagacagggcccacactcagaatctgactggggtagagacgcgggacgagaaccgagagcaagaactgaaagtgaaagtgaccactaaagggaggagaggacagaggggcaggatgtgtcaagattaccagagaacacttggccagaaatgcgcaaccattggagctctccggattacccaaaggttaacgagtttgaacgcctctgcccactcgcccatctctgatggtttcccaagaactcctcaagcaaaatatatataattgtgtgtattatgcacagacacgagaaaatgctgtttttctgatctgcattacagcacatttgcccgccaacgacaataccacccactcggtacctcgctgactcctgatgcctgatacctgcgcggtgactgtctacaatctgcataatcaagagaagttgtgttgaagacgagcgccacacaaccgtttccacaaggtcacccaaggccggtgcagatgtaggtgaggtctccataaacagactgaaataaacacatcctccgctgggaacaacaaccccctcacgcctcatgcatttccataagcctacatgcatctcttccaacttatggagactcgcacctaccaacatccgcacaacaaagatatacagagcgcgctccctcaggtcaaggccctgtgggggtctgtgcagaaataggtcatttgtcacacatcaagtcctggggcaggagatgcattatagatgagaccaaacagcctgtctcggtgagctctacccactccctgagactagaaatgggggaagggagcttgagataacaaccgctgcaatcactgtgtcgatgtttaatatcagcaccaaccgggaacaataaggagatgggtgcattcatgttcacatcttaccagtcaagtatcatcgaaccggcttgataaccacacctcgtgtaatagctgagcagatagttgtcattttaaagcgttggcctttgtcgattatgtaatgcgcacattcaacacatggtaatatagaaacggttatgtcgaggttgttttgtccagagatgaccttcacacagttacagccgctctgcatccacacaaatggaggacttaatcgtggactgcattcttagaaatgatctacaaagacaaataatgtgaaatcaagaaaggacaaaatttaagtaaggggatgagggagagagagaacgaggggcaaggagaaagcatggctcctgtctttttctgcacccatctgttcggagtgcaggtggagctctattcactcagctctgcatgtgtgtttggggggggcaggaagaaagggagggcaaaaggaagagtggagagatggtgggggctggagggatggggggttctcggtgatctctcctgaaggggataatgggagagcagcgctttgcaatggctgccatgtagtaccctccctgcacaattagccaatcagcagcaagctctgccagccagaaggacacataaaagaagaacattgcagcagaggcacagaaggagcctgcgaggagctgggaaatacacacacaacagcagaaccacaacaccctcccctggacacaccctactggggatcactgcttttctttttttctgaaccatcgcccacgccacacggagagaaatctctctctcatcatcatcctgaagaaaacccccttatcctcattttcacactgctgaggaaaacctacaatcgcacgggctgagatttcctggcgaagactgtcctttttcctttttctttttttttcttttcctttggaaactgacatttgcatttctccattccaagccacggcgtaataatatctgcaatccagcctgaagacctgcaaatcgaaggacctagatcactatcatctttgtacgtcaagaatggttactgtacgtataacctttctttcttttgctctgaccaatatgaaacactaaaatcgattcgagcagcctctcagcatcaattacagtgcgtgaaaaacattcaaatagaggcagcaaatattacatgtgaaaatacaggctggctaaatccaagctaatttagaaatgtggtcaaaacgcatactggcacgtctaatcgcggattcagtaaacaagattaacgattagcccagtgtataagtcatatgatacaggcatgcgcgagagcatcgctacacccgagctggcttcattttcggaggaaaatcaaaacattgctttctcctgccgtgcgaaccattcgtcataaaccgtaatacgcaacatacatttattactacatccgttaattagcgataattagccgttattaacaaagagcgctgaggaattcctctcaaatagcggaggtgcggcggaggcagaggggcgtaaaagggcacatgcgtgcctggctcaaaaaaggatgctccagactgaaactcagagacaaaacacgatgcctcggaggctgagagcccatcgagaggaaaggcaaagaaaagggtcgagtcactcagagggggaggggagatattgtgcatccattggtttgaattgaagcaggcagaataaaaatccttgcgattatgcttcgtgagagatcgcgagagaggaaaaggctaaatgccacgtatgcaaatggataaatgtcatctatttcttcgcgagtagacattttgtggacaacgagagtgtaaataagcgatatgaggggaatacaaaggccttgagggaaagcgttttgggcgtgtcttgtcgaaaagaagacagcgatggcacgcgctcagaaccaccatcttcacgtagataatccgcgtgaaaacaataacaaaactgctcattttaacacgagcaggtgtttgaaaccacccaaaaaagattgtctaaaatattaagattaattaatgacgtttaaatgtccaggcctgatataaatgaagcgtgtagtaagagtaatcgcctttgtttcttttcagagatacgttttcagagattcagggaattatatcttcaataaaataatgtttgatttcattattttaaagctttttaagaagtaaaaatacacattattcatttacattttattttatttaaaggcctatggtcttgaaaataataagtggaatatataggctatatattcgtctaaggacagccggtgttattttatagtgacctcagacaaaagccgagacaaaacgaggcgcttgcctttcattttaatccttaatagacggtgtgatgaatgaatgaatgaatgaataaatgaatgaatgacgggcccttcggcatgttgttccgcagtcctccgtgagcacgagtctctaccgcagtgccaagcacataaaaccgttgagtcagataaccttctccaggcgcgtatacacaattcaaggacaagcacatcacaactatacacaacacaacacaaccgcctaaacgcacgagctcatcaatcgcaatttaaaggcatgtcagtcaaagaaaaaggcggcgttatttaaaaccaatgttcaacaatatttgtatgctgactagcccgggcgcgcacgctataagatcacaaggccttgttttttccctttattcaaaatatcattaattattacaggtcataaaacaaaacaatgcaaattacaatgatttaaagactattgatttaacaataatcagttaattatagaataatattataatattttacatacaaatgaaagatgacattatttgatgacattgtaattaaaatatatgcaatatatttttacgtttttattaattaggctattactattattataattatcattatttttattattattattattattaaatagtcttgcgaaataagagtgaaggcagttgcaatgttcattgttcccggagagtcccgcagcctctggcctcaacacaaagcgctactgtttacattaatattcatagtgctgccatggtctctgtagaggaggaacgggtggctcttttgttcgctagtgtcaatacgtttattcagcaaaaagcagctcggatttgtgaatgcccaacaagcacacgcgcactccaatcaaaggacgagaggataacgattttaaacgattcgcaaacgtgtttatttgtaaagacgacatcaagagcttaatgtccacttgaaaagaaataaatatgcccgcggcgccaaggatattttgaatgtagtcgttcatggtgagccactcccgaattcagcactctggagagcgaccaaagaggaatagcggaatagcaactacttgagccatttctctccgtttgatggcgttcatgattaaaaatataatcacgtgattttttatacatatataaatatatacataaagtaacgctttccttttgagaatacataaatatttattcgcgtgataaatcaatgatcttatatttatttgcacgaccgaaattagccaaattcaccaattaaaaaaaaaataagccaacaaaaaagaagggtttatccgttcagttttgacttgtgtcctgttgttttacagctgccactgtgatcccttaagctgcagtgagagtgtggctaatgccttttgtttaagataatcctgtaatctgttaccgaaacggcctattgacaagccggcattcacatttcagtcaggaggcccgtccagacatgtacatttatgaattacgaatgataaaattaagatctgcattaggcgtcagaaatgtcacgaacacccattcatttcccacagccaataatggatcatgctgggaagcgctatcctcgcagtctcaaaattaatgttgacatgttgcgtagagctacagattagatcagccatatgctttatgtgtttacctcagcggatcttcagcaagatgtgtttattttaagaaaatggcttcctcgctgcctgcacaggggcattaaggaagtgacgtgagcgtcctcacagtcaaattactttatctcatgctgctttcaggcctctgcttattttattattattattttaaattagggggaatcacggtggcgttgtgggtagggtagcgcgatcaccttacagcaagaaggtcgctggttcgagctctggctgggtcagttggcatttctgtgtggagtttaaattgaattgaaattgaataaactaaattggccctagtgtatgtgtgtgaatgtaagtgtgcatgggtgtttcccagtgttgggtttgactggaagagcatccgcttcgtaaaacatatgctggataagttggcggttcatttcactgtggtgaccgctgattaataaagggactaagctgaaaatgaaatgaattaatacattttaaatgagcttttgctgacatgtttatgattacaaatagtgaaattgtatgttaatttacgataagtgcattgttctaaattcatttttatgtagcagctggtttttcttccatttgtgtcattcaacagaacatttttctaaaaaagtgaacttaaattttctcctccctctgacaaggcttgatggtaatttcagccgactctaattacagactcactaaaaggaatcggtgcagtcatttatctttatcagcgcgctggtgggaaggtaataggttttgcttatgagttgtttgcgtgcgagtctgggtccttgtgtaggcgatgctgatgcactgcattaaatattgagggagaagtcgctcaaaaatagcaaagtacaggctggggcaggaacgtcaaagcccgctcagtggccacgtttcttgtttcgtaagtcctatttttaatagcgataattcaggctcagtagaaggaactccagcactataagcagtctctcgcctgtctcggcgagttatgtattttgggatgaagtgctcttccacctctacctctgctgtgctggcgccagtatctgggctgtaagatagtgtacgtgtcagtctgtgtggccgaagagcctgtgtgttgtgtaactcactacattcgtcgctgtggatggctgacttgccatggggaggtttacttcagttcacgaatcacattcgccacgatcttgtcactttgtgtcaagactcgctctctgtgtgtcaacagctctgctgtttgaggttgaaattctgaacttgagatatatcccaggatatattagggctactgccaacggaaaaagcaaatggtgccatggccatttgattgatcaaacaaacacccttttgcttgggtgacagtgaaatgtcagatccatgtttgtactgctttaataacttgcctctctgagctttctccttgtcagtgtcaatttgcctgagatataaattccggttgccccgaaagcttattttattaaaaaaaagctaacatgcactcatacaacgtgcgcacatacatgtgaggcttgctaaaagtcaagaagcaagccaatagcaagagtcgtcagactgctgttacctgggcaacctggttagaggtaaggctcaaggcaagaataaatcattccactgaagagacacagcgttacagcgagatgagagcaagaggcgatagtgaagggagaacaaaagaacagcctacccacactagtgcagatctacctgtttgagctactgattgttcagtttgattagatatcagacaattctgctatctccaattgcattgctgcatgaattcctagaaatcattttaatcaccaaaaactagtagggacacttgtggcgtatatgattctgcctgttgattgtggggatccaacagaaagatcatgaatgcattgttaattaagtcggtgagacaccctgttccaccctaggggccgttctggggaaagagtgctttcagtcagctaaagatgactaatatgtgaacatatattactacacatgccaatttgtacattctggatagttaccagccctgggaaaacatcgaaaaaaataaatcaacatagataaaattggcaaatcccttctggtacgatgcagagtgcttgctctgagaacttgtgcattgtgacagaaagcgaccgttaaaaactgaaagtagcatctacaacctgcatacatctgttctttgaaaatcccctgtaggccaaattaagcatcacgctgtgctccacagcaacacggatgaaccgaaaacccagacacaaacgcacacacttttcacataaacaaggtttagttatgctagctatgctttttcgtcctccctttgtcatcagcggcgagtgacgtaacacagtttgaccctggacagcgtaaagggggggttgggaatgagtgaaaggactgtgacatctgcagggccaggggctgatggagagagctgaagtgagggaggtcagaggaggaggaagggtgggatattgtcctcctcaggccctatccctctcagacgcattgatttttaacctctcagcgagaatgccaagcattacacccctcaaattatggttcctcacccaacctgttatattttccacctgcagc

SEQ ID NO: 36 - DNA, 28 bp, Artificial Sequence
  source: /note=“Description of Artificial Sequence Synthetic oligonucleotide”
ctgacgctttttatcgcaactctctact

SEQ ID NO: 37 - DNA, 750 bp, Artificial Sequence
  source: /note=“Description of Artificial Sequence Synthetic polynucleotide”
atgaaactgctgctgatcttgggaagcgtaattgccttgccgacattcgcagctgggggaggggatctggacgccagcgattacacgggtgtcagtttttggctcgtgactgcggcgctcctggcatcgaccgtgtttttcttcgtggaaagagacagggtgtcggcgaagtggaaaacctcgttgactgtctccgggttggtgacaggcatcgcgttttggcactacatgtatatgcgaggggtctggattgagacaggtgattcaccgacggtgtttcgttacatcaattggttgctcactgtaccactcctcatttgcgagttttaccttattcttgcggcagccacgaatgtggcgggttcgttgttcaaaaagctccttgttggctcgttggttatgctggtatttggctatatgggggaagccggtatcatggctgcgtggcctgcgtttatcattggatgcctggcttgggtctatatgatctatgagttgtgggccggagaaggaaaatccgcgtgtaatacggcctcgcccgcagtgcagtccgcctataacacgatgatgtatatcatcatctttggatgggcaatctatcccgtcggatactttaccgggtacctcatgggtgacggtggatctgccctcaatcttaatctcatctacaaccttgcagacttcgtcaacaagattcttttcgggctgattatctggaacgtcgcagtaaaagaatcctcaaatgcgtga

SEQ ID NO: 38 - DNA, 750 bp, Artificial Sequence
  source: /note=“Description of Artificial Sequence Synthetic polynucleotide”
atgaaactgctgctgatcttgggaagcgtaattgccttgccgacattcgcagctgggggaggggatctggacgccagcgattacacgggtgtcagtttttggctcgtgactgcggcgctcctggcatcgaccgtgtttttcttcgtggaaagagacagggtgtcggcgaagtggaaaacctcgttgactgtctccgggttggtgacaggcatcgcgttttggcactacatgtatatgcgaggggtctggattgagacaggtgattcaccgacggtgtttcgttacatcaattggttgctcactgtaccactcctcatttgccagttttaccttattcttgcggcagccacgaatgtggcgggttcgttgttcaaaaagctccttgttggctcgttggttatgctggtatttggctatatggggcaagccggtatcatggctgcgtggcctgcgtttatcattggatgcctggcttgggtctatatgatctatgagttgtgggccggagaaggaaaatccgcgtgtaatacggcctcgcccgcagtgcagtccgcctataacacgatgatgtatatcatcatctttggatgggcaatctatcccgtcggatactttaccgggtacctcatgggtgacggtggatctgccgacaatcttaatctcatctacaaccttgcagacttcgtcaacaagattcttttcgggctgattatctggaacgtcgcagtaaaagaatcctcaaatgcgtga

SEQ ID NO: 39 - DNA, 753 bp, Artificial Sequence
  source: /note=“Description of Artificial Sequence Synthetic polynucleotide”
atgggtaagcttctcctgattctaggaagtgctattgctttgccatcttttgcagcggccgggggagatctcgacataagcgacacagtcggggtgagtttttggcttgtcaccgcagggatgttggcagctacggtcttttttttcgtggagcgggatcaggtgtccgcaaagtggaagacttcactgaccgtttctggattgataacggggatcgccttttggcattatctctacatgcgaggagtgtggattgataccggggatactcccacggtatttcgatacatcaattggctactgacagttcccctgcaggttgtagagttctatctgatactggctgcatgcacaagcgtcgcggcctctctcttcaagaaactgctggctggttcattagttatgttgggggctgggttcgccggagaggcggggctggccccagtgctgccagcgtttattatcggtatggcaggatggctctatatgatttacgagttgtatatgggggaagggaaggccgctgtgagcacagccagcccagctgtgaattccgcgtacaatgccatgatgatgattattgttgttgggtgggccatctatccagccgggtatgcagcagggtatctgatgggcggagaaggagtgtatgcatctaacttgaacctgatctacaatctcgccgacttcgttaacaagatcctattcggtttgatcatttggaacgttgccgtgaaagaatcaagtaatgca

SEQ ID NO: 40 - DNA, 717 bp, Artificial Sequence
  source: /note=“Description of Artificial Sequence Synthetic polynucleotide”
atggtgggcctcaccacccttttctggctgggcgctattgggatgttggttgggaccctggcttttgcatgggccggcagggacgccgggtcaggtgagaggcggtactacgtgacgctcgtgggaattagcggtatcgccgccgtagcatatgtcgtaatggcccttggggttggctgggtccccgtggccgagcggaccgtttttgcacctcgatacattaattggattctcactactccacttatcgtttacttccttgggctgctggctggcctggacagccgcgaatttggaatagttataactttgaatacagtggtgatgttggcgggcttcgctggggccatggtgccaggcatcgagcgatatgctcttttcggtatgggcgcagtagctttcctaggactcgtttattaccttgtggggcctatgacagagagcgctagccagaggtctagcggaatcaagagcctttatgtgagactgcggaatttgaccgtgattctgtgggccatttatccctttatttggttgttagggccccccggcgtcgccttactgactcccacagtcgacgtggcgctgatcgtctatctggacctggtcactaaagtggggtttggcttcattgctctggacgccgctgccactttgagagctgaacacggagaatcactcgcaggagtggataccgacgctcccgccgtggcagat

SEQ ID NO: 41 - DNA, 54 bp, Artificial Sequence
  source: /note=“Description of Artificial Sequence Synthetic oligonucleotide”
atgaggggtacgcccctgctcctcgtcgtctctctgttctctctgcttcaggac

SEQ ID NO: 42 - DNA, 108 bp, Artificial Sequence
  source: /note=“Description of Artificial Sequence Synthetic polynucleotide”
atgatggacagcaaaggttcgtcgcagaaagggtcccgcctgctcctgctgctggtggtgtcaaatctactcttgtgccagggtgtggtctccacccccgtcgggatc

SEQ ID NO: 43 - DNA, 21 bp, Artificial Sequence
  source: /note=“Description of Artificial Sequence Synthetic oligonucleotide”
ttctgctacgagaacgaggtg

SEQ ID NO: 44 - DNA, 60 bp, Artificial Sequence
  source: /note=“Description of Artificial Sequence Synthetic oligonucleotide”
aagagcaggatcaccagcgagggcgagtacatccccctggaccagatcgacatcaacgtg

SEQ ID NO: 45 - DNA, 720 bp, Artificial Sequence
  source: /note=“Description of Artificial Sequence Synthetic polynucleotide”
atggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagctgatctgcaccaccggcaagctgcccgtgccctggcccaccctcgtgaccaccctgggctacggcctgcagtgcttcgcccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacaacagccacaacgtctatatcaccgccgacaagcagaagaacggcatcaaggccaacttcaagatccgccacaacatcgaggacggcggcgtgcagctcgccgaccactaccagcagaacacccccatcggcgacggccccgtgctgctgcccgacaaccactacctgagctaccagtccgccctgagcaaagaccccaacgagaagcgcgatcacatggtcctgctggagttcgtgaccgccgccgggatcactctcggcatggacgagctgtacaagtga

SEQ ID NO: 46 - DNA, 720 bp, Artificial Sequence
  source: /note=“Description of Artificial Sequence Synthetic polynucleotide”
atggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagttcatctgcaccaccggcaagctgcccgtgccctggcccaccctcgtgaccaccttcggctacggcctgcagtgcttcgcccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacaacagccacaacgtctatatcatggccgacaagcagaagaacggcatcaaggtgaacttcaagatccgccacaacatcgaggacggcagcgtgcagctcgccgaccactaccagcagaacacccccatcggcgacggccccgtgctgctgcccgacaaccactacctgagctaccagtccgccctgagcaaagaccccaacgagaagcgcgatcacatggtcctgctggagttcgtgaccgccgccgggatcactctcggcatggacgagctgtacaagtaa

SEQ ID NO: 47 - DNA, 714 bp, Artificial Sequence
  source: /note=“Description of Artificial Sequence Synthetic polynucleotide”
atggtgtctaagggcgaagagctgattaaggagaacatgcacatgaagctgtacatggagggcaccgtgaacaaccaccacttcaagtgcacatccgagggcgaaggcaagccctacgagggcacccagaccatgagaatcaaggtggtcgagggcggccctctccccttcgccttcgacatcctggctaccagcttcatgtacggcagcagaaccttcatcaaccacacccagggcatccccgacttctttaagcagtccttccctgagggcttcacatgggagagagtcaccacatacgaagacgggggcgtgctgaccgctacccaggacaccagcctccaggacggctgcctcatctacaacgtcaagatcagaggggtgaacttcccatccaacggccctgtgatgcagaagaaaacactcggctgggaggccaacaccgagatgctgtaccccgctgacggcggcctggaaggcagaaccgacatggccctgaagctcgtgggcgggggccacctgatctgcaacttcaagaccacatacagatccaagaaacccgctaagaacctcaagatgcccggcgtctactatgtggaccacagactggaaagaatcaaggaggccgacaaagagacctacgtcgagcagcacgaggtggctgtggccagatactgcgacctccctagcaaactggggcacaaacttaattaa

SEQ ID NO: 48 - DNA, 33 bp, Artificial Sequence
  primer
ttatgccaggtacgccaactggctgtttaccac

SEQ ID NO: 49 - DNA, 33 bp, Artificial Sequence
  primer
gtggtaaacagccagttggcgtacctggcataa